(19) United States
(12) Patent Application Publication
(10) Pub. No.: US 2012/0239349 A1
(43) Pub. Date: Sep. 20, 2012

(54) Method to detect signals

(76) Inventor: Vladimir Trakhtman, New York, NY (US)

(21) Appl. No.: 12/932,524

(22) Filed: Feb. 28, 2011

(51) Int. Cl. G06F 15/00

(52) U.S. Cl. 702/189

(57) ABSTRACT

A method is offered to detect a signal in mixture with noise analyzing a structure of the mixture “by partial intensity”. It is done by a reclassification of initial data in such a way every decimal digit becomes the top digit of a correspondent operational set. An embodiment of the invention offers a local television to switch on brightness of a dot on a screen of TV when a weak signal appears detected indirectly while no signal is directly observed in a mixture with a strong noise. Another embodiment of the invention offers mobile bearing by recognizing and processing two contrasted patterns of bearing. While a pattern of high intensity masks a pattern of low intensity, the task of bearing appears one to detect a signal in noise or under hindrance.

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Listing of computer program and tables of data are attached at Appendix I.

Compact disc 1 contains: a) file of this specification, b) file of the computer program, c) files of tables of data.

Duplicate compact disk 2 is identical in respect to compact disk 1.

Listings of compact disks 1 and 2 are attached at Appendix 2.

TABLES
The patent application contains table(s) that have been included at the end of the specification.

### BACKGROUND OF THE INVENTION

Method to detect signals concern different experimental activities (technical, physical, geophysical, biological, medical etc) when a physical sensor provides data that later are amplified and digitized by an analog-digital transformer ADT. If data represent a mixture of a signal and noise, the present invention offers the method to detect the signal. It relates to the current U.S. Class 341 Subclass 110, the Class 377 Subclass 700 and the Class 700 Subclasses 15, 116, 18, 30 concerning data processing using ADT and including sound processing.

Experimental activity of people is provided naturally by organs of senses. Such activity could be called “passive”. It gives information about which is perceived (visible, heard etc) while there is no direct influence at an object of observation. Microscope and telescope extend the scope of passive experimental activity. An object of observation could be invisible. It becomes visible thanks to microscope and telescope. The method is called focusing. In optics, focusing is realized by lenses. Similarly, acoustical lenses are applied to make heard which is non heard. The idea is to strengthen contrast or the difference of a signal to represent an object of observation in comparison with the environment around. This technique is supported with spectral analysis based on the Fourier and other orthogonal transformations of mathematical physics.

U.S. Pat. No. 7,835,223 “Removing noise from seismic data obtained from towed seismic sensors”, Nov. 16, 2010, inventors Goujon et al, deals in sets of data provided by seismic sensors. Different sampling intervals are used to eliminate noise at least partially. It is an example of a passive observation based on the common idea to improve a contrast, here—by dividing experimental data into separate parts.

U.S. Pat. No. 7,426,439 “Method and apparatus for marine seismic data acquisition”, Sep. 16, 2008, inventors Ozdemir et al, provides a method and apparatus for seismic data acquisition by at least two particle motion sensors. The data include a seismic signal and a noise that could be separated from the signal if to measure length coherent with noise. The method is used to remove even a portion of noise. It is a similar example of a passive experiment based on the same common idea to get a contrast, here—by separating channels of observation. U.S. Pat. No. 7,715,996 “Method of estimating digital signal frequency”, May 11, 2010, inventor Cusmariu, performs spectral analysis applying Gram-Schmidt transformation to get a contrast in respect to Fourier, Gabor and Hilbert transforms. A received signal is segmented into a number of data blocks that may be disjoint or overlapped. For each data block, the signal is differentiated, and used to obtain orthogonality between a signal and its derivative. The complex extension leads to computation of phases using either an inverse tangent function or complex logarithm. It is also the example of a passive experiment, here—based on contrasting by formal ideas like an orthogonal transformation.

The prototypes above eliminate useless noise around a useful signal. Unfortunately, noise is omnipresent. It prevents from contrasting a signal and a weak signal or a small object could remain non observed directly by said passive method. Active experimental methods are applied instead. Nuclear and quantum physics, modern biology, a lot of other activities are based on active methods only provided by electronic microscopy, PAT and Cat scanners of medical diagnostics etc. An artificial contrasting of an object of study is applied by the active experimental methods. It is based on knowledge a priori and it is why the active methods are useful but they are less objective. To prove a theoretic concept completely, a passive experiment is more desirable. But the deficit of initial or natural contrast prevents from extending said passive experimental activity.

So, repeat. Priori art of a physical observation is based on a contrast. If the contrast is a natural one (exists in the environment objectively), a correspondent physical observation is called “passive” or “direct”. If an man made or artificial contrast is created in the environment, such “active” or “indirect” experimental activity could be useful but it is less objective because it is impossible to estimate entire influence of the artificial contrast. Unfortunately, passive experimental activity is limited with available contrasts. Entire world of very small atoms, particles, nuclear processes etc. is known indirectly thanks to an indirect active experiment. The world of regular and large objects as well as the world of different processes are known partially. If a signal which gives information is weak and/or is drowned in noise up to the level not to be received, a direct passive experiment is impossible.

Prior art knows technologies to prepare objects not to be observed or to receive noise instead of a signal (like a technology to camouflage a plane or ship artificially). Developing a passive experiment means to fight against this activity. But there are phenomena like a thought of a human being which is perceived well but remains invisible physically. This phenomenon waits for more powerful passive observation. The same could help medicine, to improve vision under water, inside other noise-like mediums, to meet a signal of external civilization etc.

### BRIEF SUMMERY OF THE INVENTION

A method is offered to detect a signal analyzing a structure of the signal “by partial intensity”. It is done by a reclassification of initial data in such a way every decimal digit becomes the top digit of a correspondent operational set. An embodiment of the invention offers a local and artificial television to switch on brightness of a dot on a screen of TV when a weak signal appears detected indirectly (by the new method) for a period of time while no signal is directly observed in a mixture with a strong noise. Another embodiment of the invention offers mobile or even packet size passive bearing like ranging by sound thanks to detecting by the method small differences between similar signals received by sensors placed close to each others. A lot of practical applications could be realized on the base of both embodiments but the orientation of the invention to use an artificial dimension of partial intensity seems even more important. It opens the way to improve known spectral method.

### SEVERAL VIEWS OF THE DRAWINGS

FIG. 1—mixing like liquids signal and noise

FIG. 2—numbers by operational planes

FIG. 3—partial numbers

FIG. 4—sampling procedure

FIG. 5—operational function

FIG. 6—operational patterns

FIG. 7—patterns to display signal+noise
a—patterns of circle (signal without noise)
b—patterns of line (signal+0.000000001*noise)

FIG. 8—different ratio signal/noise
a—noise=signal
b—0.000002*noise<signal
c—noise>0.000002* signal

FIG. 9—catching external contrasts
a—0.001*signal, no noise
b—0.0001*signal, no noise
c—0.0001*signal+noise
d—0.0000001*signal+noise

FIG. 10—block scheme to provide signals for local and artificial television

10—physical block

11—operational block

12—algorithmic block

13—block for taking decisions

14—apparatus for artificial television

FIG. 11—passive bearing

10—object

11—receivers

12—operational sets

13—pattern of line

14—making decision

### DETAILED DESCRIPTION OF THE INVENTION

The invention offers a method to observe indirectly which is not observed directly. It includes the embodiments:

detecting a signal in mixture with noise, for example, for local and artificial television

measuring the difference between signals, for example, for mobile passive bearing

pattern recognition by comparing partial differences on different levels of intensity.

If a signal is not observed in a mixture with noise, physical parameters of the signal could be supposed to be camouflaged by noise. The invention offers detecting the signal by man made (artificial) parameters. The idea is to divide the mixture into separate parts, to find internal differences between the parts and to accept the differences like artificial attributes of a signal. It is not excluded the signal remains non detected by this procedure or another signal would be detected. In spite of such possibilities, the invention gives a chance to enter by an arbitrary experimental activity a zone of which is invisible and unknown.

Actually, it is an attempt to enrich cognition and, in particular, the art of intelligence (in a wide sense) with a method of an artificial perception based on an artificial manipulation with data. By other words, it looks like an artificial extending natural perception by an inverse in respect to usual or “double artificial intelligence”. Such activity waits for a support of people.

It is unknown a priori whether or not people need and want such artificial extending natural perception. Commercial initiative could help like a kind of industry of toys, different means of learning for children and adults to develop imagination and thinking by observing which is not perceived directly but could become observed indirectly.

It concerns such toys and means as:

equipments for long distance passive optical/sound underwater artificial television

mobile and pocket size devices for passive bearing

binocular (monocular) technique based on combined sound/optical “vision”

compact and automated back and gun sights

compact warning about invisible obstacles for people, ships, planes, automobiles etc.

means of precise geophysics

medical diagnostics on the base of which is invisible

means for physical investigations of which is non received and is unknown

means to keep philosophic discussions concerning the nature of things.

The invention offers a method of signal processing to extend a known one. Regular observing environment by real, physical attributes (brightness, size, weight, speed etc.) is substituted with “observing” by formal attributes (senseless in respect to physics) and based on separating data into parts. It is the way to observe arbitrary contrasts and to decide if some differences define a signal while another ones—noise. Art of physics looks differently: it is based on strong reasoning supported with perception.

But spectral space (offered by prior art of physics and mathematics for signal processing) does not keep noise. Spectral processing meets difficulties when ratio “signal in respect to noise” is about 4:1 or 3:1. It is the case when there are “more signal than noise”. If there is “less signal than noise”, spectral methods do not work at all.

The current invention deals in whatever ratio “signal/noise” (noise could be stronger than signal even 1000000000 times and more). Physically, the ratio “signal/noise” is limited by exactness of an experimental channel. It looks like a natural barrier. But there is a man-made barrier. It concerns signal processing. The problem is there is no adequate procedure to deal in a weak signal in strong noise. A procedures of this kind is offered by the invention. The procedure does not depend on a physical ratio “signal/noise” because an operational space is offered with a formal ratio “signal/noise” approximately not worser than 1:10 (a signal is weaker than noise) to process any physical ratio “signal/noise”.

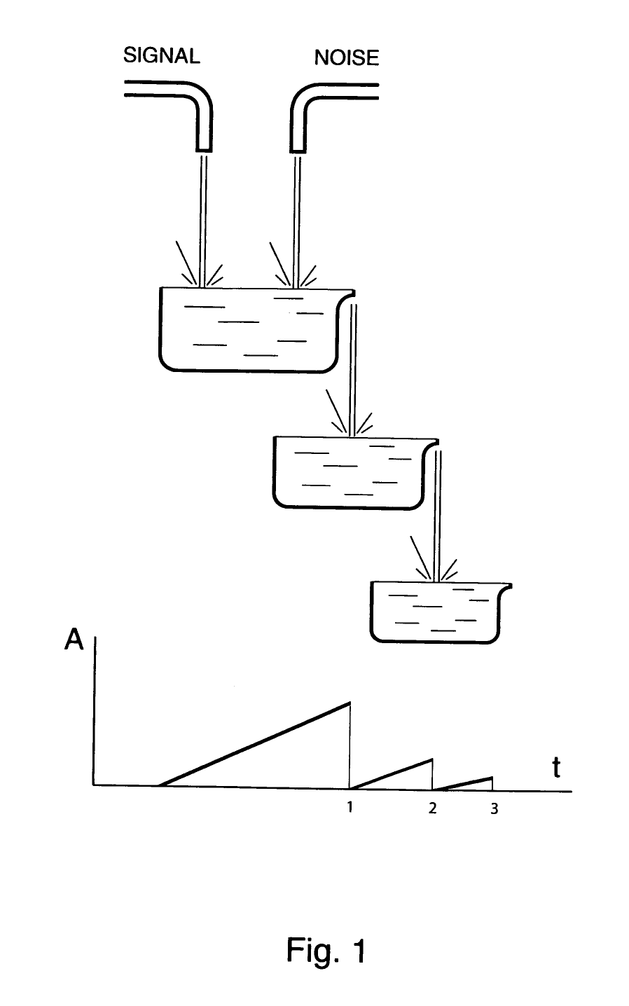

Imagine a technology of mixing a signal with noise like mixing liquids. It is shown on FIG. 1. The set of pots of different sizes represents analogy with a structure of a fraction which keeps a value of a sample of data. Known fraction is made like the set of places or orders to be fulfilled by digits while different orders have different arithmetic weights. Something similar is drawn on FIG. 1. When a current pot is fulfilled, the mixture of liquids overflows this level and fills a pot below. In reality, a mixture of noise and signal is created physically (by a sensor), by ADT or anywhere else. In any case, a digitized sample of the mixture is created like a specific oscillation (shown on FIG. 1 below) but it is a mathematical and artificial (man-made), not physical oscillation. The current invention represents the very beginning of processing the formal oscillation to get a bit more detailed sample. It results in offering an operational space to provide the dimension of intensity with formal normalization of the ratio signal/noise of the mixture.

The invention deals in a linear model of mixing signal and noise. It implies a smooth or linear process of fulfilling pots/orders and opens the possibility to deal in each pot/order either separately or together with other ones. For example, all pots/orders could be made equal in size by a formal normalization and be compared each in respect to others. It is the way to enrich initial arithmetic meaning of entire fraction with a detailed representation “by levels of intensity”.

A senseful signal is distributed among orders of a sample in accordance with a) common intensity and b) the distribution of weights of orders. It gives physical sense formal weights. On the contrary, senseless noise is distributed among parts-orders of a sample without any physical sense. It is because “linear noise” is indifferent in respect to intensity. Said “linear noise” acts on all levels of intensity at the same manner physically. It reveals an essential difference of a signal in respect to noise. The difference is masked by mathematics with a stable structure of numbers.

It could be said mathematics mystifies people masking which appears invisible thanks to arithmetic sense of entire number. It is done for favor of people. Mathematics is based on logic and understanding. Signal processing does not need logic and understanding. It needs getting proper information while signals are processed.

Because all orders of a fraction are of the same construction, each one could take the same portion of noise as a signal. It limits ratio “signal/noise” inside an order and permits to deal in a mixture “by separate orders of one sample”. Replacing an order into a new position keeps the same noise and the same signal contained at the order but a real ratio “signal/noise” (defined by entire fraction) is substituted by a formal one depending on a current position inside the fraction of such wandering orders.

Formal ratio “signal/noise” of a separate order (independently from a position) could be estimated between 0-9 because it is defined by digits to be put inside an order. But the first position of a fraction keeps formal ratio “signal/noise” between 0-0.99999 . . . in accordance with a possible value of entire fraction. It looks like 10 times of formal improving for the cost of nothing. And it is used by the invention.

The invention offers signal processing by “artificial” or “partial” numbers made from separate chains of decimal numbers (parts of real numbers) each chain with one of decimals of a real fraction replaced onto the first position of said artificial partial number. So, an operational space is created by a reclassification of orders of initial fractions.

To separate into parts, it is prior art of signal processing. To separate numbers into parts, it is novelty of the current invention. It is the novelty to get an operational space more stable in respect to noise in comparison with known spectral space.

There is another interpretation of which is done by the current invention. It is based on the practice of an artist who draws a picture on a canvas and, from a time to time, restores an old canvas. This activity is similar mixing a signal (like a picture) with nose (on the canvas). Noise has no definite structure like a clear canvas. A picture has a structure and could be detected by the difference among the structures of the picture and canvas. If the picture could not be directly detected, it could be done “by parts” either by dividing the canvas into parts entirely or “by small layers” and going into depth like 3-D activity. A set of tiny layers of painting (like a film of patina) is removing during restoration to see which is below.

A structure of numbers permits similar interpretation and similar technique. A set of orders of a fraction looks like a construction to keep different pictures drawn on different layers like partial pictures represented by partial numbers-samples. This vision gives the idea to deal in parallel with a common numeric value of a fraction when all decimals are taken together and with the set of “partial numbers” or different combinations of decimal numbers. Such “partial numbers” represent invisible “partial signals” like different layers on canvas represent old pictures that are masked by new ones.

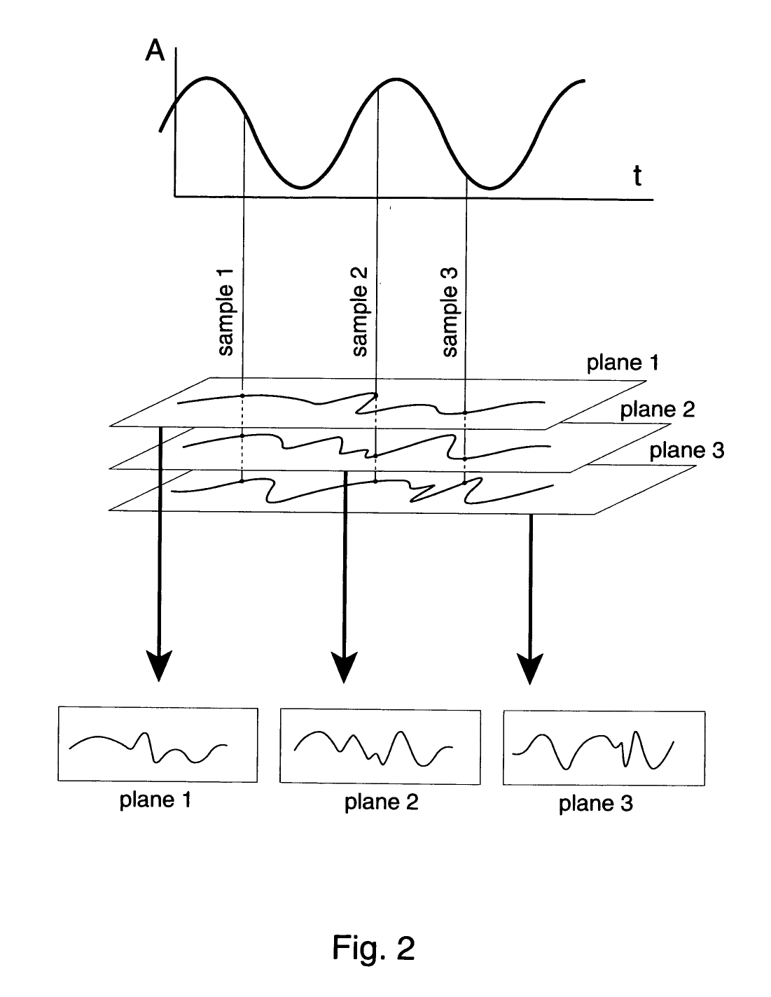

On FIG. 2 partial signals are shown each on an operational plane of a correspondent order. This process separates into parts the unity of orders and destroys initial arithmetic sense of fractions. Each layer could be processed separately or like a leader of layers below. By such vision, each operational plate (the same, an operational set of a definite order) represents a part of an initial signal and this partial signal differs from other partial signals.

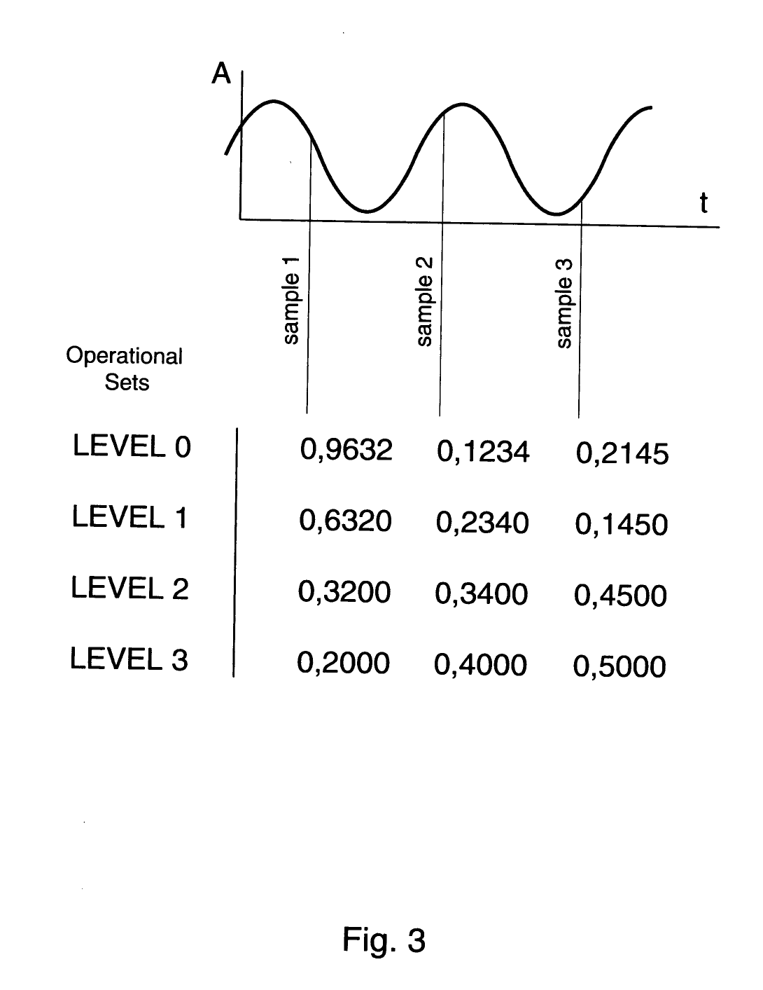

On FIG. 3, the mechanism is drawn of creating partial numbers. An initial signal is shown above in coordinates of intensity A and time t. The signal is digitized by ADT into the set of samples each one represented by a regular normalized fraction (Three samples are shown on FIG. 3). The number of orders of a fraction is defined by precision of an experiment. The top line on FIG. 3 represents the set of initial fractions (samples of the signal above). The next line is gotten by shifting out to the left numbers of the first line etc. Each line represents an operation set and each one is made from normalized decimal numbers of initial fractions.

So the invention explores the dimension of intensity creating special operational sets of data by dividing into parts fractions-samples of data. It is used by all three concrete embodiments of the invention like a common “arithmetic embodiment”. Technologically, this construction looks like an informational rocket with the first stage to provide further steps with something like “better arithmetics”, which is improved in sense of fighting against noise. More concrete embodiments of the invention look like separating heads of the informational racket.

The point is any concrete signal application needs a signal processing. It includes getting a visual/numeric decision, indicating the visual decision and representing the numeric one. It defines necessity of some algorithmic instruments. It this invention, there are:

a function (functions) which should be chosen to count a measure and to take a decision

a sampling procedure (procedures) to feed the function (functions) with data

a pattern (patterns) to see a useful difference (like one between a signal and noise)

a pattern (patterns) not to see a useless difference (like one between elements of noise).

Taking in mind such necessity, the current invention is constructed like an instrument of further inventions on the same theme. Following the current invention, a weak signal could be detected in a mixture with strong noise. But it is a partial result. A complete one would happen when:

all parameters of a weak signal in strong noise are measured

a weak signal is completely restored from a mixture with strong noise.

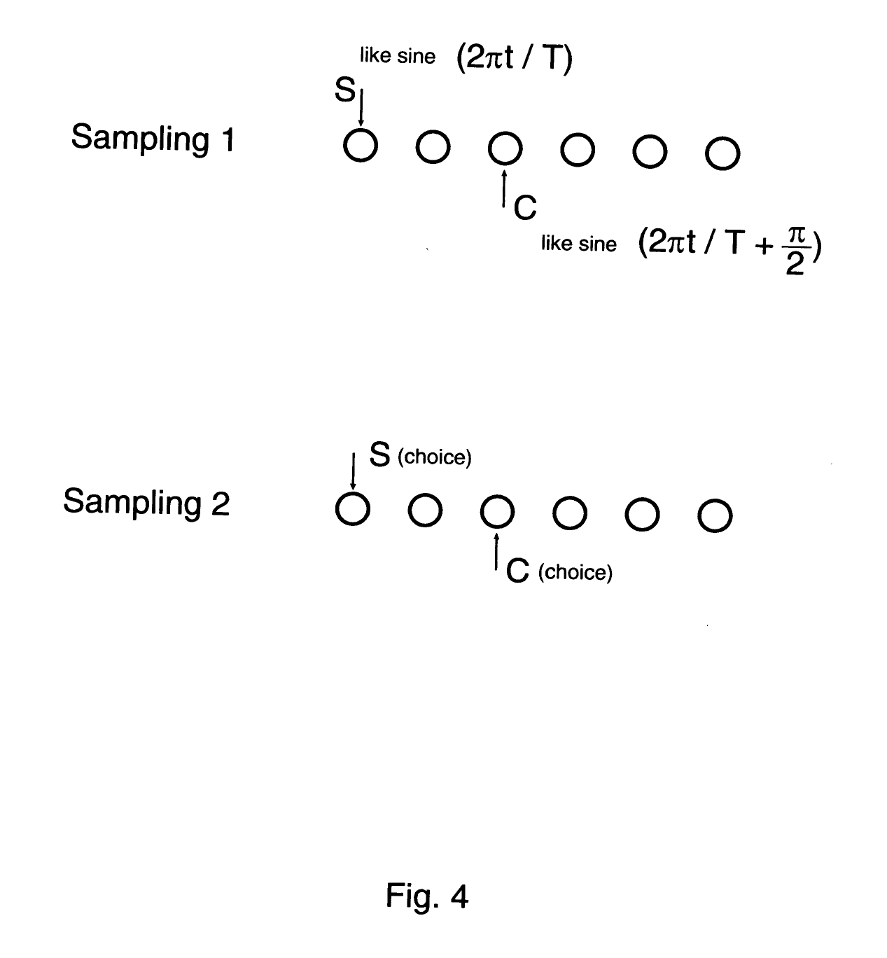

To touch the problems mentioned above further and with a similar technique, the present invention deals in pseudo sine and pseudo cosine functions. Arguments of the functions are taken like in is shown at FIG. 4 or in accordance with regular trigonometric rules. Alternative—to choose all possible combinations of samples. It is is shown on FIG. 4 also. This kind of sampling is useful when a real observation provides insufficient number of samples (less then 12-15).

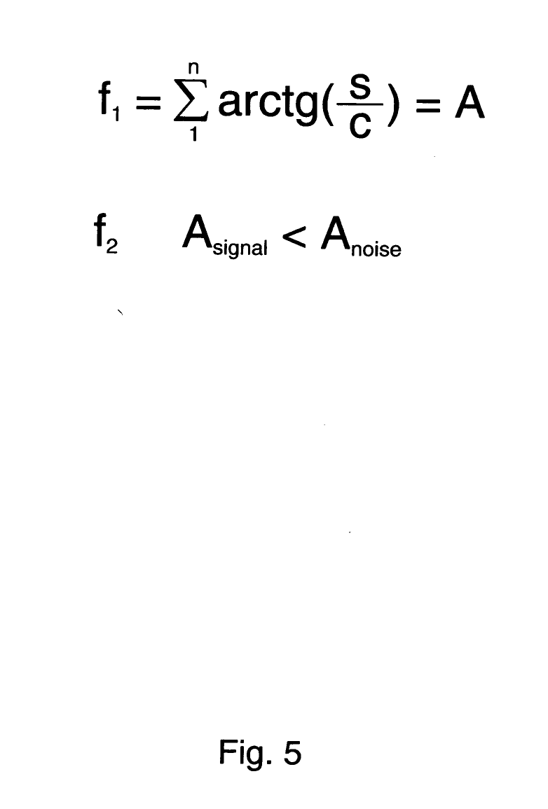

The pseudo function f1 (FIG.5) is computed as a pseudo inverse tangent function with values of pseudo sine function divided by values of pseudo cosine function (both gotten by sampling in accordance with FIG. 4). Detecting a signal in noise is done by minimum of the sum A computed applying values of a processed function (FIG. 5). Maximum of A is supposed to be an attribute of noise.

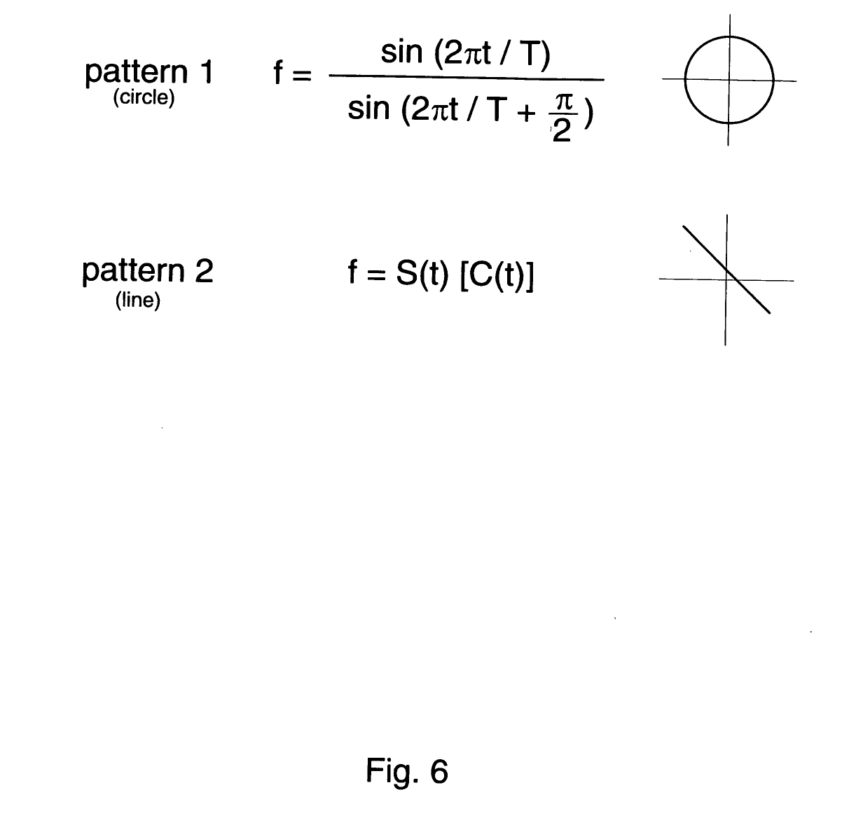

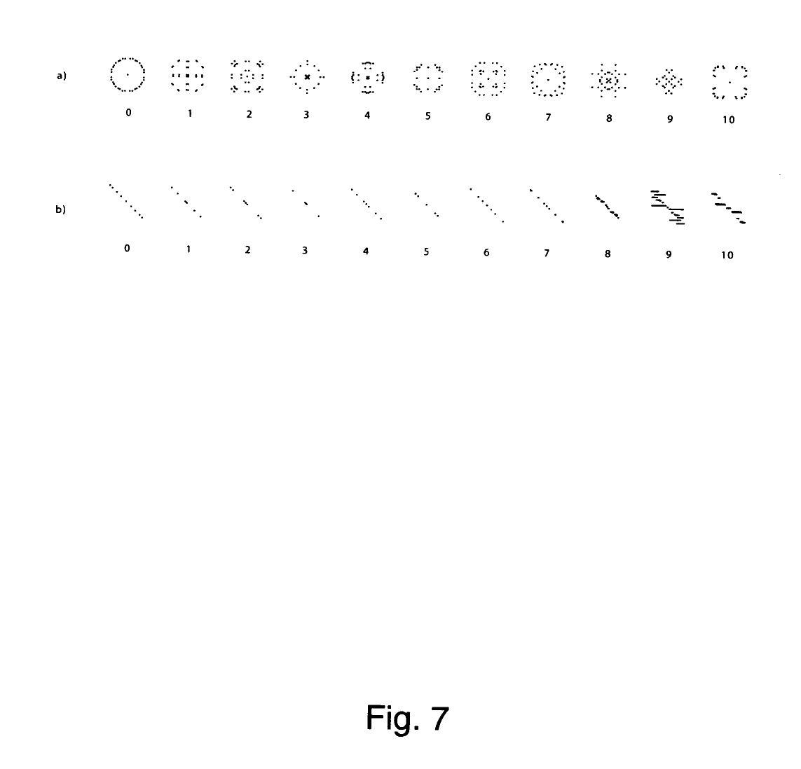

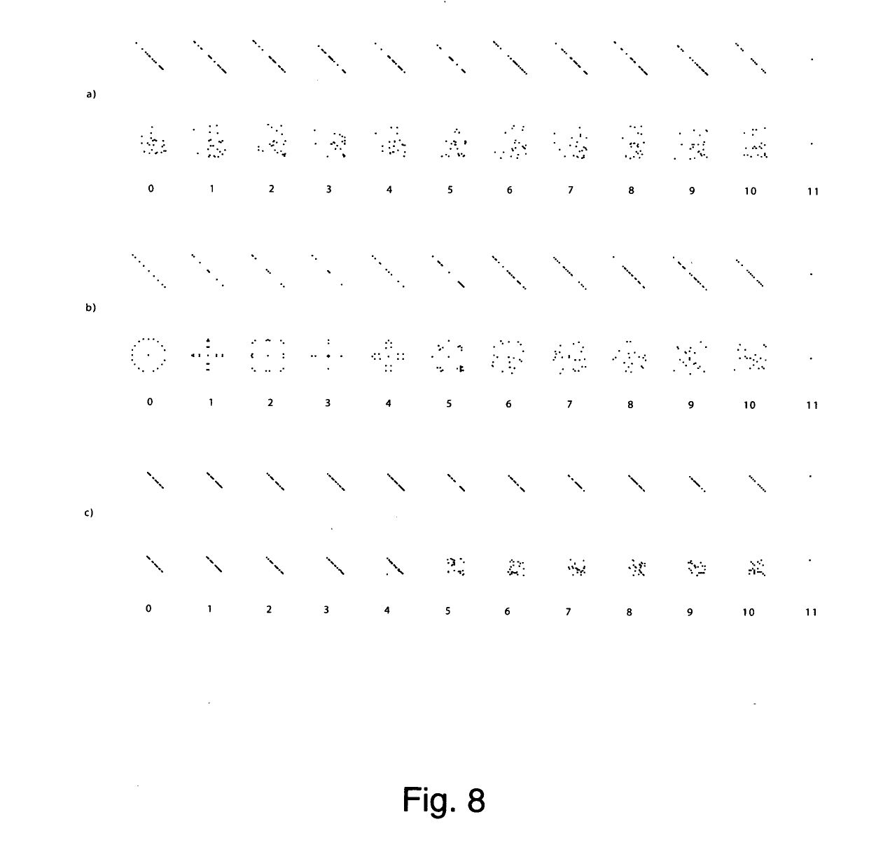

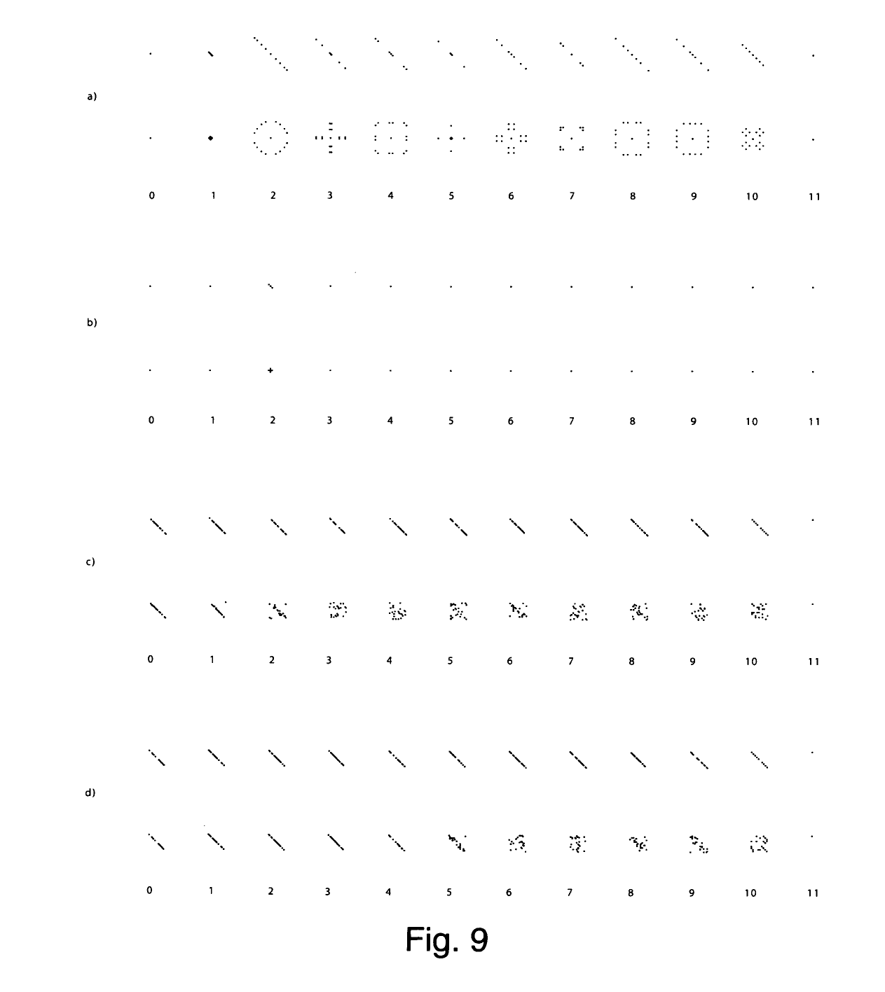

Signal processing “by partial numbers” could be simplified by patterns able to represent or not to represent the partial data visually. The pattern of a circle is useful to observe “partial circles” represented by partial numbers. The pattern of line with the same x and y arguments is useful to observe the line instead of the same functions applied like arguments of the line. It helps detecting the difference between x and y on deep levels of intensity. The patterns are represented on FIG. 6.

On FIG. 7a, a usual circle is shown (index 0) created by the pair of regular sine and cosine functions. The next patterns on the line are “partial patterns” (they are indexed by numbers 1-10). Patterns are created by “partial numbers” made by shifting out to the left current top digits of similar numbers of a higher level. They are collected at the table 1-as of sine samples and the table 1-ac of cosine samples (Appendix). Correspondent partial numbers are indexed by numbers from 0 to 11.

“Partial circles” on FIG. 7a keep specific structures that differ each others while levels are changed of correspondent partial numbers. It supports the idea arithmetics may and should serve internal structures of samples (to work with details on the dimension of intensity). It is not done thanks to prior arithmetic art to deal in entire value of a number only. Arithmetics serves mathematics for mathematics, not mathematics for signal processing.

However, partial patterns like above depend on initial sine/cosine parameters and are not defended from noise like all other spectral factors. An internal structure of such pictures is used indirectly by the invention.

On FIG. 7b, the set of patterns of line is shown with arguments x and y fulfilled by the pair of similar sine functions that differ a little bit thanks to a very small phase difference (the difference much more smaller than one between sine and cosine functions). The patterns on the line b are indexed like ones on the line a: by number from 0 to 10. The index 0 corresponds to a regular sine function. The next indexes on the line b define “partial patters”. They are created by “partial numbers” made by shifting out to the left the top digits of numbers of a higher level. All numbers are represented by the table 1-b (Appendix). Data are divided by levels 0-11 counted in accordance with an initial position of a current order on the top level.

Partial patterns on FIG. 7a are called to observe and count internal structures created by two different (shifted) pseudo sine and cosine functions. On the contrary, partial patterns on FIG. 7b are created to ignore (not to observe) identical structures. The pattern of line supports this approach with identical functions or even the same function to feed x and y arguments. But the difference is visible if it is more that a definite level. On FIG. 7b actual difference between two signals is about 0.000000001 but it is seen like 0.1 thanks to a proper operational set. It becomes seen that the contrast begins seen on levels 1>=8. Correspondent data are given at the table 1-b, Appendix.

This example shows signal processing can deal in deep levels of intensity analyzing small peculiarities of data. But it depends on obstacles (correctly, on absence of obstacles) on the way to reach the deep levels. The table 1b represents a contrast between operational sets on different levels. If the way throughout decimals into the depth of very small parts on a number is masked by contrast above nothing could be detected and observed without a special procedure.

It is shown by the couple of lines on FIG. 8a. Both patterns—of line (fed by sine function), and circle (fed by sine and cosine functions taken together) represent approximately equal mixtures of a signal with noise. Both components of the mixture are created on level It is the level of regular normalized fractions. The ratio is approximately 1:1 and nothing is seen on all levels of decimals “by lines” and “by circles” (noise works on all levels similarly).

It is the situation when operational sets are prepared and normalized (the first stage works of said informational racket) but there is no external contrast to detect either a signal or noise. To get more information, internal structures of numbers should be analyzed.

On FIG. 8b and by table 2-b (Appendix) the case is represented of an external contrast like a weak noise and a strong signal. It is realized by multiplied regular noise by the number 0.000002. It is seen on FIG. 8b that noise is seen without an additional processing just on the levels 1>=6. Initial base preparation of data which does not work at the case above (when signal=noise) works here thanks to an external contrast. By the way, circles work better than lines at this case. Signal is stronger than noise and is seen well on high levels. Nevertheless the difference is seen by lines too. A contrast could be improved by a special processing similar one applied to improve the contrast on pictures on the FIG. 8b. It concerns non-linear additional contrasted.

An inverse situation when noise is stronger than signal is represented on FIG. 8c and by table 2-c. It forms an external contrast as well. Amplitude of the signal is multiplied with the same number 0.000002. And the signal is seen on the levels 1>=6. It is seen “by circles” because pseudo sine and pseudo cosine functions create correspondent partial circles. On the levels 1>=6 the circles are seen even if destroyed by noise while similar weak signal is not seen in a mixture with strong noise if the pattern of line is applied to display the situation. This example shows if a signal is not observed it does not mean there is no signal. A signal need conditions to be observed. Some of conditions look unusually.

By FIG. 9a and the table 3-a (Appendix), another case is represented of a contrast coming from without. There is no noise while a signal is weak. It is modeled by multiplying regular sine and cosine functions with the number 0.001. Both patterns of line and circle represent the contrast excellently.

By FIG. 9b and the table 3-b (Appendix), one more case of this kind is represented. There is no noise while a signal is a bit more weaker. It is modeled by multiplying regular sine and cosine functions with the number 0.0001. But nothing is represented by both patterns. Data of the table 3-b show complete absence of data. Everything is equal zero. No doubt, it concern a concrete computer and a concrete program on the computer. The fact is nothing is done by the author to get such strange effect artificially. It happens sometimes with numbers created with leading zeros and it shows one more time if nothing is received it does not mean nothing takes place indeed.

By FIG. 9c and the table 3-c (Appendix), one more case of this kind is represented. The same weak signal is gotten by multiplying sine and cosine functions with the same number 0.0001. It is mixed with noise. In result, the pattern of a circle detects the signal while the patterns of line does not. This difference is explained above but it becomes clear that noise works at some cases like a useful medium to receive which is invisible like a carrier to adjust the signal with an experimental channel.

By FIG. 9d and the table 3-d (Appendix), one more case of this kind is represented. It is the case which repeats the previous one by more weak signal gotten by multiplying sine and cosine functions with the number 0.0000001. It is mixed with noise. In result, the pattern of a circle detects the signal while the patterns of line does not.

An embodiment of the invention offers an artificial and universal eye or, correctly, an artificial and universal local television (ATV) provided with information on the base of by the method to detect signals (current invention). It would be the eye or ATV to help blind people to see which is seen by other people. But the task to help all people together to notice which is invisible by all people together, it is not less importance task. People do not perceive which is not observed. The embodiment offers a perceptive effect of which is invisible. Actually the invention calls “people do not know how blind they are in respect to which is invisible”. But there are cases when a common blindness in perceived. For example, it concerns a submarine under the depth of water.

When a physical sensor (optical, audio, seismic etc.) receives a mixture of a strong noise and a weak signal (or there is no signal at all), this stuff can be observed but noise is observed instead of a signal. No visibility could be at a deep darkness under water when no light is permitted, inside turbid or foggy medium (water among therm) while even a strong light fails to overcome optical resistance of the medium. The invention offers an artificial or man-made vision of a contrast of a layer of intensity. It concerns whatever physical experiment and extends human perception into entire physical knowledge.

Suppose the mixture of a signal and noise is digitalized by ADT and a stream of fractions—samples of the mixture indexed in time by the index “t” is represented for further signal processing. The invention offers a reclassification of the fractions “by orders of intensity” like it is described above. It comprises creating some artificial fractions from each initial one. New fractions will be additionally indexed by the index “l” from 0 to L-1 (L—the number of significant digits). Actually, “by l” are indexed operational streams that combine together digits similar in respect to the pair “initial order” before reclassification and “current top digits” after reclassification. So, each fraction of the initial stream (indexed “by t”) appears double indexed “by l and t” after the reclassification.

It has already said this representation keeps a formal ratio 1:1 in respect to signal/noise in every operational set keeping the same physical structure of data. It means, data could be analyzed better “by operational sets” the more so as ranging of a measure to analyze data appears extended by new steps in the direction of intensity.

Each operational set keeps its own step of initial intensity but is analyzed separately from other operational sets as if it belongs to maximal level of intensity. A similar measure m (l,t) could be gotten for all sets taken separately and it opens the possibility to compare the sets together like similar ones. It is the realization of the idea to estimate separately each set of similar (by the number of an initial order) decimals of all fractions that form the initial stream of data and to get more detailed two dimensional signal processing “by time and intensity”.

To compare different operational sets, time dependent measures like m(l,t) good inside a set should be transformed into time independent ones like measures M(l) indexed “by operational sets” double represented a) like equal during comparing b) like different each to keep its own initial “step of intensity”—after comparing. Said re-indexing could be done, for example, by adding all partial or time estimations belonging a set. It is the way to compare independent measures M(1) each one for an operational set and to choose one which reveals a contrast of an internal intensity (between steps of intensity) or a common minimum of diversity (a contrast of an established threshold to separate signal from noise). Such technology of signal processing represents novelty of the invention. It could be useful in many directions and a passive artificial eye or said local ATV looks like one of the most important applications.

Said ATV could be used to observe non observed signals in noise by an internal contrast of entire structure of data, for example, in respect to a common difference of a signal from noise. A concrete purpose of signal processing would be supported by a learning procedure like it is done when patterns are recognized. The signal processing appears “pattern recognition” and could be adjusted to recognize any patterns. Physical nature of a patterns depends on a sensor (optical, audio etc.).

When a contrast (like a pattern of something) is established by a learning procedure and is detected while a real mixture “signal and noise” is processed, which appears detected would be an artificial signal for an artificial TV. This apparatus will switch on brightness of a dot on a screen under the influence of the signal. All dots will be lighted or not in accordance with results of a concrete signal processing during a concrete physical experiment. Correspondent information will be distributed on the screen of ATV by a scanning circuit of ATV in sense of either time or space/time. Such device would be useful in scientific, medical, military etc. applications, like a personal eye of a blind person (with a signal to influence directly on brain). an instrument of an operator of a technology etc.

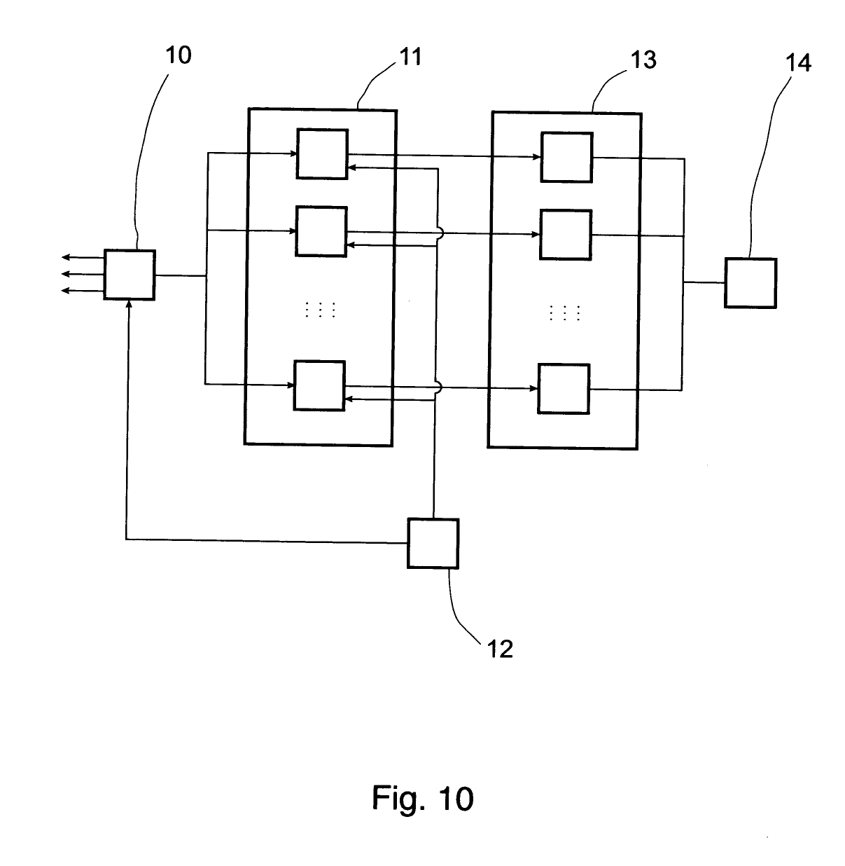

On FIG. 10, the block scheme is represented to detect a signal in a mixture with noise and to get information for ATV. It includes the block 10 of physical observation by any sensor. The same block provides preliminary signal processing including ADT. A stream of data (regular fractions) enters the block 11 which provides said operational sets gotten by a reclassification of initial fractions.

The block 12 provides time/intensity processing of data a) by sampling operational streams and b) by calculating the samples applying a formula. Correspondent arrows show the block 12 controls both physical (by time) and operational (by orders) elements of signal processing.

The set of time-intensity measures m(l,t) estimates diversity of a current structure of data separately in respect to each operational stream. The measures like m(l,t) are summarized by the block 13 into ones like M(l) that could be compared “by sets” to decide whether or not a signal is detected in noise on a set. If the signal is detected, the block 13 creates a signal for the block 14 (ATV) which provides a proper brightness of a dot on a screen. Screening circuit of ATV is not shown on FIG. 10. Learning procedures are not shown as well.

It depends on an application. Some of them could work with a constant tuning an apparatus while others may need adjusting in accordance with a real situation. Complete procedure of computing is kept by a file which could be represented electronically.

The procedure of computing could be described by the tables 4a, 4b and 4c, look at Appendix. The tables represent three of four steps of computing. The first step (table 4a) concerns preparing data for a learning procedure. The function sine(2*pi*t/T) is used like “a signal” which is masked by noise. It is computed with T=20.0, t from 0 to 24 and represented at the table 4a. Noise is generated by computer applying the command of the language Java to get an uniform noise. It is the command “Math.random( )”. Other kinds of generators were tested also. Noise is represented at the table 4a separately and in mixture with the signal. It is the mixture of ratio signal/noise 1:1. Different ratio are tested also. But additional operational streams used for detecting a signal are normalized and signal processing do not depend on initial ration signal/noise.

The table 4b represent a part of data concerning the second step of processing. It is the step to create the additional operational streams. Entire procedure includes 10 levels of cutting off current top digits. They are indexed by “1”. At Appendix, only the first levels l=1 is printed. All levels are in file named “table 4b” and written on compact discs CD1 and CD2 of the application. A printed part of table 4b reflects a part of data prepared to compute appropriate measures.

A real situation is modeled by the only mixture of a signal and noise, which is prepared here artificially (represented by table 4a). Both signal and noise are known on the phase of learning. They are represented by the table 4a as well. The table 4b represents the initial mixture which is artificially transformed into 10 operational sets. Printed page represents the first artificial operational set. For the purpose of learning, both initial signal and noise are transformed into additional operational sets as well. Printed page represents the first operational set of signal and the first operational set of noise.

Step 3 of signal processing is not represented here. Inverse tangent function is calculated on this step by dividing samples of each operational set taken with a shift equal 5 indexes to model samples of sine and cosine functions. But actually a mixture is computed of a sine function and noise. The table 4c represents normalized measures of each operational set gotten by adding all partial measures for all moments of time.

This table represents the main consistent result of the invention. A mixture of signal and noise appears on all levels of intensity smoothed by a signal. It is seen in comparison with noise. Noise is measured by the number 29. the mixture by numbers from 11 to 16. It means, a signal could be detected by this method in a mixture with noise.

Another embodiment of the invention is offered for mobile or even pocket size passive bearing. This technique needs receiving at least two signals of one object to be processed together in order to measure a time or phase difference between the signals and to count bearing of the object on the base of this information. The problem is bearing suffers from rather a mathematical problem: an optimal distance should be kept between sensors that receive the signals.

When the sensors are placed too close together (or too far one from another) the procedure demands much more exactness on the level of data in order to get the same exactness on the level of a result. It happen thanks to a peculiarity of the situation: the smaller is the difference between external signals at the place of receiving the signals, the lower is a physical intensity of the difference between the signals and, accordingly, the deeper is an order of decimal numbers that represent the difference. But the result (unknown coordinates of the object) should be represented by entire numbers (it corresponds to entire physical intensity of signals.

It looks like dividing entire bearing into 2 parts that differ by physical/numeric intensity. The first part of bearing (which is represented by the most part of physical/numeric intensity) takes responsibility for the situation near an object of bearing. The second part (which is represented by the rest of intensity) takes responsibility for signal processing. It means, the same signals and the same numbers serve differently an object of bearing and the bearing proper. And what is more, an intensive part of bearing camouflages a weak part of beating as if the same bearing gives information and camouflages the same information.

It is a natural phenomenon which is almost invisible if an optimal distance is established between sensors. But it becomes visible when, for example a short distance measuring base is applied in bearing. It looks like a natural production of a signal in mixture with noise when Nature resists a procedure. By other words, it is a production of an informational event by a physical medium.

In any case, the current invention could resolve this problem. It is the problem of a signal in mixture with noise and it is the problem of the dimension of intensity of both physical and numerical essences.

Prior art cannot resolve this problem. Prior art acts at the plane “time*intensity” while a technique to deal in details of intensity is not developed yet. Prior art cannot process signals of mobile bearing and it is why prior art denies mobile bearing. It explains, for example, huge cosmic navigation. It results from wrong understanding mobile local navigation which is much more cheaper and tactically much more usable. Cosmic navigation results from wrong arithmetics which is historically tuned not to classify numbers by orders of decimal numbers. But arithmetics is a man made phenomenon while conditions of bearing are defined by a natural phenomenon. Which is natural evidently has priority of attention. However, clever mathematics ignores this discrepancy. It is a real defect of human logic. It shows mathematics is insufficient to resolve all problems of cognition because is full of problems not to be resolved mathematically. Current physics is based on such mathematics and it is a dangerous situation in respect to human cognition.

So, a part of each number of a signal processing in respect to bearing is camouflaged by another part of the same numbers. It is the situation when a classification like dichotomy (dividing into two parts) is demanded with different processing different parts.

The invention offers a physical processing high intensity of signals and a signal processing of low intensity of numbers. Sensors should be placed as close to each others as it is possible thanks to physical conditions: to get enough significant orders for numeric signal processing. It would result in replacing information of bearing into lower levels of numbers.

The processing “by intensity” is offered by the current invention to deal in any levels of intensity. For bearing, a pattern of line “x(t)=y(t)” is offered to keep processing. It is the pattern not to notice a common (the same) distortion of both signals x and y and to notice any difference between x and y. The closer sensors are placed each in respect to another, the less influence of the same external noise and obstacles into the differences between signals (both catch almost the same external noise/hindrances). Side effect of such decision (replacing the difference between signal into levels of low intensity) could be overcome by the method offered by the invention to deal in normalized operational sets that represent different steps of intensity.

The sets are created by a reclassification of orders of initial numbers gotten by sensors. It maximizes the vision of small difference between signals and minimizes influence of variations the same for both signals.

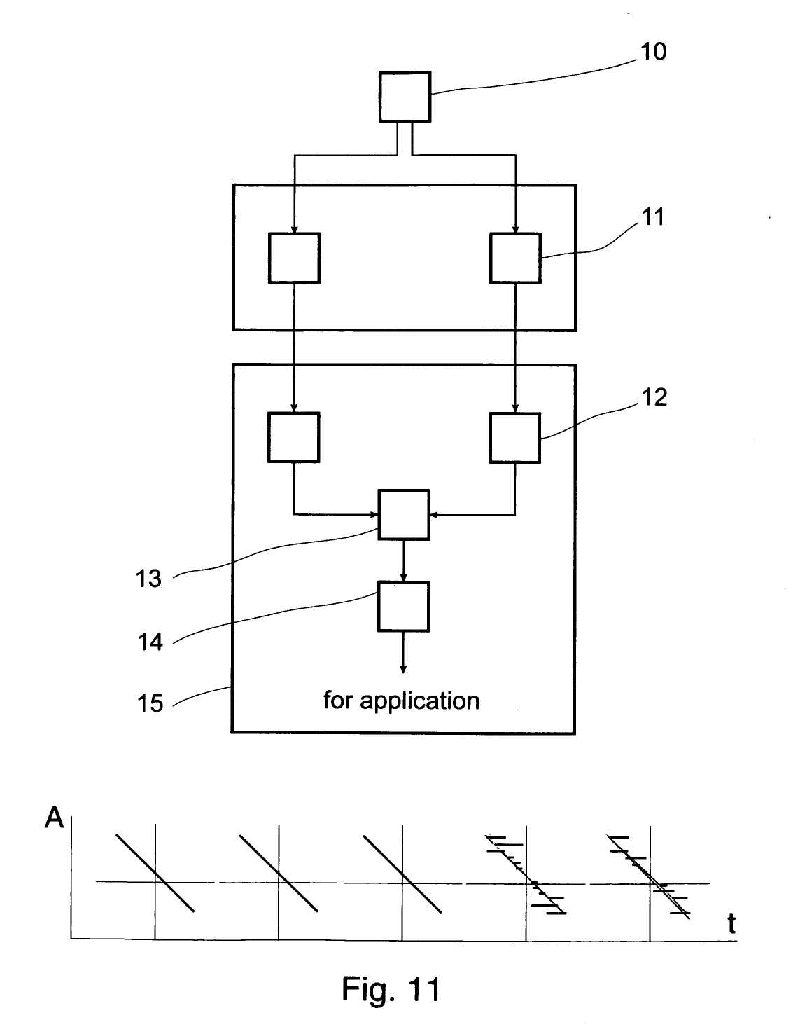

On FIG. 11, the scheme is drawn of processing passive bearing. The block 10 is an object of processing. The block 11 represents a physical part of mobile bearing which includes sensors and means of prime processing the signals like amplifying and ADT. The set of normalized data (regular fractions) is sent to the block of data processing 15 (a computer) belonging to the same mobile equipment of bearing. The stream of data is reclassified by the block 12 into separate operational sets.

The block 13 provides getting correspondent (of the same level 1) arguments x(t)—of one signal of bearing and y(t)—of another signal of bearing by each instance of said pattern of line to come from correspondent operational sets created by the block 12.

In result, entire dimension of intensity appears represented “by orders of intensity” like it is represented on the scheme on FIG. 11 below: highest orders keep “nothing” (there is similarity of the signals on the levels of high intensity). Lower levels of intensity reveal the difference between signals. It is just useful information of bearing.

Mobile and compact (even a pocket size) bearing may find a lot of applications. Many of them could be realized by weak signals and even by signals under a special masked noise. Some applications need exactness of navigation, others do not. A lot of toys on this theme may be manufactured and sold for kids and adults.

Other applications may become home devices of everyday usage like means to keep security around a person or building or to find lost goods. Similar equipments could keep in touch people during a trip.

TABLE 1-as
T = 40

| | | 1 | 2 |
|---|---|---|---|
| l = 0 | t = 1 | S = 0.15643446504 | SA [l] [t] = 0.15643446504 |
| l = 0 | t = 2 | S = 0.30901699437 | SA [l] [t] = 0.30901699437 |
| l = 0 | t = 3 | S = 0.45399049973 | SA [l] [t] = 0.45399049973 |
| l = 0 | t = 4 | S = 0.58778525229 | SA [l] [t] = 0.58778525229 |
| l = 0 | t = 5 | S = 0.70710678118 | SA [l] [t] = 0.70710678118 |
| l = 0 | t = 6 | S = 0.80901699437 | SA [l] [t] = 0.80901699437 |
| l = 0 | t = 7 | S = 0.89100652418 | SA [l] [t] = 0.89100652418 |
| l = 0 | t = 8 | S = 0.95105651629 | SA [l] [t] = 0.95105651629 |
| l = 0 | t = 9 | S = 0.98768834059 | SA [l] [t] = 0.98768834059 |
| l = 0 | t = 10 | S = 0.0 | SA [l] [t] = 0.0 |
| l = 0 | t = 11 | S = 0.98768834059 | SA [l] [t] = 0.98768834059 |
| l = 0 | t = 12 | S = 0.95105651629 | SA [l] [t] = 0.95105651629 |
| l = 0 | t = 13 | S = 0.89100652418 | SA [l] [t] = 0.89100652418 |
| l = 0 | t = 14 | S = 0.80901699437 | SA [l] [t] = 0.80901699437 |
| l = 0 | t = 15 | S = 0.70710678118 | SA [l] [t] = 0.70710678118 |
| l = 0 | t = 16 | S = 0.58778525229 | SA [l] [t] = 0.58778525229 |
| l = 0 | t = 17 | S = 0.45399049973 | SA [l] [t] = 0.45399049973 |
| l = 0 | t = 18 | S = 0.30901699437 | SA [l] [t] = 0.30901699437 |
| l = 0 | t = 19 | S = 0.15643446504 | SA [l] [t] = 0.15643446504 |
| l = 0 | t = 20 | S = 0.0 | SA [l] [t] = 0.0 |
| l = 0 | t = 21 | S = −0.15643446504 | SA [l] [t] = −0.15643446504 |
| l = 0 | t = 22 | S = −0.30901699437 | SA [l] [t] = −0.30901699437 |
| l = 0 | t = 23 | S = −0.45399049973 | SA [l] [t] = −0.45399049973 |
| l = 0 | t = 24 | S = −0.58778525229 | SA [l] [t] = −0.58778525229 |
| l = 0 | t = 25 | S = −0.70710678118 | SA [l] [t] = −0.70710678118 |
| l = 0 | t = 26 | S = −0.80901699437 | SA [l] [t] = −0.80901699437 |
| l = 0 | t = 27 | S = −0.89100652418 | SA [l] [t] = −0.89100652418 |
| l = 0 | t = 28 | S = −0.95105651629 | SA [l] [t] = −0.95105651629 |
| l = 0 | t = 29 | S = −0.98768834059 | SA [l] [t] = −0.98768834059 |
| l = 0 | t = 30 | S = −0.0 | SA [l] [t] = −0.0 |
| l = 0 | t = 31 | S = −0.98768834059 | SA [l] [t] = −0.98768834059 |
| l = 0 | t = 32 | S = −0.95105651629 | SA [l] [t] = −0.95105651629 |
| l = 0 | t = 33 | S = −0.89100652418 | SA [l] [t] = −0.89100652418 |
| l = 0 | t = 34 | S = −0.80901699437 | SA [l] [t] = −0.80901699437 |
| l = 0 | t = 35 | S = −0.70710678118 | SA [l] [t] = −0.70710678118 |
| l = 0 | t = 36 | S = −0.58778525229 | SA [l] [t] = −0.58778525229 |
| l = 0 | t = 37 | S = −0.45399049973 | SA [l] [t] = −0.45399049973 |
| l = 0 | t = 38 | S = −0.30901699437 | SA [l] [t] = −0.30901699437 |
| l = 0 | t = 39 | S = −0.15643446504 | SA [l] [t] = −0.15643446504 |
| l = 0 | t = 40 | S = −0.0 | SA [l] [t] = −0.0 |
| l = 0 | t = 41 | S = 0.15643446504 | SA [l] [t] = 0.15643446504 |
| l = 0 | t = 42 | S = 0.30901699437 | SA [l] [t] = 0.30901699437 |
| l = 0 | t = 43 | S = 0.45399049973 | SA [l] [t] = 0.45399049973 |
| l = 0 | t = 44 | S = 0.58778525229 | SA [l] [t] = 0.58778525229 |
| l = 0 | t = 45 | S = 0.70710678118 | SA [l] [t] = 0.70710678118 |
| l = 0 | t = 46 | S = 0.80901699437 | SA [l] [t] = 0.80901699437 |
| l = 0 | t = 47 | S = 0.89100652418 | SA [l] [t] = 0.89100652418 |
| l = 0 | t = 48 | S = 0.95105651629 | SA [l] [t] = 0.95105651629 |
| l = 0 | t = 49 | S = 0.98768834059 | SA [l] [t] = 0.98768834059 |
| l = 1 | t = 1 | S = 0.15643446504 | SA [l] [t] = 0.5643446504 |
| l = 1 | t = 2 | S = 0.30901699437 | SA [l] [t] = 0.0901699437 |
| l = 1 | t = 3 | S = 0.45399049973 | SA [l] [t] = 0.5399049973 |
| l = 1 | t = 4 | S = 0.58778525229 | SA [l] [t] = 0.8778525229 |
| l = 1 | t = 5 | S = 0.70710678118 | SA [l] [t] = 0.0710678118 |
| l = 1 | t = 6 | S = 0.80901699437 | SA [l] [t] = 0.0901699437 |
| l = 1 | t = 7 | S = 0.89100652418 | SA [l] [t] = 0.9100652418 |
| l = 1 | t = 8 | S = 0.95105651629 | SA [l] [t] = 0.5105651629 |
| l = 1 | t = 9 | S = 0.98768834059 | SA [l] [t] = 0.8768834059 |
| l = 1 | t = 10 | S = 0.0 | SA [l] [t] = 0.0 |
| l = 1 | t = 11 | S = 0.98768834059 | SA [l] [t] = 0.8768834059 |
| l = 1 | t = 12 | S = 0.95105651629 | SA [l] [t] = 0.5105651629 |
| l = 1 | t = 13 | S = 0.89100652418 | SA [l] [t] = 0.9100652418 |
| l = 1 | t = 14 | S = 0.80901699437 | SA [l] [t] = 0.0901699437 |
| l = 1 | t = 15 | S = 0.70710678118 | SA [l] [t] = 0.0710678118 |
| l = 1 | t = 16 | S = 0.58778525229 | SA [l] [t] = 0.8778525229 |
| l = 1 | t = 17 | S = 0.45399049973 | SA [l] [t] = 0.5399049973 |
| l = 1 | t = 18 | S = 0.30901699437 | SA [l] [t] = 0.0901699437 |
| l = 1 | t = 19 | S = 0.15643446504 | SA [l] [t] = 0.5643446504 |
| l = 1 | t = 20 | S = 0.0 | SA [l] [t] = 0.0 |
| l = 1 | t = 21 | S = −0.15643446504 | SA [l] [t] = −0.5643446504 |
| l = 1 | t = 22 | S = −0.30901699437 | SA [l] [t] = −0.0901699437 |
| l = 1 | t = 23 | S = −0.45399049973 | SA [l] [t] = −0.5399049973 |
| l = 1 | t = 24 | S = −0.58778525229 | SA [l] [t] = −0.8778525229 |
| l = 1 | t = 25 | S = −0.70710678118 | SA [l] [t] = −0.0710678118 |
| l = 1 | t = 26 | S = −0.80901699437 | SA [l] [t] = −0.0901699437 |
| l = 1 | t = 27 | S = −0.89100652418 | SA [l] [t] = −0.9100652418 |
| l = 1 | t = 28 | S = −0.95105651629 | SA [l] [t] = −0.5105651629 |
| l = 1 | t = 29 | S = −0.98768834059 | SA [l] [t] = −0.8768834059 |
| l = 1 | t = 30 | S = −0.0 | SA [l] [t] = −0.0 |
| l = 1 | t = 31 | S = −0.98768834059 | SA [l] [t] = −0.8768834059 |
| l = 1 | t = 32 | S = −0.95105651629 | SA [l] [t] = −0.5105651629 |
| l = 1 | t = 33 | S = −0.89100652418 | SA [l] [t] = −0.9100652418 |
| l = 1 | t = 34 | S = −0.80901699437 | SA [l] [t] = −0.0901699437 |
| l = 1 | t = 35 | S = −0.70710678118 | SA [l] [t] = −0.0710678118 |
| l = 1 | t = 36 | S = −0.58778525229 | SA [l] [t] = −0.8778525229 |
| l = 1 | t = 37 | S = −0.45399049973 | SA [l] [t] = −0.5399049973 |
| l = 1 | t = 38 | S = −0.30901699437 | SA [l] [t] = −0.0901699437 |
| l = 1 | t = 39 | S = −0.15643446504 | SA [l] [t] = −0.5643446504 |
| l = 1 | t = 40 | S = −0.0 | SA [l] [t] = −0.0 |
| l = 1 | t = 41 | S = 0.15643446504 | SA [l] [t] = 0.5643446504 |
| l = 1 | t = 42 | S = 0.30901699437 | SA [l] [t] = 0.0901699437 |
| l = 1 | t = 43 | S = 0.45399049973 | SA [l] [t] = 0.5399049973 |
| l = 1 | t = 44 | S = 0.58778525229 | SA [l] [t] = 0.8778525229 |
| l = 1 | t = 45 | S = 0.70710678118 | SA [l] [t] = 0.0710678118 |
| l = 1 | t = 46 | S = 0.80901699437 | SA [l] [t] = 0.0901699437 |
| l = 1 | t = 47 | S = 0.89100652418 | SA [l] [t] = 0.9100652418 |
| l = 1 | t = 48 | S = 0.95105651629 | SA [l] [t] = 0.5105651629 |
| l = 1 | t = 49 | S = 0.98768834059 | SA [l] [t] = 0.8768834059 |
| l = 2 | t = 1 | S = 0.15643446504 | SA [l] [t] = 0.643446504 |
| l = 2 | t = 2 | S = 0.30901699437 | SA [l] [t] = 0.901699437 |
| l = 2 | t = 3 | S = 0.45399049973 | SA [l] [t] = 0.399049973 |
| l = 2 | t = 4 | S = 0.58778525229 | SA [l] [t] = 0.778525229 |
| l = 2 | t = 5 | S = 0.70710678118 | SA [l] [t] = 0.710678118 |
| l = 2 | t = 6 | S = 0.80901699437 | SA [l] [t] = 0.901699437 |
| l = 2 | t = 7 | S = 0.89100652418 | SA [l] [t] = 0.100652418 |
| l = 2 | t = 8 | S = 0.95105651629 | SA [l] [t] = 0.105651629 |
| l = 2 | t = 9 | S = 0.98768834059 | SA [l] [t] = 0.768834059 |
| l = 2 | t = 10 | S = 0.0 | SA [l] [t] = 0.0 |
| l = 2 | t = 11 | S = 0.98768834059 | SA [l] [t] = 0.768834059 |
| l = 2 | t = 12 | S = 0.95105651629 | SA [l] [t] = 0.105651629 |
| l = 2 | t = 13 | S = 0.89100652418 | SA [l] [t] = 0.100652418 |
| l = 2 | t = 14 | S = 0.80901699437 | SA [l] [t] = 0.901699437 |
| l = 2 | t = 15 | S = 0.70710678118 | SA [l] [t] = 0.710678118 |
| l = 2 | t = 16 | S = 0.58778525229 | SA [l] [t] = 0.778525229 |
| l = 2 | t = 17 | S = 0.45399049973 | SA [l] [t] = 0.399049973 |
| l = 2 | t = 18 | S = 0.30901699437 | SA [l] [t] = 0.901699437 |
| l = 2 | t = 19 | S = 0.15643446504 | SA [l] [t] = 0.643446504 |
| l = 2 | t = 20 | S = 0.0 | SA [l] [t] = 0.0 |
| l = 2 | t = 21 | S = −0.15643446504 | SA [l] [t] = −0.643446504 |
| l = 2 | t = 22 | S = −0.30901699437 | SA [l] [t] = −0.901699437 |
| l = 2 | t = 23 | S = −0.45399049973 | SA [l] [t] = −0.399049973 |
| l = 2 | t = 24 | S = −0.58778525229 | SA [l] [t] = −0.778525229 |
| l = 2 | t = 25 | S = −0.70710678118 | SA [l] [t] = −0.710678118 |
| l = 2 | t = 26 | S = −0.80901699437 | SA [l] [t] = −0.901699437 |
| l = 2 | t = 27 | S = −0.89100652418 | SA [l] [t] = −0.100652418 |
| l = 2 | t = 28 | S = −0.95105651629 | SA [l] [t] = −0.105651629 |
| l = 2 | t = 29 | S = −0.98768834059 | SA [l] [t] = −0.768834059 |
| l = 2 | t = 30 | S = −0.0 | SA [l] [t] = −0.0 |
| l = 2 | t = 31 | S = −0.98768834059 | SA [l] [t] = −0.768834059 |
| l = 2 | t = 32 | S = −0.95105651629 | SA [l] [t] = −0.105651629 |
| l = 2 | t = 33 | S = −0.89100652418 | SA [l] [t] = −0.100652418 |
| l = 2 | t = 34 | S = −0.80901699437 | SA [l] [t] = −0.901699437 |
| l = 2 | t = 35 | S = −0.70710678118 | SA [l] [t] = −0.710678118 |
| l = 2 | t = 36 | S = −0.58778525229 | SA [l] [t] = −0.778525229 |
| l = 2 | t = 37 | S = −0.45399049973 | SA [l] [t] = −0.399049973 |
| l = 2 | t = 38 | S = −0.30901699437 | SA [l] [t] = −0.901699437 |
| l = 2 | t = 39 | S = −0.15643446504 | SA [l] [t] = −0.643446504 |
| l = 2 | t = 40 | S = −0.0 | SA [l] [t] = −0.0 |
| l = 2 | t = 41 | S = 0.15643446504 | SA [l] [t] = 0.643446504 |
| l = 2 | t = 42 | S = 0.30901699437 | SA [l] [t] = 0.901699437 |
| l = 2 | t = 43 | S = 0.45399049973 | SA [l] [t] = 0.399049973 |
| l = 2 | t = 44 | S = 0.58778525229 | SA [l] [t] = 0.778525229 |
| l = 2 | t = 45 | S = 0.70710678118 | SA [l] [t] = 0.710678118 |
| l = 2 | t = 46 | S = 0.80901699437 | SA [l] [t] = 0.901699437 |
| l = 2 | t = 47 | S = 0.89100652418 | SA [l] [t] = 0.100652418 |
| l = 2 | t = 48 | S = 0.95105651629 | SA [l] [t] = 0.105651629 |
| l = 2 | t = 49 | S = 0.98768834059 | SA [l] [t] = 0.768834059 |
| l = 3 | t = 1 | S = 0.15643446504 | SA [l] [t] = 0.43446504 |
| l = 3 | t = 2 | S = 0.30901699437 | SA [l] [t] = 0.01699437 |
| l = 3 | t = 3 | S = 0.45399049973 | SA [l] [t] = 0.99049973 |
| l = 3 | t = 4 | S = 0.58778525229 | SA [l] [t] = 0.78525229 |
| l = 3 | t = 5 | S = 0.70710678118 | SA [l] [t] = 0.10678118 |
| l = 3 | t = 6 | S = 0.80901699437 | SA [l] [t] = 0.01699437 |
| l = 3 | t = 7 | S = 0.89100652418 | SA [l] [t] = 0.00652418 |
| l = 3 | t = 8 | S = 0.95105651629 | SA [l] [t] = 0.05651629 |
| l = 3 | t = 9 | S = 0.98768834059 | SA [l] [t] = 0.68834059 |
| l = 3 | t = 10 | S = 0.0 | SA [l] [t] = 0.0 |
| l = 3 | t = 11 | S = 0.98768834059 | SA [l] [t] = 0.68834059 |
| l = 3 | t = 12 | S = 0.95105651629 | SA [l] [t] = 0.05651629 |
| l = 3 | t = 13 | S = 0.89100652418 | SA [l] [t] = 0.00652418 |
| l = 3 | t = 14 | S = 0.80901699437 | SA [l] [t] = 0.01699437 |
| l = 3 | t = 15 | S = 0.70710678118 | SA [l] [t] = 0.10678118 |
| l = 3 | t = 16 | S = 0.58778525229 | SA [l] [t] = 0.78525229 |
| l = 3 | t = 17 | S = 0.45399049973 | SA [l] [t] = 0.99049973 |
| l = 3 | t = 18 | S = 0.30901699437 | SA [l] [t] = 0.01699437 |
| l = 3 | t = 19 | S = 0.15643446504 | SA [l] [t] = 0.43446504 |
| l = 3 | t = 20 | S = 0.0 | SA [l] [t] = 0.0 |
| l = 3 | t = 21 | S = −0.15643446504 | SA [l] [t] = −0.43446504 |
| l = 3 | t = 22 | S = −0.30901699437 | SA [l] [t] = −0.01699437 |
| l = 3 | t = 23 | S = −0.45399049973 | SA [l] [t] = −0.99049973 |
| l = 3 | t = 24 | S = −0.58778525229 | SA [l] [t] = −0.78525229 |
| l = 3 | t = 25 | S = −0.70710678118 | SA [l] [t] = −0.10678118 |
| l = 3 | t = 26 | S = −0.80901699437 | SA [l] [t] = −0.01699437 |
| l = 3 | t = 27 | S = −0.89100652418 | SA [l] [t] = −0.00652418 |
| l = 3 | t = 28 | S = −0.95105651629 | SA [l] [t] = −0.05651629 |
| l = 3 | t = 29 | S = −0.98768834059 | SA [l] [t] = −0.68834059 |
| l = 3 | t = 30 | S = −0.0 | SA [l] [t] = −0.0 |
| l = 3 | t = 31 | S = −0.98768834059 | SA [l] [t] = −0.68834059 |
| l = 3 | t = 32 | S = −0.95105651629 | SA [l] [t] = −0.05651629 |
| l = 3 | t = 33 | S = −0.89100652418 | SA [l] [t] = −0.00652418 |
| l = 3 | t = 34 | S = −0.80901699437 | SA [l] [t] = −0.01699437 |
| l = 3 | t = 35 | S = −0.70710678118 | SA [l] [t] = −0.10678118 |
| l = 3 | t = 36 | S = −0.58778525229 | SA [l] [t] = −0.78525229 |
| l = 3 | t = 37 | S = −0.45399049973 | SA [l] [t] = −0.99049973 |
| l = 3 | t = 38 | S = −0.30901699437 | SA [l] [t] = −0.01699437 |
| l = 3 | t = 39 | S = −0.15643446504 | SA [l] [t] = −0.43446504 |
| l = 3 | t = 40 | S = −0.0 | SA [l] [t] = −0.0 |
| l = 3 | t = 41 | S = 0.15643446504 | SA [l] [t] = 0.43446504 |
| l = 3 | t = 42 | S = 0.30901699437 | SA [l] [t] = 0.01699437 |
| l = 3 | t = 43 | S = 0.45399049973 | SA [l] [t] = 0.99049973 |
| l = 3 | t = 44 | S = 0.58778525229 | SA [l] [t] = 0.78525229 |
| l = 3 | t = 45 | S = 0.70710678118 | SA [l] [t] = 0.10678118 |
| l = 3 | t = 46 | S = 0.80901699437 | SA [l] [t] = 0.01699437 |
| l = 3 | t = 47 | S = 0.89100652418 | SA [l] [t] = 0.00652418 |
| l = 3 | t = 48 | S = 0.95105651629 | SA [l] [t] = 0.05651629 |
| l = 3 | t = 49 | S = 0.98768834059 | SA [l] [t] = 0.68834059 |
| l = 4 | t = 1 | S = 0.15643446504 | SA [l] [t] = 0.3446504 |
| l = 4 | t = 2 | S = 0.30901699437 | SA [l] [t] = 0.1699437 |
| l = 4 | t = 3 | S = 0.45399049973 | SA [l] [t] = 0.9049973 |
| l = 4 | t = 4 | S = 0.58778525229 | SA [l] [t] = 0.8525229 |
| l = 4 | t = 5 | S = 0.70710678118 | SA [l] [t] = 0.0678118 |
| l = 4 | t = 6 | S = 0.80901699437 | SA [l] [t] = 0.1699437 |
| l = 4 | t = 7 | S = 0.89100652418 | SA [l] [t] = 0.0652418 |
| l = 4 | t = 8 | S = 0.95105651629 | SA [l] [t] = 0.5651629 |
| l = 4 | t = 9 | S = 0.98768834059 | SA [l] [t] = 0.8834059 |
| l = 4 | t = 10 | S = 0.0 | SA [l] [t] = 0.0 |
| l = 4 | t = 11 | S = 0.98768834059 | SA [l] [t] = 0.8834059 |
| l = 4 | t = 12 | S = 0.95105651629 | SA [l] [t] = 0.5651629 |
| l = 4 | t = 13 | S = 0.89100652418 | SA [l] [t] = 0.0652418 |
| l = 4 | t = 14 | S = 0.80901699437 | SA [l] [t] = 0.1699437 |
| l = 4 | t = 15 | S = 0.70710678118 | SA [l] [t] = 0.0678118 |
| l = 4 | t = 16 | S = 0.58778525229 | SA [l] [t] = 0.8525229 |
| l = 4 | t = 17 | S = 0.45399049973 | SA [l] [t] = 0.9049973 |
| l = 4 | t = 18 | S = 0.30901699437 | SA [l] [t] = 0.1699437 |
| l = 4 | t = 19 | S = 0.15643446504 | SA [l] [t] = 0.3446504 |
| l = 4 | t = 20 | S = 0.0 | SA [l] [t] = 0.0 |
| l = 4 | t = 21 | S = −0.15643446504 | SA [l] [t] = −0.3446504 |
| l = 4 | t = 22 | S = −0.30901699437 | SA [l] [t] = −0.1699437 |
| l = 4 | t = 23 | S = −0.45399049973 | SA [l] [t] = −0.9049973 |
| l = 4 | t = 24 | S = −0.58778525229 | SA [l] [t] = −0.8525229 |
| l = 4 | t = 25 | S = −0.70710678118 | SA [l] [t] = −0.0678118 |
| l = 4 | t = 26 | S = −0.80901699437 | SA [l] [t] = −0.1699437 |
| l = 4 | t = 27 | S = −0.89100652418 | SA [l] [t] = −0.0652418 |
| l = 4 | t = 28 | S = −0.95105651629 | SA [l] [t] = −0.5651629 |
| l = 4 | t = 29 | S = −0.98768834059 | SA [l] [t] = −0.8834059 |
| l = 4 | t = 30 | S = −0.0 | SA [l] [t] = −0.0 |
| l = 4 | t = 31 | S = −0.98768834059 | SA [l] [t] = −0.8834059 |
| l = 4 | t = 32 | S = −0.95105651629 | SA [l] [t] = −0.5651629 |
| l = 4 | t = 33 | S = −0.89100652418 | SA [l] [t] = −0.0652418 |
| l = 4 | t = 34 | S = −0.80901699437 | SA [l] [t] = −0.1699437 |
| l = 4 | t = 35 | S = −0.70710678118 | SA [l] [t] = −0.0678118 |
| l = 4 | t = 36 | S = −0.58778525229 | SA [l] [t] = −0.8525229 |
| l = 4 | t = 37 | S = −0.45399049973 | SA [l] [t] = −0.9049973 |
| l = 4 | t = 38 | S = −0.30901699437 | SA [l] [t] = −0.1699437 |
| l = 4 | t = 39 | S = −0.15643446504 | SA [l] [t] = −0.3446504 |
| l = 4 | t = 40 | S = −0.0 | SA [l] [t] = −0.0 |
| l = 4 | t = 41 | S = 0.15643446504 | SA [l] [t] = 0.3446504 |
| l = 4 | t = 42 | S = 0.30901699437 | SA [l] [t] = 0.1699437 |
| l = 4 | t = 43 | S = 0.45399049973 | SA [l] [t] = 0.9049973 |
| l = 4 | t = 44 | S = 0.58778525229 | SA [l] [t] = 0.8525229 |
| l = 4 | t = 45 | S = 0.70710678118 | SA [l] [t] = 0.0678118 |
| l = 4 | t = 46 | S = 0.80901699437 | SA [l] [t] = 0.1699437 |
| l = 4 | t = 47 | S = 0.89100652418 | SA [l] [t] = 0.0652418 |
| l = 4 | t = 48 | S = 0.95105651629 | SA [l] [t] = 0.5651629 |
| l = 4 | t = 49 | S = 0.98768834059 | SA [l] [t] = 0.8834059 |
| l = 5 | t = 1 | S = 0.15643446504 | SA [l] [t] = 0.446504 |
| l = 5 | t = 2 | S = 0.30901699437 | SA [l] [t] = 0.699437 |
| l = 5 | t = 3 | S = 0.45399049973 | SA [l] [t] = 0.049973 |
| l = 5 | t = 4 | S = 0.58778525229 | SA [l] [t] = 0.525229 |
| l = 5 | t = 5 | S = 0.70710678118 | SA [l] [t] = 0.678118 |
| l = 5 | t = 6 | S = 0.80901699437 | SA [l] [t] = 0.699437 |
| l = 5 | t = 7 | S = 0.89100652418 | SA [l] [t] = 0.652418 |
| l = 5 | t = 8 | S = 0.95105651629 | SA [l] [t] = 0.651629 |
| l = 5 | t = 9 | S = 0.98768834059 | SA [l] [t] = 0.834059 |
| l = 5 | t = 10 | S = 0.0 | SA [l] [t] = 0.0 |
| l = 5 | t = 11 | S = 0.98768834059 | SA [l] [t] = 0.834059 |
| l = 5 | t = 12 | S = 0.95105651629 | SA [l] [t] = 0.651629 |
| l = 5 | t = 13 | S = 0.89100652418 | SA [l] [t] = 0.652418 |
| l = 5 | t = 14 | S = 0.80901699437 | SA [l] [t] = 0.699437 |
| l = 5 | t = 15 | S = 0.70710678118 | SA [l] [t] = 0.678118 |
| l = 5 | t = 16 | S = 0.58778525229 | SA [l] [t] = 0.525229 |
| l = 5 | t = 17 | S = 0.45399049973 | SA [l] [t] = 0.049973 |
| l = 5 | t = 18 | S = 0.30901699437 | SA [l] [t] = 0.699437 |
| l = 5 | t = 19 | S = 0.15643446504 | SA [l] [t] = 0.446504 |
| l = 5 | t = 20 | S = 0.0 | SA [l] [t] = 0.0 |
| l = 5 | t = 21 | S = −0.15643446504 | SA [l] [t] = −0.446504 |
| l = 5 | t = 22 | S = −0.30901699437 | SA [l] [t] = −0.699437 |
| l = 5 | t = 23 | S = −0.45399049973 | SA [l] [t] = −0.049973 |
| l = 5 | t = 24 | S = −0.58778525229 | SA [l] [t] = −0.525229 |
| l = 5 | t = 25 | S = −0.70710678118 | SA [l] [t] = −0.678118 |
| l = 5 | t = 26 | S = −0.80901699437 | SA [l] [t] = −0.699437 |
| l = 5 | t = 27 | S = −0.89100652418 | SA [l] [t] = −0.652418 |
| l = 5 | t = 28 | S = −0.95105651629 | SA [l] [t] = −0.651629 |
| l = 5 | t = 29 | S = −0.98768834059 | SA [l] [t] = −0.834059 |
| l = 5 | t = 30 | S = −0.0 | SA [l] [t] = −0.0 |
| l = 5 | t = 31 | S = −0.98768834059 | SA [l] [t] = −0.834059 |
| l = 5 | t = 32 | S = −0.95105651629 | SA [l] [t] = −0.651629 |
| l = 5 | t = 33 | S = −0.89100652418 | SA [l] [t] = −0.652418 |
| l = 5 | t = 34 | S = −0.80901699437 | SA [l] [t] = −0.699437 |
| l = 5 | t = 35 | S = −0.70710678118 | SA [l] [t] = −0.678118 |
| l = 5 | t = 36 | S = −0.58778525229 | SA [l] [t] = −0.525229 |
| l = 5 | t = 37 | S = −0.45399049973 | SA [l] [t] = −0.049973 |
| l = 5 | t = 38 | S = −0.30901699437 | SA [l] [t] = −0.699437 |
| l = 5 | t = 39 | S = −0.15643446504 | SA [l] [t] = −0.446504 |
| l = 5 | t = 40 | S = −0.0 | SA [l] [t] = −0.0 |
| l = 5 | t = 41 | S = 0.15643446504 | SA [l] [t] = 0.446504 |
| l = 5 | t = 42 | S = 0.30901699437 | SA [l] [t] = 0.699437 |
| l = 5 | t = 43 | S = 0.45399049973 | SA [l] [t] = 0.049973 |
| l = 5 | t = 44 | S = 0.58778525229 | SA [l] [t] = 0.525229 |
| l = 5 | t = 45 | S = 0.70710678118 | SA [l] [t] = 0.678118 |
| l = 5 | t = 46 | S = 0.80901699437 | SA [l] [t] = 0.699437 |
| l = 5 | t = 47 | S = 0.89100652418 | SA [l] [t] = 0.652418 |
| l = 5 | t = 48 | S = 0.95105651629 | SA [l] [t] = 0.651629 |
| l = 5 | t = 49 | S = 0.98768834059 | SA [l] [t] = 0.834059 |
| l = 6 | t = 1 | S = 0.15643446504 | SA [l] [t] = 0.46504 |
| l = 6 | t = 2 | S = 0.30901699437 | SA [l] [t] = 0.99437 |
| l = 6 | t = 3 | S = 0.45399049973 | SA [l] [t] = 0.49973 |
| l = 6 | t = 4 | S = 0.58778525229 | SA [l] [t] = 0.25229 |
| l = 6 | t = 5 | S = 0.70710678118 | SA [l] [t] = 0.78118 |
| l = 6 | t = 6 | S = 0.80901699437 | SA [l] [t] = 0.99437 |
| l = 6 | t = 7 | S = 0.89100652418 | SA [l] [t] = 0.52418 |
| l = 6 | t = 8 | S = 0.95105651629 | SA [l] [t] = 0.51629 |
| l = 6 | t = 9 | S = 0.98768834059 | SA [l] [t] = 0.34059 |
| l = 6 | t = 10 | S = 0.0 | SA [l] [t] = 0.0 |
| l = 6 | t = 11 | S = 0.98768834059 | SA [l] [t] = 0.34059 |
| l = 6 | t = 12 | S = 0.95105651629 | SA [l] [t] = 0.51629 |
| l = 6 | t = 13 | S = 0.89100652418 | SA [l] [t] = 0.52418 |
| l = 6 | t = 14 | S = 0.80901699437 | SA [l] [t] = 0.99437 |
| l = 6 | t = 15 | S = 0.70710678118 | SA [l] [t] = 0.78118 |
| l = 6 | t = 16 | S = 0.58778525229 | SA [l] [t] = 0.25229 |
| l = 6 | t = 17 | S = 0.45399049973 | SA [l] [t] = 0.49973 |
| l = 6 | t = 18 | S = 0.30901699437 | SA [l] [t] = 0.99437 |
| l = 6 | t = 19 | S = 0.15643446504 | SA [l] [t] = 0.46504 |
| l = 6 | t = 20 | S = 0.0 | SA [l] [t] = 0.0 |
| l = 6 | t = 21 | S = −0.15643446504 | SA [l] [t] = −0.46504 |
| l = 6 | t = 22 | S = −0.30901699437 | SA [l] [t] = −0.99437 |
| l = 6 | t = 23 | S = −0.45399049973 | SA [l] [t] = −0.49973 |
| l = 6 | t = 24 | S = −0.58778525229 | SA [l] [t] = −0.25229 |
| l = 6 | t = 25 | S = −0.70710678118 | SA [l] [t] = −0.78118 |
| l = 6 | t = 26 | S = −0.80901699437 | SA [l] [t] = −0.99437 |
| l = 6 | t = 27 | S = −0.89100652418 | SA [l] [t] = −0.52418 |
| l = 6 | t = 28 | S = −0.95105651629 | SA [l] [t] = −0.51629 |
| l = 6 | t = 29 | S = −0.98768834059 | SA [l] [t] = −0.34059 |
| l = 6 | t = 30 | S = −0.0 | SA [l] [t] = −0.0 |
| l = 6 | t = 31 | S = −0.98768834059 | SA [l] [t] = −0.34059 |
| l = 6 | t = 32 | S = −0.95105651629 | SA [l] [t] = −0.51629 |
| l = 6 | t = 33 | S = −0.89100652418 | SA [l] [t] = −0.52418 |
| l = 6 | t = 34 | S = −0.80901699437 | SA [l] [t] = −0.99437 |
| l = 6 | t = 35 | S = −0.70710678118 | SA [l] [t] = −0.78118 |
| l = 6 | t = 36 | S = −0.58778525229 | SA [l] [t] = −0.25229 |
| l = 6 | t = 37 | S = −0.45399049973 | SA [l] [t] = −0.49973 |
| l = 6 | t = 38 | S = −0.30901699437 | SA [l] [t] = −0.99437 |
| l = 6 | t = 39 | S = −0.15643446504 | SA [l] [t] = −0.46504 |
| l = 6 | t = 40 | S = −0.0 | SA [l] [t] = −0.0 |
| l = 6 | t = 41 | S = 0.15643446504 | SA [l] [t] = 0.46504 |
| l = 6 | t = 42 | S = 0.30901699437 | SA [l] [t] = 0.99437 |
| l = 6 | t = 43 | S = 0.45399049973 | SA [l] [t] = 0.49973 |
| l = 6 | t = 44 | S = 0.58778525229 | SA [l] [t] = 0.25229 |
| l = 6 | t = 45 | S = 0.70710678118 | SA [l] [t] = 0.78118 |
| l = 6 | t = 46 | S = 0.80901699437 | SA [l] [t] = 0.99437 |
| l = 6 | t = 47 | S = 0.89100652418 | SA [l] [t] = 0.52418 |
| l = 6 | t = 48 | S = 0.95105651629 | SA [l] [t] = 0.51629 |

1) S = SA [0] [t] = sine (2*pi*t/T), l = 0
2) partial SA [l] [t] from S = SA [0] [t] for l = 1 . . . 11

TABLE 1-ac
T = 40

| | | 1 | 2 |
|---|---|---|---|
| l = 0 | t = 1 | C = 0.98768834059 | CA [l] [t] = 0.98768834059 |
| l = 0 | t = 2 | C = 0.95105651629 | CA [l] [t] = 0.95105651629 |
| l = 0 | t = 3 | C = 0.89100652418 | CA [l] [t] = 0.89100652418 |
| l = 0 | t = 4 | C = 0.80901699437 | CA [l] [t] = 0.80901699437 |
| l = 0 | t = 5 | C = 0.70710678118 | CA [l] [t] = 0.70710678118 |
| l = 0 | t = 6 | C = 0.58778525229 | CA [l] [t] = 0.58778525229 |
| l = 0 | t = 7 | C = 0.45399049973 | CA [l] [t] = 0.45399049973 |
| l = 0 | t = 8 | C = 0.30901699437 | CA [l] [t] = 0.30901699437 |
| l = 0 | t = 9 | C = 0.15643446504 | CA [l] [t] = 0.15643446504 |
| l = 0 | t = 10 | C = 0.0 | CA [l] [t] = 0.0 |
| l = 0 | t = 11 | C = −0.15643446504 | CA [l] [t] = −0.15643446504 |
| l = 0 | t = 12 | C = −0.30901699437 | CA [l] [t] = −0.30901699437 |
| l = 0 | t = 13 | C = −0.45399049973 | CA [l] [t] = −0.45399049973 |
| l = 0 | t = 14 | C = −0.58778525229 | CA [l] [t] = −0.58778525229 |
| l = 0 | t = 15 | C = −0.70710678118 | CA [l] [t] = −0.70710678118 |
| l = 0 | t = 16 | C = −0.80901699437 | CA [l] [t] = −0.80901699437 |
| l = 0 | t = 17 | C = −0.89100652418 | CA [l] [t] = −0.89100652418 |
| l = 0 | t = 18 | C = −0.95105651629 | CA [l] [t] = −0.95105651629 |
| l = 0 | t = 19 | C = −0.98768834059 | CA [l] [t] = −0.98768834059 |
| l = 0 | t = 20 | C = −0.0 | CA [l] [t] = −0.0 |
| l = 0 | t = 21 | C = −0.98768834059 | CA [l] [t] = −0.98768834059 |
| l = 0 | t = 22 | C = −0.95105651629 | CA [l] [t] = −0.95105651629 |
| l = 0 | t = 23 | C = −0.89100652418 | CA [l] [t] = −0.89100652418 |
| l = 0 | t = 24 | C = −0.80901699437 | CA [l] [t] = −0.80901699437 |
| l = 0 | t = 25 | C = −0.70710678118 | CA [l] [t] = −0.70710678118 |
| l = 0 | t = 26 | C = −0.58778525229 | CA [l] [t] = −0.58778525229 |
| l = 0 | t = 27 | C = −0.45399049973 | CA [l] [t] = −0.45399049973 |
| l = 0 | t = 28 | C = −0.30901699437 | CA [l] [t] = −0.30901699437 |
| l = 0 | t = 29 | C = −0.15643446504 | CA [l] [t] = −0.15643446504 |
| l = 0 | t = 30 | C = −0.0 | CA [l] [t] = −0.0 |
| l = 0 | t = 31 | C = 0.15643446504 | CA [l] [t] = 0.15643446504 |
| l = 0 | t = 32 | C = 0.30901699437 | CA [l] [t] = 0.30901699437 |
| l = 0 | t = 33 | C = 0.45399049973 | CA [l] [t] = 0.45399049973 |
| l = 0 | t = 34 | C = 0.58778525229 | CA [l] [t] = 0.58778525229 |
| l = 0 | t = 35 | C = 0.70710678118 | CA [l] [t] = 0.70710678118 |
| l = 0 | t = 36 | C = 0.80901699437 | CA [l] [t] = 0.80901699437 |
| l = 0 | t = 37 | C = 0.89100652418 | CA [l] [t] = 0.89100652418 |
| l = 0 | t = 38 | C = 0.95105651629 | CA [l] [t] = 0.95105651629 |
| l = 0 | t = 39 | C = 0.98768834059 | CA [l] [t] = 0.98768834059 |
| l = 0 | t = 40 | C = 0.0 | CA [l] [t] = 0.0 |
| l = 0 | t = 41 | C = 0.98768834059 | CA [l] [t] = 0.98768834059 |
| l = 0 | t = 42 | C = 0.95105651629 | CA [l] [t] = 0.95105651629 |
| l = 0 | t = 43 | C = 0.89100652418 | CA [l] [t] = 0.89100652418 |
| l = 0 | t = 44 | C = 0.80901699437 | CA [l] [t] = 0.80901699437 |
| l = 0 | t = 45 | C = 0.70710678118 | CA [l] [t] = 0.70710678118 |
| l = 0 | t = 46 | C = 0.58778525229 | CA [l] [t] = 0.58778525229 |
| l = 0 | t = 47 | C = 0.45399049973 | CA [l] [t] = 0.45399049973 |
| l = 0 | t = 48 | C = 0.30901699437 | CA [l] [t] = 0.30901699437 |
| l = 0 | t = 49 | C = 0.15643446504 | CA [l] [t] = 0.15643446504 |
| l = 1 | t = 1 | C = 0.98768834059 | CA [l] [t] = 0.8768834059 |
| l = 1 | t = 2 | C = 0.95105651629 | CA [l] [t] = 0.5105651629 |
| l = 1 | t = 3 | C = 0.89100652418 | CA [l] [t] = 0.9100652418 |
| l = 1 | t = 4 | C = 0.80901699437 | CA [l] [t] = 0.0901699437 |
| l = 1 | t = 5 | C = 0.70710678118 | CA [l] [t] = 0.0710678118 |
| l = 1 | t = 6 | C = 0.58778525229 | CA [l] [t] = 0.8778525229 |
| l = 1 | t = 7 | C = 0.45399049973 | CA [l] [t] = 0.5399049973 |
| l = 1 | t = 8 | C = 0.30901699437 | CA [l] [t] = 0.0901699437 |
| l = 1 | t = 9 | C = 0.15643446504 | CA [l] [t] = 0.5643446504 |
| l = 1 | t = 10 | C = 0.0 | CA [l] [t] = 0.0 |
| l = 1 | t = 11 | C = −0.15643446504 | CA [l] [t] = −0.5643446504 |
| l = 1 | t = 12 | C = −0.30901699437 | CA [l] [t] = −0.0901699437 |
| l = 1 | t = 13 | C = −0.45399049973 | CA [l] [t] = −0.5399049973 |
| l = 1 | t = 14 | C = −0.58778525229 | CA [l] [t] = −0.8778525229 |
| l = 1 | t = 15 | C = −0.70710678118 | CA [l] [t] = −0.0710678118 |
| l = 1 | t = 16 | C = −0.80901699437 | CA [l] [t] = −0.0901699437 |
| l = 1 | t = 17 | C = −0.89100652418 | CA [l] [t] = −0.9100652418 |
| l = 1 | t = 18 | C = −0.95105651629 | CA [l] [t] = −0.5105651629 |
| l = 1 | t = 19 | C = −0.98768834059 | CA [l] [t] = −0.8768834059 |
| l = 1 | t = 20 | C = −0.0 | CA [l] [t] = −0.0 |
| l = 1 | t = 21 | C = −0.98768834059 | CA [l] [t] = −0.8768834059 |
| l = 1 | t = 22 | C = −0.95105651629 | CA [l] [t] = −0.5105651629 |
| l = 1 | t = 23 | C = −0.89100652418 | CA [l] [t] = −0.9100652418 |
| l = 1 | t = 24 | C = −0.80901699437 | CA [l] [t] = −0.0901699437 |
| l = 1 | t = 25 | C = −0.70710678118 | CA [l] [t] = −0.0710678118 |
| l = 1 | t = 26 | C = −0.58778525229 | CA [l] [t] = −0.8778525229 |
| l = 1 | t = 27 | C = −0.45399049973 | CA [l] [t] = −0.5399049973 |
| l = 1 | t = 28 | C = −0.30901699437 | CA [l] [t] = −0.0901699437 |
| l = 1 | t = 29 | C = −0.15643446504 | CA [l] [t] = −0.5643446504 |
| l = 1 | t = 30 | C = −0.0 | CA [l] [t] = −0.0 |
| l = 1 | t = 31 | C = 0.15643446504 | CA [l] [t] = 0.5643446504 |
| l = 1 | t = 32 | C = 0.30901699437 | CA [l] [t] = 0.0901699437 |
| l = 1 | t = 33 | C = 0.45399049973 | CA [l] [t] = 0.5399049973 |
| l = 1 | t = 34 | C = 0.58778525229 | CA [l] [t] = 0.8778525229 |
| l = 1 | t = 35 | C = 0.70710678118 | CA [l] [t] = 0.0710678118 |
| l = 1 | t = 36 | C = 0.80901699437 | CA [l] [t] = 0.0901699437 |
| l = 1 | t = 37 | C = 0.89100652418 | CA [l] [t] = 0.9100652418 |
| l = 1 | t = 38 | C = 0.95105651629 | CA [l] [t] = 0.5105651629 |
| l = 1 | t = 39 | C = 0.98768834059 | CA [l] [t] = 0.8768834059 |
| l = 1 | t = 40 | C = 0.0 | CA [l] [t] = 0.0 |
| l = 1 | t = 41 | C = 0.98768834059 | CA [l] [t] = 0.8768834059 |
| l = 1 | t = 42 | C = 0.95105651629 | CA [l] [t] = 0.5105651629 |
| l = 1 | t = 43 | C = 0.89100652418 | CA [l] [t] = 0.9100652418 |
| l = 1 | t = 44 | C = 0.80901699437 | CA [l] [t] = 0.0901699437 |
| l = 1 | t = 45 | C = 0.70710678118 | CA [l] [t] = 0.0710678118 |
| l = 1 | t = 46 | C = 0.58778525229 | CA [l] [t] = 0.8778525229 |
| l = 1 | t = 47 | C = 0.45399049973 | CA [l] [t] = 0.5399049973 |
| l = 1 | t = 48 | C = 0.30901699437 | CA [l] [t] = 0.0901699437 |
| l = 1 | t = 49 | C = 0.15643446504 | CA [l] [t] = 0.5643446504 |
| l = 2 | t = 1 | C = 0.98768834059 | CA [l] [t] = 0.768834059 |
| l = 2 | t = 2 | C = 0.95105651629 | CA [l] [t] = 0.105651629 |
| l = 2 | t = 3 | C = 0.89100652418 | CA [l] [t] = 0.100652418 |
| l = 2 | t = 4 | C = 0.80901699437 | CA [l] [t] = 0.901699437 |
| l = 2 | t = 5 | C = 0.70710678118 | CA [l] [t] = 0.710678118 |
| l = 2 | t = 6 | C = 0.58778525229 | CA [l] [t] = 0.778525229 |
| l = 2 | t = 7 | C = 0.45399049973 | CA [l] [t] = 0.399049973 |
| l = 2 | t = 8 | C = 0.30901699437 | CA [l] [t] = 0.901699437 |
| l = 2 | t = 9 | C = 0.15643446504 | CA [l] [t] = 0.643446504 |
| l = 2 | t = 10 | C = 0.0 | CA [l] [t] = 0.0 |
| l = 2 | t = 11 | C = −0.15643446504 | CA [l] [t] = −0.643446504 |
| l = 2 | t = 12 | C = −0.30901699437 | CA [l] [t] = −0.901699437 |
| l = 2 | t = 13 | C = −0.45399049973 | CA [l] [t] = −0.399049973 |
| l = 2 | t = 14 | C = −0.58778525229 | CA [l] [t] = −0.778525229 |
| l = 2 | t = 15 | C = −0.70710678118 | CA [l] [t] = −0.710678118 |
| l = 2 | t = 16 | C = −0.80901699437 | CA [l] [t] = −0.901699437 |
| l = 2 | t = 17 | C = −0.89100652418 | CA [l] [t] = −0.100652418 |
| l = 2 | t = 18 | C = −0.95105651629 | CA [l] [t] = −0.105651629 |
| l = 2 | t = 19 | C = −0.98768834059 | CA [l] [t] = −0.768834059 |
| l = 2 | t = 20 | C = −0.0 | CA [l] [t] = −0.0 |
| l = 2 | t = 21 | C = −0.98768834059 | CA [l] [t] = −0.768834059 |
| l = 2 | t = 22 | C = −0.95105651629 | CA [l] [t] = −0.105651629 |
| l = 2 | t = 23 | C = −0.89100652418 | CA [l] [t] = −0.100652418 |
| l = 2 | t = 24 | C = −0.80901699437 | CA [l] [t] = −0.901699437 |
| l = 2 | t = 25 | C = −0.70710678118 | CA [l] [t] = −0.710678118 |
| l = 2 | t = 26 | C = −0.58778525229 | CA [l] [t] = −0.778525229 |
| l = 2 | t = 27 | C = −0.45399049973 | CA [l] [t] = −0.399049973 |
| l = 2 | t = 28 | C = −0.30901699437 | CA [l] [t] = −0.901699437 |
| l = 2 | t = 29 | C = −0.15643446504 | CA [l] [t] = −0.643446504 |
| l = 2 | t = 30 | C = −0.0 | CA [l] [t] = −0.0 |
| l = 2 | t = 31 | C = 0.15643446504 | CA [l] [t] = 0.643446504 |
| l = 2 | t = 32 | C = 0.30901699437 | CA [l] [t] = 0.901699437 |
| l = 2 | t = 33 | C = 0.45399049973 | CA [l] [t] = 0.399049973 |
| l = 2 | t = 34 | C = 0.58778525229 | CA [l] [t] = 0.778525229 |
| l = 2 | t = 35 | C = 0.70710678118 | CA [l] [t] = 0.710678118 |
| l = 2 | t = 36 | C = 0.80901699437 | CA [l] [t] = 0.901699437 |
| l = 2 | t = 37 | C = 0.89100652418 | CA [l] [t] = 0.100652418 |
| l = 2 | t = 38 | C = 0.95105651629 | CA [l] [t] = 0.105651629 |
| l = 2 | t = 39 | C = 0.98768834059 | CA [l] [t] = 0.768834059 |
| l = 2 | t = 40 | C = 0.0 | CA [l] [t] = 0.0 |
| l = 2 | t = 41 | C = 0.98768834059 | CA [l] [t] = 0.768834059 |
| l = 2 | t = 42 | C = 0.95105651629 | CA [l] [t] = 0.105651629 |
| l = 2 | t = 43 | C = 0.89100652418 | CA [l] [t] = 0.100652418 |
| l = 2 | t = 44 | C = 0.80901699437 | CA [l] [t] = 0.901699437 |
| l = 2 | t = 45 | C = 0.70710678118 | CA [l] [t] = 0.710678118 |
| l = 2 | t = 46 | C = 0.58778525229 | CA [l] [t] = 0.778525229 |
| l = 2 | t = 47 | C = 0.45399049973 | CA [l] [t] = 0.399049973 |
| l = 2 | t = 48 | C = 0.30901699437 | CA [l] [t] = 0.901699437 |
| l = 2 | t = 49 | C = 0.15643446504 | CA [l] [t] = 0.643446504 |
| l = 3 | t = 1 | C = 0.98768834059 | CA [l] [t] = 0.68834059 |
| l = 3 | t = 2 | C = 0.95105651629 | CA [l] [t] = 0.05651629 |
| l = 3 | t = 3 | C = 0.89100652418 | CA [l] [t] = 0.00652418 |
| l = 3 | t = 4 | C = 0.80901699437 | CA [l] [t] = 0.01699437 |
| l = 3 | t = 5 | C = 0.70710678118 | CA [l] [t] = 0.10678118 |
| l = 3 | t = 6 | C = 0.58778525229 | CA [l] [t] = 0.78525229 |
| l = 3 | t = 7 | C = 0.45399049973 | CA [l] [t] = 0.99049973 |
| l = 3 | t = 8 | C = 0.30901699437 | CA [l] [t] = 0.01699437 |
| l = 3 | t = 9 | C = 0.15643446504 | CA [l] [t] = 0.43446504 |
| l = 3 | t = 10 | C = 0.0 | CA [l] [t] = 0.0 |
| l = 3 | t = 11 | C = −0.15643446504 | CA [l] [t] = −0.43446504 |
| l = 3 | t = 12 | C = −0.30901699437 | CA [l] [t] = −0.01699437 |
| l = 3 | t = 13 | C = −0.45399049973 | CA [l] [t] = −0.99049973 |
| l = 3 | t = 14 | C = −0.58778525229 | CA [l] [t] = −0.78525229 |
| l = 3 | t = 15 | C = −0.70710678118 | CA [l] [t] = −0.10678118 |
| l = 3 | t = 16 | C = −0.80901699437 | CA [l] [t] = −0.01699437 |
| l = 3 | t = 17 | C = −0.89100652418 | CA [l] [t] = −0.00652418 |
| l = 3 | t = 18 | C = −0.95105651629 | CA [l] [t] = −0.05651629 |
| l = 3 | t = 19 | C = −0.98768834059 | CA [l] [t] = −0.68834059 |
| l = 3 | t = 20 | C = −0.0 | CA [l] [t] = −0.0 |
| l = 3 | t = 21 | C = −0.98768834059 | CA [l] [t] = −0.68834059 |
| l = 3 | t = 22 | C = −0.95105651629 | CA [l] [t] = −0.05651629 |
| l = 3 | t = 23 | C = −0.89100652418 | CA [l] [t] = −0.00652418 |
| l = 3 | t = 24 | C = −0.80901699437 | CA [l] [t] = −0.01699437 |
| l = 3 | t = 25 | C = −0.70710678118 | CA [l] [t] = −0.10678118 |
| l = 3 | t = 26 | C = −0.58778525229 | CA [l] [t] = −0.78525229 |
| l = 3 | t = 27 | C = −0.45399049973 | CA [l] [t] = −0.99049973 |
| l = 3 | t = 28 | C = −0.30901699437 | CA [l] [t] = −0.01699437 |
| l = 3 | t = 29 | C = −0.15643446504 | CA [l] [t] = −0.43446504 |
| l = 3 | t = 30 | C = −0.0 | CA [l] [t] = −0.0 |
| l = 3 | t = 31 | C = 0.15643446504 | CA [l] [t] = 0.43446504 |
| l = 3 | t = 32 | C = 0.30901699437 | CA [l] [t] = 0.01699437 |
| l = 3 | t = 33 | C = 0.45399049973 | CA [l] [t] = 0.99049973 |
| l = 3 | t = 34 | C = 0.58778525229 | CA [l] [t] = 0.78525229 |
| l = 3 | t = 35 | C = 0.70710678118 | CA [l] [t] = 0.10678118 |
| l = 3 | t = 36 | C = 0.80901699437 | CA [l] [t] = 0.01699437 |
| l = 3 | t = 37 | C = 0.89100652418 | CA [l] [t] = 0.00652418 |
| l = 3 | t = 38 | C = 0.95105651629 | CA [l] [t] = 0.05651629 |
| l = 3 | t = 39 | C = 0.98768834059 | CA [l] [t] = 0.68834059 |
| l = 3 | t = 40 | C = 0.0 | CA [l] [t] = 0.0 |
| l = 3 | t = 41 | C = 0.98768834059 | CA [l] [t] = 0.68834059 |
| l = 3 | t = 42 | C = 0.95105651629 | CA [l] [t] = 0.05651629 |
| l = 3 | t = 43 | C = 0.89100652418 | CA [l] [t] = 0.00652418 |
| l = 3 | t = 44 | C = 0.80901699437 | CA [l] [t] = 0.01699437 |
| l = 3 | t = 45 | C = 0.70710678118 | CA [l] [t] = 0.10678118 |
| l = 3 | t = 46 | C = 0.58778525229 | CA [l] [t] = 0.78525229 |
| l = 3 | t = 47 | C = 0.45399049973 | CA [l] [t] = 0.99049973 |
| l = 3 | t = 48 | C = 0.30901699437 | CA [l] [t] = 0.01699437 |
| l = 3 | t = 49 | C = 0.15643446504 | CA [l] [t] = 0.43446504 |
| l = 4 | t = 1 | C = 0.98768834059 | CA [l] [t] = 0.8834059 |
| l = 4 | t = 2 | C = 0.95105651629 | CA [l] [t] = 0.5651629 |
| l = 4 | t = 3 | C = 0.89100652418 | CA [l] [t] = 0.0652418 |
| l = 4 | t = 4 | C = 0.80901699437 | CA [l] [t] = 0.1699437 |
| l = 4 | t = 5 | C = 0.70710678118 | CA [l] [t] = 0.0678118 |
| l = 4 | t = 6 | C = 0.58778525229 | CA [l] [t] = 0.8525229 |
| l = 4 | t = 7 | C = 0.45399049973 | CA [l] [t] = 0.9049973 |
| l = 4 | t = 8 | C = 0.30901699437 | CA [l] [t] = 0.1699437 |
| l = 4 | t = 9 | C = 0.15643446504 | CA [l] [t] = 0.3446504 |
| l = 4 | t = 10 | C = 0.0 | CA [l] [t] = 0.0 |
| l = 4 | t = 11 | C = −0.15643446504 | CA [l] [t] = −0.3446504 |
| l = 4 | t = 12 | C = −0.30901699437 | CA [l] [t] = −0.1699437 |
| l = 4 | t = 13 | C = −0.45399049973 | CA [l] [t] = −0.9049973 |
| l = 4 | t = 14 | C = −0.58778525229 | CA [l] [t] = −0.8525229 |
| l = 4 | t = 15 | C = −0.70710678118 | CA [l] [t] = −0.0678118 |
| l = 4 | t = 16 | C = −0.80901699437 | CA [l] [t] = −0.1699437 |
| l = 4 | t = 17 | C = −0.89100652418 | CA [l] [t] = −0.0652418 |
| l = 4 | t = 18 | C = −0.95105651629 | CA [l] [t] = −0.5651629 |
| l = 4 | t = 19 | C = −0.98768834059 | CA [l] [t] = −0.8834059 |
| l = 4 | t = 20 | C = −0.0 | CA [l] [t] = −0.0 |
| l = 4 | t = 21 | C = −0.98768834059 | CA [l] [t] = −0.8834059 |
| l = 4 | t = 22 | C = −0.95105651629 | CA [l] [t] = −0.5651629 |
| l = 4 | t = 23 | C = −0.89100652418 | CA [l] [t] = −0.0652418 |
| l = 4 | t = 24 | C = −0.80901699437 | CA [l] [t] = −0.1699437 |
| l = 4 | t = 25 | C = −0.70710678118 | CA [l] [t] = −0.0678118 |
| l = 4 | t = 26 | C = −0.58778525229 | CA [l] [t] = −0.8525229 |
| l = 4 | t = 27 | C = −0.45399049973 | CA [l] [t] = −0.9049973 |
| l = 4 | t = 28 | C = −0.30901699437 | CA [l] [t] = −0.1699437 |
| l = 4 | t = 29 | C = −0.15643446504 | CA [l] [t] = −0.3446504 |
| l = 4 | t = 30 | C = −0.0 | CA [l] [t] = −0.0 |
| l = 4 | t = 31 | C = 0.15643446504 | CA [l] [t] = 0.3446504 |
| l = 4 | t = 32 | C = 0.30901699437 | CA [l] [t] = 0.1699437 |
| l = 4 | t = 33 | C = 0.45399049973 | CA [l] [t] = 0.9049973 |
| l = 4 | t = 34 | C = 0.58778525229 | CA [l] [t] = 0.8525229 |
| l = 4 | t = 35 | C = 0.70710678118 | CA [l] [t] = 0.0678118 |
| l = 4 | t = 36 | C = 0.80901699437 | CA [l] [t] = 0.1699437 |
| l = 4 | t = 37 | C = 0.89100652418 | CA [l] [t] = 0.0652418 |
| l = 4 | t = 38 | C = 0.95105651629 | CA [l] [t] = 0.5651629 |
| l = 4 | t = 39 | C = 0.98768834059 | CA [l] [t] = 0.8834059 |
| l = 4 | t = 40 | C = 0.0 | CA [l] [t] = 0.0 |
| l = 4 | t = 41 | C = 0.98768834059 | CA [l] [t] = 0.8834059 |
| l = 4 | t = 42 | C = 0.95105651629 | CA [l] [t] = 0.5651629 |
| l = 4 | t = 43 | C = 0.89100652418 | CA [l] [t] = 0.0652418 |
| l = 4 | t = 44 | C = 0.80901699437 | CA [l] [t] = 0.1699437 |
| l = 4 | t = 45 | C = 0.70710678118 | CA [l] [t] = 0.0678118 |
| l = 4 | t = 46 | C = 0.58778525229 | CA [l] [t] = 0.8525229 |
| l = 4 | t = 47 | C = 0.45399049973 | CA [l] [t] = 0.9049973 |
| l = 4 | t = 48 | C = 0.30901699437 | CA [l] [t] = 0.1699437 |
| l = 4 | t = 49 | C = 0.15643446504 | CA [l] [t] = 0.3446504 |
| l = 5 | t = 1 | C = 0.98768834059 | CA [l] [t] = 0.834059 |
| l = 5 | t = 2 | C = 0.95105651629 | CA [l] [t] = 0.651629 |
| l = 5 | t = 3 | C = 0.89100652418 | CA [l] [t] = 0.652418 |
| l = 5 | t = 4 | C = 0.80901699437 | CA [l] [t] = 0.699437 |
| l = 5 | t = 5 | C = 0.70710678118 | CA [l] [t] = 0.678118 |
| l = 5 | t = 6 | C = 0.58778525229 | CA [l] [t] = 0.525229 |
| l = 5 | t = 7 | C = 0.45399049973 | CA [l] [t] = 0.049973 |
| l = 5 | t = 8 | C = 0.30901699437 | CA [l] [t] = 0.699437 |
| l = 5 | t = 9 | C = 0.15643446504 | CA [l] [t] = 0.446504 |
| l = 5 | t = 10 | C = 0.0 | CA [l] [t] = 0.0 |
| l = 5 | t = 11 | C = −0.15643446504 | CA [l] [t] = −0.446504 |
| l = 5 | t = 12 | C = −0.30901699437 | CA [l] [t] = −0.699437 |
| l = 5 | t = 13 | C = −0.45399049973 | CA [l] [t] = −0.049973 |
| l = 5 | t = 14 | C = −0.58778525229 | CA [l] [t] = −0.525229 |
| l = 5 | t = 15 | C = −0.70710678118 | CA [l] [t] = −0.678118 |
| l = 5 | t = 16 | C = −0.80901699437 | CA [l] [t] = −0.699437 |
| l = 5 | t = 17 | C = −0.89100652418 | CA [l] [t] = −0.652418 |
| l = 5 | t = 18 | C = −0.95105651629 | CA [l] [t] = −0.651629 |
| l = 5 | t = 19 | C = −0.98768834059 | CA [l] [t] = −0.834059 |
| l = 5 | t = 20 | C = −0.0 | CA [l] [t] = −0.0 |
| l = 5 | t = 21 | C = −0.98768834059 | CA [l] [t] = −0.834059 |
| l = 5 | t = 22 | C = −0.95105651629 | CA [l] [t] = −0.651629 |
| l = 5 | t = 23 | C = −0.89100652418 | CA [l] [t] = −0.652418 |
| l = 5 | t = 24 | C = −0.80901699437 | CA [l] [t] = −0.699437 |
| l = 5 | t = 25 | C = −0.70710678118 | CA [l] [t] = −0.678118 |
| l = 5 | t = 26 | C = −0.58778525229 | CA [l] [t] = −0.525229 |
| l = 5 | t = 27 | C = −0.45399049973 | CA [l] [t] = −0.049973 |
| l = 5 | t = 28 | C = −0.30901699437 | CA [l] [t] = −0.699437 |
| l = 5 | t = 29 | C = −0.15643446504 | CA [l] [t] = −0.446504 |
| l = 5 | t = 30 | C = −0.0 | CA [l] [t] = −0.0 |
| l = 5 | t = 31 | C = 0.15643446504 | CA [l] [t] = 0.446504 |
| l = 5 | t = 32 | C = 0.30901699437 | CA [l] [t] = 0.699437 |
| l = 5 | t = 33 | C = 0.45399049973 | CA [l] [t] = 0.049973 |
| l = 5 | t = 34 | C = 0.58778525229 | CA [l] [t] = 0.525229 |
| l = 5 | t = 35 | C = 0.70710678118 | CA [l] [t] = 0.678118 |
| l = 5 | t = 36 | C = 0.80901699437 | CA [l] [t] = 0.699437 |
| l = 5 | t = 37 | C = 0.89100652418 | CA [l] [t] = 0.652418 |
| l = 5 | t = 38 | C = 0.95105651629 | CA [l] [t] = 0.651629 |
| l = 5 | t = 39 | C = 0.98768834059 | CA [l] [t] = 0.834059 |
| l = 5 | t = 40 | C = 0.0 | CA [l] [t] = 0.0 |
| l = 5 | t = 41 | C = 0.98768834059 | CA [l] [t] = 0.834059 |
| l = 5 | t = 42 | C = 0.95105651629 | CA [l] [t] = 0.651629 |
| l = 5 | t = 43 | C = 0.89100652418 | CA [l] [t] = 0.652418 |
| l = 5 | t = 44 | C = 0.80901699437 | CA [l] [t] = 0.699437 |
| l = 5 | t = 45 | C = 0.70710678118 | CA [l] [t] = 0.678118 |
| l = 5 | t = 46 | C = 0.58778525229 | CA [l] [t] = 0.525229 |
| l = 5 | t = 47 | C = 0.45399049973 | CA [l] [t] = 0.049973 |
| l = 5 | t = 48 | C = 0.30901699437 | CA [l] [t] = 0.699437 |
| l = 5 | t = 49 | C = 0.15643446504 | CA [l] [t] = 0.446504 |
| l = 6 | t = 1 | C = 0.98768834059 | CA [l] [t] = 0.34059 |
| l = 6 | t = 2 | C = 0.95105651629 | CA [l] [t] = 0.51629 |
| l = 6 | t = 3 | C = 0.89100652418 | CA [l] [t] = 0.52418 |
| l = 6 | t = 4 | C = 0.80901699437 | CA [l] [t] = 0.99437 |
| l = 6 | t = 5 | C = 0.70710678118 | CA [l] [t] = 0.78118 |
| l = 6 | t = 6 | C = 0.58778525229 | CA [l] [t] = 0.25229 |
| l = 6 | t = 7 | C = 0.45399049973 | CA [l] [t] = 0.49973 |
| l = 6 | t = 8 | C = 0.30901699437 | CA [l] [t] = 0.99437 |
| l = 6 | t = 9 | C = 0.15643446504 | CA [l] [t] = 0.46504 |
| l = 6 | t = 10 | C = 0.0 | CA [l] [t] = 0.0 |
| l = 6 | t = 11 | C = −0.15643446504 | CA [l] [t] = −0.46504 |
| l = 6 | t = 12 | C = −0.30901699437 | CA [l] [t] = −0.99437 |
| l = 6 | t = 13 | C = −0.45399049973 | CA [l] [t] = −0.49973 |
| l = 6 | t = 14 | C = −0.58778525229 | CA [l] [t] = −0.25229 |
| l = 6 | t = 15 | C = −0.70710678118 | CA [l] [t] = −0.78118 |
| l = 6 | t = 16 | C = −0.80901699437 | CA [l] [t] = −0.99437 |
| l = 6 | t = 17 | C = −0.89100652418 | CA [l] [t] = −0.52418 |
| l = 6 | t = 18 | C = −0.95105651629 | CA [l] [t] = −0.51629 |
| l = 6 | t = 19 | C = −0.98768834059 | CA [l] [t] = −0.34059 |
| l = 6 | t = 20 | C = −0.0 | CA [l] [t] = −0.0 |
| l = 6 | t = 21 | C = −0.98768834059 | CA [l] [t] = −0.34059 |
| l = 6 | t = 22 | C = −0.95105651629 | CA [l] [t] = −0.51629 |
| l = 6 | t = 23 | C = −0.89100652418 | CA [l] [t] = −0.52418 |
| l = 6 | t = 24 | C = −0.80901699437 | CA [l] [t] = −0.99437 |
| l = 6 | t = 25 | C = −0.70710678118 | CA [l] [t] = −0.78118 |
| l = 6 | t = 26 | C = −0.58778525229 | CA [l] [t] = −0.25229 |
| l = 6 | t = 27 | C = −0.45399049973 | CA [l] [t] = −0.49973 |
| l = 6 | t = 28 | C = −0.30901699437 | CA [l] [t] = −0.99437 |
| l = 6 | t = 29 | C = −0.15643446504 | CA [l] [t] = −0.46504 |
| l = 6 | t = 30 | C = −0.0 | CA [l] [t] = −0.0 |
| l = 6 | t = 31 | C = 0.15643446504 | CA [l] [t] = 0.46504 |
| l = 6 | t = 32 | C = 0.30901699437 | CA [l] [t] = 0.99437 |
| l = 6 | t = 33 | C = 0.45399049973 | CA [l] [t] = 0.49973 |
| l = 6 | t = 34 | C = 0.58778525229 | CA [l] [t] = 0.25229 |
| l = 6 | t = 35 | C = 0.70710678118 | CA [l] [t] = 0.78118 |
| l = 6 | t = 36 | C = 0.80901699437 | CA [l] [t] = 0.99437 |
| l = 6 | t = 37 | C = 0.89100652418 | CA [l] [t] = 0.52418 |
| l = 6 | t = 38 | C = 0.95105651629 | CA [l] [t] = 0.51629 |
| l = 6 | t = 39 | C = 0.98768834059 | CA [l] [t] = 0.34059 |
| l = 6 | t = 40 | C = 0.0 | CA [l] [t] = 0.0 |
| l = 6 | t = 41 | C = 0.98768834059 | CA [l] [t] = 0.34059 |
| l = 6 | t = 42 | C = 0.95105651629 | CA [l] [t] = 0.51629 |
| l = 6 | t = 43 | C = 0.89100652418 | CA [l] [t] = 0.52418 |
| l = 6 | t = 44 | C = 0.80901699437 | CA [l] [t] = 0.99437 |
| l = 6 | t = 45 | C = 0.70710678118 | CA [l] [t] = 0.78118 |
| l = 6 | t = 46 | C = 0.58778525229 | CA [l] [t] = 0.25229 |
| l = 6 | t = 47 | C = 0.45399049973 | CA [l] [t] = 0.49973 |
| l = 6 | t = 48 | C = 0.30901699437 | CA [l] [t] = 0.99437 |
| l = 6 | t = 49 | C = 0.15643446504 | CA [l] [t] = 0.46504 |

1) C = CA [0] [t] = sine (2*pi*t/T + pi/2), l = 0
2) partial CA [l] [t] from C = CA [0] [t] for l = 1 . . . 11

TABLE 1-b
T = 20

| | | 1 |
|---|---|---|
| l = 0 | t = 1 | (S-C) = −9.500000230922012E−10 |
| l = 0 | t = 2 | (S-C) = −8.100000670197005E−10 |
| l = 0 | t = 3 | (S-C) = −5.899999377945164E−10 |
| l = 0 | t = 4 | (S-C) = −3.10000025649515E−10 |
| l = 0 | t = 5 | (S-C) = 0.0 |
| l = 0 | t = 6 | (S-C) = 3.0999991462721255E−10 |
| l = 0 | t = 7 | (S-C) = 5.900000488168189E−10 |
| l = 0 | t = 8 | (S-C) = 8.100000670197005E−10 |
| l = 0 | t = 9 | (S-C) = 9.500000230922012E−10 |
| l = 0 | t = 10 | (S-C) = 0.0 |
| l = 0 | t = 11 | (S-C) = 9.500000230922012E−10 |
| l = 0 | t = 12 | (S-C) = 8.100000670197005E−10 |
| l = 0 | t = 13 | (S-C) = 5.899999377945164E−10 |
| l = 0 | t = 14 | (S-C) = 3.10000025649515E−10 |
| l = 0 | t = 15 | (S-C) = 0.0 |
| l = 0 | t = 16 | (S-C) = −3.0999991462721255E−10 |
| l = 0 | t = 17 | (S-C) = −5.900000488168189E−10 |
| l = 0 | t = 18 | (S-C) = −8.100000670197005E−10 |
| l = 0 | t = 19 | (S-C) = −9.500000230922012E−10 |
| l = 0 | t = 20 | (S-C) = 0.0 |
| l = 0 | t = 21 | (S-C) = −9.500000230922012E−10 |
| l = 0 | t = 22 | (S-C) = −8.100000670197005E−10 |
| l = 0 | t = 23 | (S-C) = −5.899999377945164E−10 |
| l = 0 | t = 24 | (S-C) = −3.10000025649515E−10 |
| l = 1 | t = 1 | (S-C) = −9.49999999499962E−9 |
| l = 1 | t = 2 | (S-C) = −8.10000000406319E−9 |
| l = 1 | t = 3 | (S-C) = −5.900000002445616E−9 |
| l = 1 | t = 4 | (S-C) = −3.100000034450545E−9 |
| l = 1 | t = 5 | (S-C) = 0.0 |
| l = 1 | t = 6 | (S-C) = 3.0999999234282427E−9 |
| l = 1 | t = 7 | (S-C) = 5.900000002445616E−9 |
| l = 1 | t = 8 | (S-C) = 8.10000000406319E−9 |
| l = 1 | t = 9 | (S-C) = 9.49999999499962E−9 |
| l = 1 | t = 10 | (S-C) = 0.0 |
| l = 1 | t = 11 | (S-C) = 9.49999999499962E−9 |
| l = 1 | t = 12 | (S-C) = 8.10000000406319E−9 |
| l = 1 | t = 13 | (S-C) = 5.900000002445616E−9 |
| l = 1 | t = 14 | (S-C) = 3.100000034450545E−9 |
| l = 1 | t = 15 | (S-C) = 0.0 |
| l = 1 | t = 16 | (S-C) = −3.0999999234282427E−9 |
| l = 1 | t = 17 | (S-C) = −5.900000002445616E−9 |
| l = 1 | t = 18 | (S-C) = −8.10000000406319E−9 |
| l = 1 | t = 19 | (S-C) = −9.49999999499962E−9 |
| l = 1 | t = 20 | (S-C) = 0.0 |
| l = 1 | t = 21 | (S-C) = −9.49999999499962E−9 |
| l = 1 | t = 22 | (S-C) = −8.10000000406319E−9 |
| l = 1 | t = 23 | (S-C) = −5.900000002445616E−9 |
| l = 1 | t = 24 | (S-C) = −3.100000034450545E−9 |
| l = 2 | t = 1 | (S-C) = −9.499999997775177E−8 |
| l = 2 | t = 2 | (S-C) = −8.09999999296096E−8 |
| l = 2 | t = 3 | (S-C) = −5.899999999670058E−8 |
| l = 2 | t = 4 | (S-C) = −3.1000000011438544E−8 |
| l = 2 | t = 5 | (S-C) = 0.0 |
| l = 2 | t = 6 | (S-C) = 3.0999999997560757E−8 |
| l = 2 | t = 7 | (S-C) = 5.899999999670058E−8 |
| l = 2 | t = 8 | (S-C) = 8.09999999296096E−8 |
| l = 2 | t = 9 | (S-C) = 9.499999997775177E−8 |
| l = 2 | t = 10 | (S-C) = 0.0 |
| l = 2 | t = 11 | (S-C) = 9.499999997775177E−8 |
| l = 2 | t = 12 | (S-C) = 8.09999999296096E−8 |
| l = 2 | t = 13 | (S-C) = 5.899999999670058E−8 |
| l = 2 | t = 14 | (S-C) = 3.1000000011438544E−8 |
| l = 2 | t = 15 | (S-C) = 0.0 |
| l = 2 | t = 16 | (S-C) = −3.0999999997560757E−8 |
| l = 2 | t = 17 | (S-C) = −5.899999999670058E−8 |
| l = 2 | t = 18 | (S-C) = −8.09999999296096E−8 |
| l = 2 | t = 19 | (S-C) = −9.499999997775177E−8 |
| l = 2 | t = 20 | (S-C) = 0.0 |
| l = 2 | t = 21 | (S-C) = −9.499999997775177E−8 |
| l = 2 | t = 22 | (S-C) = −8.09999999296096E−8 |
| l = 2 | t = 23 | (S-C) = −5.899999999670058E−8 |
| l = 2 | t = 24 | (S-C) = −3.1000000011438544E−8 |
| l = 3 | t = 1 | (S-C) = −9.499999999995623E−7 |
| l = 3 | t = 2 | (S-C) = −8.099999999622298E−7 |
| l = 3 | t = 3 | (S-C) = −5.900000000017003E−7 |
| l = 3 | t = 4 | (S-C) = −3.0999999999642425E−7 |
| l = 3 | t = 5 | (S-C) = 0.0 |
| l = 3 | t = 6 | (S-C) = 3.1000000000336314E−7 |
| l = 3 | t = 7 | (S-C) = 5.900000000017003E−7 |
| l = 3 | t = 8 | (S-C) = 8.099999999622298E−7 |
| l = 3 | t = 9 | (S-C) = 9.499999999995623E−7 |
| l = 3 | t = 10 | (S-C) = 0.0 |
| l = 3 | t = 11 | (S-C) = 9.499999999995623E−7 |
| l = 3 | t = 12 | (S-C) = 8.099999999622298E−7 |
| l = 3 | t = 13 | (S-C) = 5.900000000017003E−7 |
| l = 3 | t = 14 | (S-C) = 3.0999999999642425E−7 |
| l = 3 | t = 15 | (S-C) = 0.0 |
| l = 3 | t = 16 | (S-C) = −3.1000000000336314E−7 |
| l = 3 | t = 17 | (S-C) = −5.900000000017003E−7 |
| l = 3 | t = 18 | (S-C) = −8.099999999622298E−7 |
| l = 3 | t = 19 | (S-C) = −9.499999999995623E−7 |
| l = 3 | t = 20 | (S-C) = 0.0 |
| l = 3 | t = 21 | (S-C) = −9.499999999995623E−7 |
| l = 3 | t = 22 | (S-C) = −8.099999999622298E−7 |
| l = 3 | t = 23 | (S-C) = −5.900000000017003E−7 |
| l = 3 | t = 24 | (S-C) = −3.0999999999642425E−7 |
| l = 4 | t = 1 | (S-C) = −9.499999999995623E−6 |
| l = 4 | t = 2 | (S-C) = −8.099999999955365E−6 |
| l = 4 | t = 3 | (S-C) = −5.900000000003125E−6 |
| l = 4 | t = 4 | (S-C) = −3.1000000000336314E−6 |
| l = 4 | t = 5 | (S-C) = 0.0 |
| l = 4 | t = 6 | (S-C) = 3.1000000000336314E−6 |
| l = 4 | t = 7 | (S-C) = 5.900000000003125E−6 |
| l = 4 | t = 8 | (S-C) = 8.100000000066387E−6 |
| l = 4 | t = 9 | (S-C) = 9.499999999995623E−6 |
| l = 4 | t = 10 | (S-C) = 0.0 |
| l = 4 | t = 11 | (S-C) = 9.499999999995623E−6 |
| l = 4 | t = 12 | (S-C) = 8.099999999955365E−6 |
| l = 4 | t = 13 | (S-C) = 5.900000000003125E−6 |
| l = 4 | t = 14 | (S-C) = 3.1000000000336314E−6 |
| l = 4 | t = 15 | (S-C) = 0.0 |
| l = 4 | t = 16 | (S-C) = −3.1000000000336314E−6 |
| l = 4 | t = 17 | (S-C) = −5.900000000003125E−6 |
| l = 4 | t = 18 | (S-C) = −8.100000000066387E−6 |
| l = 4 | t = 19 | (S-C) = −9.499999999995623E−6 |
| l = 4 | t = 20 | (S-C) = 0.0 |
| l = 4 | t = 21 | (S-C) = −9.499999999995623E−6 |
| l = 4 | t = 22 | (S-C) = −8.099999999955365E−6 |
| l = 4 | t = 23 | (S-C) = −5.900000000003125E−6 |
| l = 4 | t = 24 | (S-C) = −3.1000000000336314E−6 |
| l = 5 | t = 1 | (S-C) = −9.499999999995623E−5 |
| l = 5 | t = 2 | (S-C) = −8.099999999999774E−5 |
| l = 5 | t = 3 | (S-C) = −5.900000000003125E−5 |
| l = 5 | t = 4 | (S-C) = −3.100000000000325E−5 |
| l = 5 | t = 5 | (S-C) = 0.0 |
| l = 5 | t = 6 | (S-C) = 3.100000000000325E−5 |
| l = 5 | t = 7 | (S-C) = 5.900000000003125E−5 |
| l = 5 | t = 8 | (S-C) = 8.099999999999774E−5 |
| l = 5 | t = 9 | (S-C) = 9.500000000006725E−5 |
| l = 5 | t = 10 | (S-C) = 0.0 |
| l = 5 | t = 11 | (S-C) = 9.499999999995623E−5 |
| l = 5 | t = 12 | (S-C) = 8.099999999999774E−5 |
| l = 5 | t = 13 | (S-C) = 5.900000000003125E−5 |
| l = 5 | t = 14 | (S-C) = 3.100000000000325E−5 |
| l = 5 | t = 15 | (S-C) = 0.0 |
| l = 5 | t = 16 | (S-C) = −3.100000000000325E−5 |
| l = 5 | t = 17 | (S-C) = −5.900000000003125E−5 |
| l = 5 | t = 18 | (S-C) = −8.099999999999774E−5 |
| l = 5 | t = 19 | (S-C) = −9.500000000006725E−5 |
| l = 5 | t = 20 | (S-C) = 0.0 |
| l = 5 | t = 21 | (S-C) = −9.499999999995623E−5 |
| l = 5 | t = 22 | (S-C) = −8.099999999999774E−5 |
| l = 5 | t = 23 | (S-C) = −5.900000000003125E−5 |
| l = 5 | t = 24 | (S-C) = −3.100000000000325E−5 |
| l = 6 | t = 1 | (S-C) = −9.500000000000064E−4 |
| l = 6 | t = 2 | (S-C) = −8.100000000000329E−4 |
| l = 6 | t = 3 | (S-C) = −5.900000000000905E−4 |
| l = 6 | t = 4 | (S-C) = −3.1000000000003247E−4 |
| l = 6 | t = 5 | (S-C) = 0.0 |
| l = 6 | t = 6 | (S-C) = 3.1000000000003247E−4 |
| l = 6 | t = 7 | (S-C) = 5.899999999999794E−4 |
| l = 6 | t = 8 | (S-C) = 8.099999999999774E−4 |
| l = 6 | t = 9 | (S-C) = 9.500000000000064E−4 |
| l = 6 | t = 10 | (S-C) = 0.0 |
| l = 6 | t = 11 | (S-C) = 9.500000000000064E−4 |
| l = 6 | t = 12 | (S-C) = 8.100000000000329E−4 |
| l = 6 | t = 13 | (S-C) = 5.900000000000905E−4 |
| l = 6 | t = 14 | (S-C) = 3.1000000000003247E−4 |
| l = 6 | t = 15 | (S-C) = 0.0 |
| l = 6 | t = 16 | (S-C) = −3.1000000000003247E−4 |
| l = 6 | t = 17 | (S-C) = −5.899999999999794E−4 |
| l = 6 | t = 18 | (S-C) = −8.099999999999774E−4 |
| l = 6 | t = 19 | (S-C) = −9.500000000000064E−4 |
| l = 6 | t = 20 | (S-C) = 0.0 |
| l = 6 | t = 21 | (S-C) = −9.500000000000064E−4 |
| l = 6 | t = 22 | (S-C) = −8.100000000000329E−4 |
| l = 6 | t = 23 | (S-C) = −5.900000000000905E−4 |
| l = 6 | t = 24 | (S-C) = −3.1000000000003247E−4 |
| l = 7 | t = 1 | (S-C) = −0.009499999999999953 |
| l = 7 | t = 2 | (S-C) = −0.008099999999999996 |
| l = 7 | t = 3 | (S-C) = −0.005900000000000016 |
| l = 7 | t = 4 | (S-C) = −0.0030999999999999917 |
| l = 7 | t = 5 | (S-C) = 0.0 |
| l = 7 | t = 6 | (S-C) = 0.0030999999999999917 |
| l = 7 | t = 7 | (S-C) = 0.005900000000000016 |
| l = 7 | t = 8 | (S-C) = 0.008099999999999996 |
| l = 7 | t = 9 | (S-C) = 0.009500000000000064 |
| l = 7 | t = 10 | (S-C) = 0.0 |
| l = 7 | t = 11 | (S-C) = 0.009499999999999953 |
| l = 7 | t = 12 | (S-C) = 0.008099999999999996 |
| l = 7 | t = 13 | (S-C) = 0.005900000000000016 |
| l = 7 | t = 14 | (S-C) = 0.0030999999999999917 |
| l = 7 | t = 15 | (S-C) = 0.0 |
| l = 7 | t = 16 | (S-C) = −0.0030999999999999917 |
| l = 7 | t = 17 | (S-C) = −0.005900000000000016 |
| l = 7 | t = 18 | (S-C) = −0.008099999999999996 |
| l = 7 | t = 19 | (S-C) = −0.009500000000000064 |
| l = 7 | t = 20 | (S-C) = 0.0 |
| l = 7 | t = 21 | (S-C) = −0.009499999999999953 |
| l = 7 | t = 22 | (S-C) = −0.008099999999999996 |
| l = 7 | t = 23 | (S-C) = −0.005900000000000016 |
| l = 7 | t = 24 | (S-C) = −0.0030999999999999917 |
| l = 8 | t = 1 | (S-C) = −0.09499999999999997 |
| l = 8 | t = 2 | (S-C) = −0.08100000000000002 |
| l = 8 | t = 3 | (S-C) = −0.05900000000000005 |
| l = 8 | t = 4 | (S-C) = −0.030999999999999917 |
| l = 8 | t = 5 | (S-C) = 0.0 |
| l = 8 | t = 6 | (S-C) = 0.031000000000000028 |
| l = 8 | t = 7 | (S-C) = 0.059 |
| l = 8 | t = 8 | (S-C) = 0.08099999999999999 |
| l = 8 | t = 9 | (S-C) = 0.09500000000000003 |
| l = 8 | t = 10 | (S-C) = 0.0 |
| l = 8 | t = 11 | (S-C) = 0.09499999999999997 |
| l = 8 | t = 12 | (S-C) = 0.08100000000000002 |
| l = 8 | t = 13 | (S-C) = 0.05900000000000005 |
| l = 8 | t = 14 | (S-C) = 0.030999999999999917 |
| l = 8 | t = 15 | (S-C) = 0.0 |
| l = 8 | t = 16 | (S-C) = −0.031000000000000028 |
| l = 8 | t = 17 | (S-C) = −0.059 |
| l = 8 | t = 18 | (S-C) = −0.08099999999999999 |
| l = 8 | t = 19 | (S-C) = −0.09500000000000003 |
| l = 8 | t = 20 | (S-C) = 0.0 |
| l = 8 | t = 21 | (S-C) = −0.09499999999999997 |
| l = 8 | t = 22 | (S-C) = −0.08100000000000002 |
| l = 8 | t = 23 | (S-C) = −0.05900000000000005 |
| l = 8 | t = 24 | (S-C) = −0.030999999999999917 |
| l = 9 | t = 1 | (S-C) = 0.04999999999999999 |
| l = 9 | t = 2 | (S-C) = −0.81 |
| l = 9 | t = 3 | (S-C) = 0.4099999999999999 |
| l = 9 | t = 4 | (S-C) = −0.31000000000000005 |
| l = 9 | t = 5 | (S-C) = 0.0 |
| l = 9 | t = 6 | (S-C) = 0.30999999999999994 |
| l = 9 | t = 7 | (S-C) = 0.5900000000000001 |
| l = 9 | t = 8 | (S-C) = −0.19000000600000006 |
| l = 9 | t = 9 | (S-C) = −0.04999999999999999 |
| l = 9 | t = 10 | (S-C) = 0.0 |
| l = 9 | t = 11 | (S-C) = −0.04999999999999999 |
| l = 9 | t = 12 | (S-C) = 0.81 |
| l = 9 | t = 13 | (S-C) = −0.4099999999999999 |
| l = 9 | t = 14 | (S-C) = 0.31000000000000005 |
| l = 9 | t = 15 | (S-C) = 0.0 |
| l = 9 | t = 16 | (S-C) = −0.30999999999999994 |
| l = 9 | t = 17 | (S-C) = −0.5900000000000001 |
| l = 9 | t = 18 | (S-C) = 0.19000000000000006 |
| l = 9 | t = 19 | (S-C) = 0.04999999999999999 |
| l = 9 | t = 20 | (S-C) = 0.0 |
| l = 9 | t = 21 | (S-C) = 0.04999999999999999 |
| l = 9 | t = 22 | (S-C) = −0.81 |
| l = 9 | t = 23 | (S-C) = 0.4099999999999999 |
| l = 9 | t = 24 | (S-C) = −0.31000000000000005 |
| l = 10 | t = 1 | (S-C) = −0.49999999999999994 |
| l = 10 | t = 2 | (S-C) = −0.1 |
| l = 10 | t = 3 | (S-C) = 0.09999999999999998 |
| l = 10 | t = 4 | (S-C) = −0.1 |
| l = 10 | t = 5 | (S-C) = 0.0 |
| l = 10 | t = 6 | (S-C) = 0.10000000000000009 |
| l = 10 | t = 7 | (S-C) = −0.09999999999999998 |
| l = 10 | t = 8 | (S-C) = 0.10000000000000009 |
| l = 10 | t = 9 | (S-C) = −0.49999999999999994 |
| l = 10 | t = 10 | (S-C) = 0.0 |
| l = 10 | t = 11 | (S-C) = 0.49999999999999994 |
| l = 10 | t = 12 | (S-C) = 0.1 |
| l = 10 | t = 13 | (S-C) = −0.09999999999999998 |
| l = 10 | t = 14 | (S-C) = 0.1 |
| l = 10 | t = 15 | (S-C) = 0.0 |
| l = 10 | t = 16 | (S-C) = −0.10000000000000009 |
| l = 10 | t = 17 | (S-C) = 0.09999999999999998 |
| l = 10 | t = 18 | (S-C) = −0.10000000000000009 |
| l = 10 | t = 19 | (S-C) = 0.49999999999999994 |
| l = 10 | t = 20 | (S-C) = 0.0 |
| l = 10 | t = 21 | (S-C) = −0.49999999999999994 |
| l = 10 | t = 22 | (S-C) = −0.1 |
| l = 10 | t = 23 | (S-C) = 0.09999999999999998 |
| l = 10 | t = 24 | (S-C) = −0.1 |
| l = 11 | t = 1 | (S-C) = 0.0 |
| l = 11 | t = 2 | (S-C) = 0.0 |
| l = 11 | t = 3 | (S-C) = 0.0 |
| l = 11 | t = 4 | (S-C) = 0.0 |
| l = 11 | t = 5 | (S-C) = 0.0 |
| l = 11 | t = 6 | (S-C) = 0.0 |
| l = 11 | t = 7 | (S-C) = 0.0 |
| l = 11 | t = 8 | (S-C) = 0.0 |
| l = 11 | t = 9 | (S-C) = 0.0 |
| l = 11 | t = 10 | (S-C) = 0.0 |
| l = 11 | t = 11 | (S-C) = 0.0 |
| l = 11 | t = 12 | (S-C) = 0.0 |
| l = 11 | t = 13 | (S-C) = 0.0 |
| l = 11 | t = 14 | (S-C) = 0.0 |
| l = 11 | t = 15 | (S-C) = 0.0 |
| l = 11 | t = 16 | (S-C) = 0.0 |
| l = 11 | t = 17 | (S-C) = 0.0 |
| l = 11 | t = 18 | (S-C) = 0.0 |
| l = 11 | t = 19 | (S-C) = 0.0 |
| l = 11 | t = 20 | (S-C) = 0.0 |
| l = 11 | t = 21 | (S-C) = 0.0 |
| l = 11 | t = 22 | (S-C) = 0.0 |
| l = 11 | t = 23 | (S-C) = 0.0 |
| l = 11 | t = 24 | (S-C) = 0.0 |

1
Signal #1 SA[l] [t] = sine (2*pi*t/T + 0.000000001)
Signal #2 CA[l] [t] = sine (2*pi*t/T + 0.000000002)
1) (S-C) = SA[l] [t] − CA[l] [t], regular fration if l = 0, purtial number if l > 0

TABLE 2-a
T = 20

| 5 | | 1 | 2 | 3 | 4 |
|---|---|---|---|---|---|
| l = 0 | t = 1 | S = 0.25776895056 | C = 0.89980847248 | S[l] = 0.25776895056 | C[l] = 0.89980847248 |
| N = 0.948751956186867 | | | | | |
| l = 0 | t = 2 | S = 0.78810178213 | C = 0.00933352421 | S[l] = 0.78810178213 | C[l] = 0.00933352421 |
| N = 0.20031652984469428 | | | | | |
| l = 0 | t = 3 | S = 0.03216088678 | C = 0.81092914469 | S[l] = 0.03216088678 | C[l] = 0.81092914469 |
| N = 0.22314389240719457 | | | | | |
| l = 0 | t = 4 | S = 0.60591842273 | C = 0.96387890081 | S[l] = 0.60591842273 | C[l] = 0.96387890081 |
| N = 0.654861906443181 | | | | | |
| l = 0 | t = 5 | S = 0.70282738053 | C = 0.70282738053 | S[l] = 0.70282738053 | C[l] = 0.70282738053 |
| N = 0.70282738053727 | | | | | |
| l = 0 | t = 6 | S = 0.29846409112 | C = 0.03839058045 | S[l] = 0.29846409112 | C[l] = 0.03839058045 |
| N = 0.34740757483032014 | | | | | |
| l = 0 | t = 7 | S = 0.78148743892 | C = 0.38468519225 | S[l] = 0.78148743892 | C[l] = 0.38468519225 |
| N = 0.9724704445503247 | | | | | |
| l = 0 | t = 8 | S = 0.55028823143 | C = 0.15348598476 | S[l] = 0.55028823143 | C[l] = 0.15348598476 |
| N = 0.9625029791429214 | | | | | |
| l = 0 | t = 9 | S = 0.15392864813 | C = −0.10614486253 | S[l] = 0.15392864813 | C[l] = −0.10614486253 |
| N = 0.8449116537601573 | | | | | |
| l = 0 | t = 10 | S = 0.69615760997 | C = −0.30384239002 | S[l] = 0.69615760997 | C[l] = −0.30384239002 |
| N = 0.6961576099751657 | | | | | |
| l = 0 | t = 11 | S = 0.17593898897 | C = −0.46610053294 | S[l] = 0.17593898897 | C[l] = −0.46610053294 |
| N = 0.48495598334696144 | | | | | |
| l = 0 | t = 12 | S = −0.26965055256 | C = −0.49088229464 | S[l] = −0.26965055256 | C[l] = −0.49088229464 |
| N = 0.31813469972871655 | | | | | |
| l = 0 | t = 13 | S = −0.00628592949 | C = 0.21494581258 | S[l] = −0.00628592949 | C[l] = 0.21494581258 |
| N = 0.8027310648765396 | | | | | |
| l = 0 | t = 14 | S = −0.49440612508 | C = 0.14763339683 | S[l] = −0.49440612508 | C[l] = 0.14763339683 |
| N = 0.45665039121056306 | | | | | |
| l = 0 | t = 15 | S = −0.84805083978 | C = 0.15194916021 | S[l] = −0.84805083978 | C[l] = 0.15194916021 |
| N = 0.15194916021537974 | | | | | |
| l = 0 | t = 16 | S = −0.15031074575 | C = 0.10976276491 | S[l] = −0.15031074575 | C[l] = 0.10976276491 |
| N = 0.8007457705392532 | | | | | |
| l = 0 | t = 17 | S = −0.0894879897 | C = 0.30731425696 | S[l] = −0.0894879897 | C[l] = 0.30731425696 |
| N = 0.7195290046703495 | | | | | |
| l = 0 | t = 18 | S = 0.03210174911 | C = 0.42890399578 | S[l] = 0.03210174911 | C[l] = 0.42890399578 |
| N = 0.6198870014088032 | | | | | |
| l = 0 | t = 19 | S = 0.61282032537 | C = 0.87289383604 | S[l] = 0.61282032537 | C[l] = 0.87289383604 |
| N = 0.9218373197540333 | | | | | |
| l = 0 | t = 20 | S = 0.26915135712 | C = 0.26915135712 | S[l] = 0.26915135712 | C[l] = 0.26915135712 |
| N = 0.2691513571218861 | | | | | |
| l = 0 | t = 21 | S = 0.79087035268 | C = 0.4329098746 | S[l] = 0.79087035268 | C[l] = 0.4329098746 |
| N = 0.48185335830979714 | | | | | |
| l = 0 | t = 22 | S = 0.78606150088 | C = 0.00729324296 | S[l] = 0.78606150088 | C[l] = 0.00729324296 |
| N = 0.1982762485888533 | | | | | |
| l = 0 | t = 23 | S = 0.70302109027 | C = 0.48178934818 | S[l] = 0.70302109027 | C[l] = 0.48178934818 |
| N = 0.8940040958973992 | | | | | |
| l = 0 | t = 24 | S = 0.39716429573 | C = 0.75512477381 | S[l] = 0.39716429573 | C[l] = 0.75512477381 |
| N = 0.44610777943856605 | | | | | |
| l = 1 | t = 1 | S = 0.25776895056 | C = 0.89980847248 | S[l] = 0.5776895056 | C[l] = 0.9980847248 |
| N = 0.948751956186867 | | | | | |
| l = 1 | t = 2 | S = 0.78810178213 | C = 0.00933352421 | S[l] = 0.8810178213 | C[l] = 0.0933352421 |
| N = 0.20031652984469428 | | | | | |
| l = 1 | t = 3 | S = 0.03216088678 | C = 0.81092914469 | S[l] = 0.3216088678 | C[l] = 0.1092914469 |
| N = 0.22314389240719457 | | | | | |
| l = 1 | t = 4 | S = 0.60591842273 | C = 0.96387890081 | S[l] = 0.0591842273 | C[l] = 0.6387890081 |
| N = 0.654861906443181 | | | | | |
| l = 1 | t = 5 | S = 0.70282738053 | C = 0.70282738053 | S[l] = 0.0282738053 | C[l] = 0.0282738053 |
| N = 0.70282738053727 | | | | | |
| l = 1 | t = 6 | S = 0.29846409112 | C = 0.03839058045 | S[l] = 0.9846409112 | C[l] = 0.3839058045 |
| N = 0.34740757483032014 | | | | | |
| l = 1 | t = 7 | S = 0.78148743892 | C = 0.38468519225 | S[l] = 0.8148743892 | C[l] = 0.8468519225 |
| N = 0.9724704445503247 | | | | | |
| l = 1 | t = 8 | S = 0.55028823143 | C = 0.15348598476 | S[l] = 0.5028823143 | C[l] = 0.5348598476 |
| N = 0.9625029791429214 | | | | | |
| l = 1 | t = 9 | S = 0.15392864813 | C = −0.10614486253 | S[l] = 0.5392864813 | C[l] −0.0614486253 |
| N = 0.8449116537601573 | | | | | |
| l = 1 | t = 10 | S = 0.69615760997 | C = −0.30384239002 | S[l] = 0.9615760997 | C[l] = −0.0384239002 |
| N = 0.6961576099751657 | | | | | |
| l = 1 | t = 11 | S = 0.17593898897 | C = −0.46610053294 | S[l] = 0.7593898897 | C[l] = −0.6610053294 |
| N = 0.48495598334696144 | | | | | |
| l = 1 | t = 12 | S = −0.26965055256 | C = −0.49088229464 | S[l] = −0.6965055256 | C[l] −0.9088229464 |
| N = 0.31813469972871655 | | | | | |
| l = 1 | t = 13 | S = −0.00628592949 | C = 0.21494581258 | S[l] = −0.0628592949 | C[l] = 0.1494581258 |
| N = 0.8027310648765396 | | | | | |
| l = 1 | t = 14 | S = −0.49440612508 | C = 0.14763339683 | S[l] = −0.9440612508 | C[l] = 0.4763339683 |
| N = 0.45665039121056306 | | | | | |
| l = 1 | t = 15 | S = −0.84805083978 | C = 0.15194916021 | S[l] = −0.4805083978 | C[l] = 0.5194916021 |
| N = 0.15194916021537974 | | | | | |
| l = 1 | t = 16 | S = −0.15031074575 | C = 0.10976276491 | S[l] = −0.5031074575 | C[l] = 0.0976276491 |
| N = 0.8007457705392532 | | | | | |
| l = 1 | t = 17 | S = −0.0894879897 | C = 0.30731425696 | S[l] = −0.894879897 | C[l] = 0.0731425696 |
| N = 0.7195290046703495 | | | | | |
| l = 1 | t = 18 | S = 0.03210174911 | C = 0.42890399578 | S[l] = 0.3210174911 | C[l] = 0.2890399578 |
| N = 0.6198870014088032 | | | | | |
| l = 1 | t = 19 | S = 0.61282032537 | C = 0.87289383604 | S[l] = 0.1282032537 | C[l] = 0.7289383604 |
| N = 0.9218373197540333 | | | | | |
| l = 1 | t = 20 | S = 0.26915135712 | C = 0.26915135712 | S[l] = 0.6915135712 | C[l] = 0.6915135712 |
| N = 0.2691513571218861 | | | | | |
| l = 1 | t = 21 | S = 0.79087035268 | C = 0.4329098746 | S[l] = 0.9087035268 | C[l] = 0.329098746 |
| N = 0.48185335830979714 | | | | | |
| l = 1 | t = 22 | S = 0.78606150088 | C = 0.00729324296 | S[l] = 0.8606150088 | C[l] = 0.0729324296 |
| N = 0.1982762485888533 | | | | | |
| l = 1 | t = 23 | S = 0.70302109027 | C = 0.48178934818 | S[l] = 0.0302109027 | C[l] = 0.8178934818 |
| N = 0.8940040958973992 | | | | | |
| l = 1 | t = 24 | S = 0.39716429573 | C = 0.75512477381 | S[l] = 0.9716429573 | C[l] = 0.5512477381 |
| N = 0.44610777943856605 | | | | | |
| l = 2 | t = 1 | S = 0.25776895056 | C = 0.89980847248 | S[l] = 0.776895056 | C+1) = 0.980847248 |
| N = 0.948751956186867 | | | | | |
| l = 2 | t = 2 | S = 0.78810178213 | C = 0.00933352421 | S[l] = 0.810178213 | C[l] = 0.933352421 |
| N = 0.20031652984469428 | | | | | |
| l = 2 | t = 3 | S = 0.03216088678 | C = 0.81092914469 | S[l] = 0.216088678 | C[l] = 0.092914469 |
| N = 0.22314389240719457 | | | | | |
| l = 2 | t = 4 | S = 0.60591842273 | C = 0.96387890081 | S[l] = 0.591842273 | C[l] = 0.387890081 |
| N = 0.654861906443181 | | | | | |
| l = 2 | t = 5 | S = 0.70282738053 | C = 0.70282738053 | S[l] = 0.282738053 | C[l] = 0.282738053 |
| N = 0.70282738053727 | | | | | |
| l = 2 | t = 6 | S = 0.29846409112 | C = 0.03839058045 | S[l] = 0.846409112 | C[l] = 0.839058045 |
| N = 0.34740757483032014 | | | | | |
| l = 2 | t = 7 | S = 0.78148743892 | C = 0.38468519225 | S[l] = 0.148743892 | C[l] = 0.468519225 |
| N = 0.9724704445503247 | | | | | |
| l = 2 | t = 8 | S = 0.55028823143 | C = 0.15348598476 | S[l] = 0.028823143 | C[l] = 0.348598476 |
| N = 0.9625029791429214 | | | | | |
| l = 2 | t = 9 | S = 0.15392864813 | C = −0.10614486253 | S[l] = 0.392864813 | C[l] = −0.614486253 |
| N = 0.8449116537601573 | | | | | |
| l = 2 | t = 10 | S = 0.69615760997 | C = −0.30384239002 | S[l] = 0.615760997 | C[l] = −0.384239002 |
| N = 0.6961576099751657 | | | | | |
| l = 2 | t = 11 | S = 0.17593898897 | C = −0.46610053294 | S[l] = 0.593898897 | C[l] = −0.610053294 |
| N = 0.48495598334696144 | | | | | |
| l = 2 | t = 12 | S = −0.26965055256 | C = −0.49088229464 | S[l] = −0.965055256 | C[l] = −0.088229464 |
| N = 0.31813469972871655 | | | | | |
| l = 2 | t = 13 | S = −0.00628592949 | C = 0.21494581258 | S[l] = −0.628592949 | C[l] = 0.494581258 |
| N = 0.8027310648765396 | | | | | |
| l = 2 | t = 14 | S = −0.49440612508 | C = 0.14763339683 | S[l] = −0.440612508 | C[l] = 0.763339683 |
| N = 0.45665039121056306 | | | | | |
| l = 2 | t = 15 | S = −0.84805083978 | C = 0.15194916021 | S[l] = −0.805083978 | C[l] = 0.194916021 |
| N = 0.15194916021537974 | | | | | |
| l = 2 | t = 16 | S = −0.15031074575 | C = 0.10976276491 | S[l] = −0.031074575 | C[l] = 0.976276491 |
| N = 0.8007457705392532 | | | | | |
| l = 2 | t = 17 | S = −0.0894879897 | C = 0.30731425696 | S[l] = −0.94879897 | C[l] = 0.731425696 |
| N = 0.7195290046703495 | | | | | |
| l = 2 | t = 18 | S = 0.03210174911 | C = 0.42890399578 | S[l] = 0.210174911 | C[l] = 0.890399578 |
| N = 0.6198870014088032 | | | | | |
| l = 2 | t = 19 | S = 0.61282032537 | C = 0.87289383604 | S[l] = 0.282032537 | C[l] = 0.289383604 |
| N = 0.9218373197540333 | | | | | |
| l = 2 | t = 20 | S = 0.26915135712 | C = 0.26915135712 | S[l] = 0.915135712 | C[l] = 0.915135712 |
| N = 0.2691513571218861 | | | | | |
| l = 2 | t = 21 | S = 0.79087035268 | C = 0.4329098746 | S[l] = 0.087035268 | C[l] = 0.29098746 |
| N = 0.48185335830979714 | | | | | |
| l = 2 | t = 22 | S = 0.78606150088 | C = 0.00729324296 | S[l] = 0.606150088 | C[l] = 0.729324296 |
| N = 0.1982762485888533 | | | | | |
| l = 2 | t = 23 | S = 0.70302109027 | C = 0.48178934818 | S[l] = 0.302109027 | C[l] = 0.178934818 |
| N = 0.8940040958973992 | | | | | |
| l = 2 | t = 24 | S = 0.39716429573 | C = 0.75512477381 | S[l] = 0.716429573 | C[l] = 0.512477381 |
| N = 0.44610777943856605 | | | | | |
| l = 8 | t = 1 | S = 0.25776895056 | C = 0.89980847248 | S[l] = 0.056 | C[l] = 0.248 |
| N = 0.948751956186867 | | | | | |
| l = 8 | t = 2 | S = 0.78810178213 | C = 0.00933352421 | S[l] = 0.213 | C[l] = 0.421 |
| N = 0.20031652984469428 | | | | | |
| l = 8 | t = 3 | S = 0.03216088678 | C = 0.81092914469 | S[l] = 0.678 | C[l] = 0.469 |
| N = 0.22314389240719457 | | | | | |
| l = 8 | t = 4 | S = 0.60591842273 | C = 0.96387890081 | S[l] = 0.273 | C[l] = 0.081 |
| N = 0.654861906443181 | | | | | |
| l = 8 | t = 5 | S = 0.70282738053 | C = 0.70282738053 | S[l] = 0.053 | C[l] = 0.053 |
| N = 0.70282738053727 | | | | | |
| l = 8 | t = 6 | S = 0.29846409112 | C = 0.03839058045 | S[l] = 0.112 | C[l] = 0.045 |
| N = 0.34740757483032014 | | | | | |
| l = 8 | t = 7 | S = 0.78148743892 | C = 0.38468519225 | S[l] = 0.892 | C[l] = 0.225 |
| N = 0.9724704445503247 | | | | | |
| l = 8 | t = 8 | S = 0.55028823143 | C = 0.15348598476 | S[l] = 0.143 | C[l] = 0.476 |
| N = 0.9625029791429214 | | | | | |
| l = 8 | t = 9 | S = 0.15392864813 | C = −0.10614486253 | S[l] = 0.813 | C[l] = −0.253 |
| N = 0.8449116537601573 | | | | | |
| l = 8 | t = 10 | S = 0.69615760997 | C = −0.30384239002 | S[l] = 0.997 | C[l] −0.0020 |
| N = 0.6961576099751657 | | | | | |
| l = 8 | t = 11 | S = 0.17593898897 | C = −0.46610053294 | S[l] = 0.897 | C[l] = −0.294 |
| N = 0.48495598334696144 | | | | | |
| l = 8 | t = 12 | S = −0.26965055256 | C = −0.49088229464 | S[l] = −0.256 | C[l] = −0.464 |
| N = 0.31813469972871655 | | | | | |
| l = 8 | t = 13 | S = −0.00628592949 | C = 0.21494581258 | S[l] = −0.949 | C[l] = 0.258 |
| N = 0.8027310648765396 | | | | | |
| l = 8 | t = 14 | S = −0.49440612508 | C = 0.14763339683 | S[l] = −0.508 | C[l] = 0.683 |
| N = 0.45665039121056306 | | | | | |
| l = 8 | t = 15 | S = −0.84805083978 | C = 0.15194916021 | S[l] = −0.978 | C[l] = 0.021 |
| N = 0.15194916021537974 | | | | | |
| l = 8 | t = 16 | S = −0.15031074575 | C = 0.10976276491 | S[l] = −0.575 | C[l] = 0.491 |
| N = 0.8007457705392532 | | | | | |
| l = 8 | t = 17 | S = −0.0894879897 | C = 0.30731425696 | S[l] = −0.97 | C[l] = 0.696 |
| N = 0.7195290046703495 | | | | | |
| l = 8 | t = 18 | S = 0.03210174911 | C = 0.42890399578 | S[l] = 0.911 | C[l] = 0.578 |
| N = 0.6198870014088032 | | | | | |
| l = 8 | t = 19 | S = 0.61282032537 | C = 0.87289383604 | S[l] = 0.537 | C[l] = 0.604 |
| N = 0.9218373197540333 | | | | | |
| l = 8 | t = 20 | S = 0.26915135712 | C = 0.26915135712 | S[l] = 0.712 | C[l] = 0.712 |
| N = 0.2691513571218861 | | | | | |
| l = 8 | t = 21 | S = 0.79087035268 | C = 0.4329098746 | S[l] = 0.268 | C[l] = 0.46 |
| N = 0.48185335830979714 | | | | | |
| l = 8 | t = 22 | S = 0.78606150088 | C = 0.00729324296 | S[l] = 0.088 | C[l] = 0.296 |
| N = 0.1982762485888533 | | | | | |
| l = 8 | t = 23 | S = 0.70302109027 | C = 0.48178934818 | S[l] = 0.027 | C[l] = 0.818 |
| N = 0.8940040958973992 | | | | | |
| l = 8 | t = 24 | S = 0.39716429573 | C = 0.75512477381 | S[l] = 0.573 | C[l] = 0.381 |
| N = 0.44610777943856605 | | | | | |
| l = 9 | t = 1 | S = 0.25776895056 | C = 0.89980847248 | S[l] = 0.56 | C[l] = 0.48 |
| N = 0.948751956186867 | | | | | |
| l = 9 | t = 2 | S = 0.78810178213 | C = 0.00933352421 | S[l] = 0.13 | C[l] = 0.21 |
| N = 0.20031652984469428 | | | | | |
| l = 9 | t = 3 | S = 0.03216088678 | C = 0.81092914469 | S[l] = 0.78 | C[l] = 0.69 |
| N = 0.22314389240719457 | | | | | |
| l = 9 | t = 4 | S = 0.60591842273 | C = 0.96387890081 | S[l] = 0.73 | C[l] = 0.81 |
| N = 0.654861906443181 | | | | | |
| l = 9 | t = 5 | S = 0.70282738053 | C = 0.70282738053 | S[l] = 0.53 | C[l] = 0.53 |
| N = 0.70282738053727 | | | | | |
| l = 9 | t = 6 | S = 0.29846409112 | C = 0.03839058045 | S[l] = 0.12 | C[l] = 0.45 |
| N = 0.34740757483032014 | | | | | |
| l = 9 | t = 7 | S = 0.78148743892 | C = 0.38468519225 | S[l] = 0.92 | C[l] = 0.25 |
| N = 0.9724704445503247 | | | | | |
| l = 9 | t = 8 | S = 0.55028823143 | C = 0.15348598476 | S[l] = 0.43 | C[l] = 0.76 |
| N = 0.9625029791429214 | | | | | |
| l = 9 | t = 9 | S = 0.15392864813 | C = −0.10614486253 | S[l] = 0.13 | C[l] = −0.53 |
| N = 0.8449116537601573 | | | | | |
| l = 9 | t = 10 | S = 0.69615760997 | C = −0.30384239002 | S[l] = 0.97 | C[l] = −0.02 |
| N = 0.6961576099751657 | | | | | |
| l = 9 | t = 11 | S = 0.17593898897 | C = −0.46610053294 | S[l] = 0.97 | C[l] = −0.94 |
| N = 0.48495598334696144 | | | | | |
| l = 9 | t = 12 | S = −0.26965055256 | C = −0.49088229464 | S[l] = −0.56 | C[l] = −0.64 |
| N = 0.31813469972871655 | | | | | |
| l = 9 | t = 13 | S = −0.00628592949 | C = 0.21494581258 | S[l] = −0.49 | C[l] = 0.58 |
| N = 0.8027310648765396 | | | | | |
| l = 9 | t = 14 | S = −0.49440612508 | C = 0.14763339683 | S[l] = −0.08 | C[l] = 0.83 |
| N = 0.45665039121056306 | | | | | |
| l = 9 | t = 15 | S = −0.84805083978 | C = 0.15194916021 | S[l] = −0.78 | C[l] = 0.21 |
| N = 0.15194916021537974 | | | | | |
| l = 9 | t = 16 | S = −0.15031074575 | C = 0.10976276491 | S[l] = −0.75 | C[l] = 0.91 |
| N = 0.8007457705392532 | | | | | |
| l = 9 | t = 17 | S = −0.0894879897 | C = 0.30731425696 | S[l] = −0.7 | C[l] = 0.96 |
| N = 0.7195290046703495 | | | | | |
| l = 9 | t = 18 | S = 0.03210174911 | C = 0.42890399578 | S[l] = 0.11 | C[l] = 0.78 |
| N = 0.6198870014088032 | | | | | |
| l = 9 | t = 19 | S = 0.61282032537 | C = 0.87289383604 | S[l] = 0.37 | C[l] = 0.04 |
| N = 0.9218373197540333 | | | | | |
| l = 9 | t = 20 | S = 0.26915135712 | C = 0.26915135712 | S[l] = 0.12 | C[l] = 0.12 |
| N = 0.2691513571218861 | | | | | |
| l = 9 | t = 21 | S = 0.79087035268 | C = 0.4329098746 | S[l] = 0.68 | C[l] = 0.6 |
| N = 0.48185335830979714 | | | | | |
| l = 9 | t = 22 | S = 0.78606150088 | C = 0.00729324296 | S[l] = 0.88 | C[l] = 0.96 |
| N = 0.1982762485888533 | | | | | |
| l = 9 | t = 23 | S = 0.70302109027 | C = 0.48178934818 | S[l] = 0.27 | C[l] = 0.18 |
| N = 0.8940040958973992 | | | | | |
| l = 9 | t = 24 | S = 0.39716429573 | C = 0.75512477381 | S[l] = 0.73 | C[l] = 0.81 |
| N = 0.44610777943856605 | | | | | |
| l = 10 | t = 1 | S = 0.25776895056 | C = 0.89980847248 | S[l] = 0.6 | C[l] = 0.8 |
| N = 0.948751956186867 | | | | | |
| l = 10 | t = 2 | S = 0.78810178213 | C = 0.00933352421 | S[l] = 0.3 | C[l] = 0.1 |
| N = 0.20031652984469428 | | | | | |
| l = 10 | t = 3 | S = 0.03216088678 | C = 0.81092914469 | S[l] = 0.8 | C[l] = 0.9 |
| N = 0.22314389240719457 | | | | | |
| l = 10 | t = 4 | S = 0.60591842273 | C = 0.96387890081 | S[l] = 0.3 | C[l] = 0.1 |
| N = 0.654861906443181 | | | | | |
| l = 10 | t = 5 | S = 0.70282738053 | C = 0.70282738053 | S[l] = 0.3 | C[l] = 0.3 |
| N = 0.70282738053727 | | | | | |
| l = 10 | t = 6 | S = 0.29846409112 | C = 0.03839058045 | S[l] = 0.2 | C[l] = 0.5 |
| N = 0.34740757483032014 | | | | | |
| l = 10 | t = 7 | S = 0.78148743892 | C = 0.38468519225 | S[l] = 0.2 | C[l] = 0.5 |
| N = 0.9724704445503247 | | | | | |
| l = 10 | t = 8 | S = 0.55028823143 | C = 0.15348598476 | S[l] = 0.3 | C[l] = 0.6 |
| N = 0.9625029791429214 | | | | | |
| l = 10 | t = 9 | S = 0.15392864813 | C = −0.10614486253 | S[l] = 0.3 | C[l] = −0.3 |
| N = 0.8449116537601573 | | | | | |
| l = 10 | t = 10 | S = 0.69615760997 | C = −0.30384239002 | S[l] = 0.7 | C[l] = −0.2 |
| N = 0.6961576099751657 | | | | | |
| l = 10 | t = 11 | S = 0.17593898897 | C = −0.46610053294 | S[l] = 0.7 | C[l] = −0.4 |
| N = 0.48495598334696144 | | | | | |
| l = 10 | t = 12 | S = −0.26965055256 | C = −0.49088229464 | S[l] = −0.6 | C[l] = −0.4 |
| N = 0.31813469972871655 | | | | | |
| l = 10 | t = 13 | S = −0.00628592949 | C = 0.21494581258 | S[l] = −0.9 | C[l] = 0.8 |
| N = 0.8027310648765396 | | | | | |
| l = 10 | t = 14 | S = −0.49440612508 | C = 0.14763339683 | S[l] = −0.8 | C[l] = 0.3 |
| N = 0.45665039121056306 | | | | | |
| l = 10 | t = 15 | S = −0.84805083978 | C = 0.15194916021 | S[l] = −0.8 | C[l] = 0.1 |
| N = 0.15194916021537974 | | | | | |
| l = 10 | t = 16 | S = −0.15031074575 | C = 0.10976276491 | S[l] = −0.5 | C[l] = 0.1 |
| N = 0.8007457705392532 | | | | | |
| l = 10 | t = 17 | S = −0.0894879897 | C = 0.30731425696 | S[l] = −0.0 | C[l] = 0.6 |
| N = 0.7195290046703495 | | | | | |
| l = 10 | t = 18 | S = 0.03210174911 | C = 0.42890399578 | S[l] = 0.1 | C[l] = 0.8 |
| N = 0.6198870014088032 | | | | | |
| l = 10 | t = 19 | S = 0.61282032537 | C = 0.87289383604 | S[l] = 0.7 | C[l] = 0.4 |
| N = 0.9218373197540333 | | | | | |
| l = 10 | t = 20 | S = 0.26915135712 | C = 0.26915135712 | S[l] = 0.2 | C[l] = 0.2 |
| N = 0.2691513571218861 | | | | | |
| l = 10 | t = 21 | S = 0.79087035268 | C = 0.4329098746 | S[l] = 0.8 | C[l] = 0.0 |
| N = 0.48185335830979714 | | | | | |
| l = 10 | t = 22 | S = 0.78606150088 | C = 0.00729324296 | S[l] = 0.8 | C[l] = 0.6 |
| N = 0.1982762485888533 | | | | | |
| l = 10 | t = 23 | S = 0.70302109027 | C = 0.48178934818 | S[l] = 0.7 | C[l] = 0.8 |
| N = 0.8940040958973992 | | | | | |
| l = 10 | t = 24 | S = 0.39716429573 | C = 0.75512477381 | S[l] = 0.3 | C[l] = 0.1 |
| N = 0.44610777943856605 | | | | | |
| l = 11 | t = 1 | S = 0.25776895056 | C = 0.89980847248 | S[l] = 0.0 | C[l] = 0.0 |
| N = 0.948751956186867 | | | | | |
| l = 11 | t = 2 | S = 0.78810178213 | C = 0.00933352421 | S[l] = 0.0 | C[l] = 0.0 |
| N = 0.20031652984469428 | | | | | |
| l = 11 | t = 3 | S = 0.03216088678 | C = 0.81092914469 | S[l] = 0.0 | C[l] = 0.0 |
| N = 0.22314389240719457 | | | | | |
| l = 11 | t = 4 | S = 0.60591842273 | C = 0.96387890081 | S[l] = 0.0 | C[l] = 0.0 |
| N = 0.654861906443181 | | | | | |
| l = 11 | t = 5 | S = 0.70282738053 | C = 0.70282738053 | S[l] = 0.0 | C[l] = 0.0 |
| N = 0.70282738053727 | | | | | |
| l = 11 | t = 6 | S = 0.29846409112 | C = 0.03839058045 | S[l] = 0.0 | C[l] = 0.0 |
| N = 0.34740757483032014 | | | | | |
| l = 11 | t = 7 | S = 0.78148743892 | C = 0.38468519225 | S[l] = 0.0 | C[l] = 0.0 |
| N = 0.9724704445503247 | | | | | |
| l = 11 | t = 8 | S = 0.55028823143 | C = 0.15348598476 | S[l] = 0.0 | C[l] = 0.0 |
| N = 0.9625029791429214 | | | | | |
| l = 11 | t = 9 | S = 0.15392864813 | C = −0.10614486253 | S[l] = 0.0 | C[l] = −0.0 |
| N = 0.8449116537601573 | | | | | |
| l = 11 | t = 10 | S = 0.69615760997 | C = −0.30384239002 | S[l] = 0.0 | C[l] = −0.0 |
| N = 0.6961576099751657 | | | | | |
| l = 11 | t = 11 | S = 0.17593898897 | C = −0.46610053294 | S[l] = 0.0 | C[l] = −0.0 |
| N = 0.48495598334696144 | | | | | |
| l = 11 | t = 12 | S = −0.26965055256 | C = −0.49088229464 | S[l] = −0.0 | C[l] = −0.0 |
| N = 0.31813469972871655 | | | | | |
| l = 11 | t = 13 | S = −0.00628592949 | C = 0.21494581258 | S[l] = −0.0 | C[l] = 0.0 |
| N = 0.8027310648765396 | | | | | |
| l = 11 | t = 14 | S = −0.49440612508 | C = 0.14763339683 | S[l] = −0.0 | C[l] = 0.0 |
| N = 0.45665039121056306 | | | | | |
| l = 11 | t = 15 | S = −0.84805083978 | C = 0.15194916021 | S[l] = −0.0 | C[l] = 0.0 |
| N = 0.15194916021537974 | | | | | |
| l = 11 | t = 16 | S = −0.15031074575 | C = 0.10976276491 | S[l] = −0.0 | C[l] = 0.0 |
| N = 0.8007457705392532 | | | | | |
| l = 11 | t = 17 | S = −0.0894879897 | C = 0.30731425696 | S[l] = −0.0 | C[l] = 0.0 |
| N = 0.7195290046703495 | | | | | |
| l = 11 | t = 18 | S = 0.03210174911 | C = 0.42890399578 | S[l] = 0.0 | C[l] = 0.0 |
| N = 0.6198870014088032 | | | | | |
| l = 11 | t = 19 | S = 0.61282032537 | C = 0.87289383604 | S[l] = 0.0 | C[l] = 0.0 |
| N = 0.9218373197540333 | | | | | |
| l = 11 | t = 20 | S = 0.26915135712 | C = 0.26915135712 | S[l] = 0.0 | C[l] = 0.0 |
| N = 0.2691513571218861 | | | | | |
| l = 11 | t = 21 | S = 0.79087035268 | C = 0.4329098746 | S[l] = 0.0 | C[l] = 0.0 |
| N = 0.48185335830979714 | | | | | |
| l = 11 | t = 22 | S = 0.78606150088 | C = 0.00729324296 | S[l] = 0.0 | C[l] = 0.0 |
| N = 0.1982762485888533 | | | | | |
| l = 11 | t = 23 | S = 0.70302109027 | C = 0.48178934818 | S[l] = 0.0 | C[l] = 0.0 |
| N = 0.8940040958973992 | | | | | |
| l = 11 | t = 24 | S = 0.39716429573 | C = 0.75512477381 | S[l] = 0.0 | C[l] = 0.0 |

N = 0.44610777943856605

1) S = sine (2*pi*t/T) + N[t]
2) C = sine (2*pi*t/T + pi/2) + N[t]
3) partial S[l] from S
4) partial C[l] from C
5) N = noise N[t]

TABLE 2-b
T = 20

| 5 | | 1 | 2 | 3 | 4 |
|---|---|---|---|---|---|
| l = 0 | t = 1 | S = 0.30901761635 | C = 0.95105713827 | S[l] = 0.30901761635 | C[l] = 0.95105713827 |
| N = 6.219760772260661E−7 | | | | | |
| l = 0 | t = 2 | S = 0.58778565554 | C = 0.80901739762 | S[l] = 0.58778565554 | C[l] = 0.80901739762 |
| N = 4.0325188069130123E−7 | | | | | |
| l = 0 | t = 3 | S = 0.80901707162 | C = 0.58778532954 | S[l] = 0.80901707162 | C[l] = 0.58778532954 |
| N = 7.725011874365183E−8 | | | | | |
| l = 0 | t = 4 | S = 0.95105828031 | C = 0.30901875839 | S[l] = 0.95105828031 | C[l] = 0.30901875839 |
| N = 1.7640215396074375E−6 | | | | | |
| l = 0 | t = 5 | S = 1.36194E−6 | C = 0.0 | S[l] = 1.36194E−6 | C[l] = 0.0 |
| N = 1.361944632341849E−6 | | | | | |
| l = 0 | t = 6 | S = 0.95105651846 | C = −0.3090169922 | S[l] = 0.95105651846 | C[l] −0.3090169922 |
| N = 2.1650401211223967E−9 | | | | | |
| l = 0 | t = 7 | S = 0.80901830327 | C = −0.58778394339 | S[l] = 0.80901830327 | C[l] = −0.58778394339 |
| N = 1.3088964583690867E−6 | | | | | |
| l = 0 | t = 8 | S = 0.58778689576 | C = −0.8090153509 | S[l] = 0.58778689576 | C[l] = −0.8090153509 |
| N = 1.6434690026182703E−6 | | | | | |
| l = 0 | t = 9 | S = 0.3090185711 | C = −0.95105493956 | S[l] = 0.3090185711 | C[l] = −0.95105493956 |
| N = 1.5767259441040967E−6 | | | | | |
| l = 0 | t = 10 | S = 0.0 | C = −0.99999968002 | S[l] = 0.0 | C[l] = −0.99999968002 |
| N = 3.1997268756345254E−7 | | | | | |
| l = 0 | t = 11 | S = −0.30901683431 | C = −0.95105635623 | S[l] = −0.30901683431 | C[l] = −0.95105635623 |
| N = 1.6005726383611728E−7 | | | | | |
| l = 0 | t = 12 | S = −0.58778413958 | C = −0.80901588166 | S[l] = −0.58778413958 | C[l] = −0.80901588166 |
| N = 1.1127111887388616E−6 | | | | | |
| l = 0 | t = 13 | S = −0.80901562035 | C = −0.58778387827 | S[l] = −0.80901562035 | C[l] = −0.58778387827 |
| N = 1.3740207942581466E−6 | | | | | |
| l = 0 | t = 14 | S = −0.95105497265 | C = −0.30901545073 | S[l] = −0.95105497265 | C[l] = −0.30901545073 |
| N = 1.5436378080855724E−6 | | | | | |
| l = 0 | t = 15 | S = −0.9999999104 | C = 0.0 | S[l] = −0.9999999104 | C[l] = 0.0 |
| N = 8.959233163761126E−8 | | | | | |
| l = 0 | t = 16 | S = −0.9510557816 | C = 0.30901772906 | S[l] = −0.9510557816 | C[l] = 0.30901772906 |
| N = 7.346940100581696E−7 | | | | | |
| l = 0 | t = 17 | S = −0.80901639068 | C = 0.58778585598 | S[l] = −0.80901639068 | C[l] = 0.58778585598 |
| N = 6.036916324803745E−7 | | | | | |
| l = 0 | t = 18 | S = −0.58778436332 | C = 0.80901788333 | S[l] = −0.58778436332 | C[l] = 0.80901788333 |
| N = 8.889643870922026E−7 | | | | | |
| l = 0 | t = 19 | S = −0.30901693997 | C = 0.95105657069 | S[l] = −0.30901693997 | C[l] = 0.95105657069 |
| N = 5.439996633508759E−8 | | | | | |
| l = 0 | t = 20 | S = 0.0 | C = 1.2004E−6 | S[l] = 0.0 | C[l] = 1.2004E−6 |
| N = 1.2004013586187288E−6 | | | | | |
| l = 0 | t = 21 | S = 0.30901815536 | C = 0.95105767728 | S[l] = 0.30901815536 | C[l] = 0.95105767728 |
| N = 1.1609861942435922E−6 | | | | | |
| l = 0 | t = 22 | S = 0.58778631896 | C = 0.80901806105 | S[l] = 0.58778631896 | C[l] = 0.80901806105 |
| N = 1.066676810781291E−6 | | | | | |
| l = 0 | t = 23 | S = 0.80901898011 | C = 0.58778723802 | S[l] = 0.80901898011 | C[l] = 0.58778723802 |
| N = 1.985737293201838E−6 | | | | | |
| l = 0 | t = 24 | S = 0.95105661381 | C = 0.30901709189 | S[l] = 0.95105661381 | C[l] = 0.30901709189 |
| N = 9.75247616165269E−8 | | | | | |
| l = 1 | t = 1 | S = 0.30901761635 | C = 0.95105713827 | S[l] = 0.0901761635 | C+1) = 0.5105713827 |
| N = 6.219760772260661E−7 | | | | | |
| l = 1 | t = 2 | S = 0.58778565554 | C = 0.80901739762 | S[l] = 0.8778565554 | C[l] = 0.0901739762 |
| N = 4.0325188069130123E−7 | | | | | |
| l = 1 | t = 3 | S = 0.80901707162 | C = 0.58778532954 | S[l] = 0.0901707162 | C[l] = 0.8778532954 |
| N = 7.725011874365183E−8 | | | | | |
| l = 1 | t = 4 | S = 0.95105828031 | C = 0.30901875839 | S[l] = 0.5105828031 | C[l] = 0.0901875839 |
| N = 1.7640215396074375E−6 | | | | | |
| l = 1 | t = 5 | S = 1.36194E−6 | C = 0.0 | S[l] = 0.0 | C[l] = 0.0 |
| N = 1.361944632341849E−6 | | | | | |
| l = 1 | t = 6 | S = 0.95105651846 | C = −0.3090169922 | S[l] = 0.5105651846 | C[l] −0.090169922 |
| N = 2.1650401211223967E−9 | | | | | |
| l = 1 | t = 7 | S = 0.80901830327 | C = −0.58778394339 | S[l] = 0.0901830327 | C[l] = −0.8778394339 |
| N = 1.3088964583690867E−6 | | | | | |
| l = 1 | t = 8 | S = 0.58778689576 | C = −0.8090153509 | S[l] = 0.8778689576 | C[l] = −0.090153509 |
| N = 1.6434690026182703E−6 | | | | | |
| l = 1 | t = 9 | S = 0.3090185711 | C = −0.95105493956 | S[l] = 0.090185711 | C[l] = −0.5105493956 |
| N = 1.5767259441040967E−6 | | | | | |
| l = 1 | t = 10 | S = 0.0 | C = −0.99999968002 | S[l] = 0.0 | C[l] = −0.9999968002 |
| N = 3.1997268756345254E−7 | | | | | |
| l = 1 | t = 11 | S = −0.30901683431 | C = −0.95105635623 | S[l] = −0.0901683431 | C[l] = −0.5105635623 |
| N = 1.6005726383611728E−7 | | | | | |
| l = 1 | t = 12 | S = −0.58778413958 | C = −0.80901588166 | S[l] = −0.8778413958 | C[l] = −0.0901588166 |
| N = 1.1127111887388616E−6 | | | | | |
| l = 1 | t = 13 | S = −0.80901562035 | C = −0.58778387827 | S[l] = −0.0901562035 | C[l] = −0.8778387827 |
| N = 1.3740207942581466E−6 | | | | | |
| l = 1 | t = 14 | S = −0.95105497265 | C = −0.30901545073 | S[l] = −0.5105497265 | C[l] = −0.0901545073 |
| N = 1.5436378080855724E−6 | | | | | |
| l = 1 | t = 15 | S = −0.9999999104 | C = 0.0 | S[l] = −0.999999104 | C[l] = 0.0 |
| N = 8.959233163761126E−8 | | | | | |
| l = 1 | t = 16 | S = −0.9510557816 | C = 0.30901772906 | S[l] = −0.510557816 | C[l] = 0.0901772906 |
| N = 7.346940100581696E−7 | | | | | |
| l = 1 | t = 17 | S = −0.80901639068 | C = 0.58778585598 | S[l] = −0.0901639068 | C[l] = 0.8778585598 |
| N = 6.036916324803745E−7 | | | | | |
| l = 1 | t = 18 | S = −0.58778436332 | C = 0.80901788333 | S[l] = −0.8778436332 | C[l] = 0.0901788333 |
| N = 8.889643870922026E−7 | | | | | |
| l = 1 | t = 19 | S = −0.30901693997 | C = 0.95105657069 | S[l] = −0.0901693997 | C[l] = 0.5105657069 |
| N = 5.439996633508759E−8 | | | | | |
| l = 1 | t = 20 | S = 0.0 | C = 1.2004E−6 | S[l] = 0.0 | C[l] = 0.0 |
| N = 1.2004013586187288E−6 | | | | | |
| l = 1 | t = 21 | S = 0.30901815536 | C = 0.95105767728 | S[l] = 0.0901815536 | C[l] = 0.5105767728 |
| N = 1.1609861942435922E−6 | | | | | |
| l = 1 | t = 22 | S = 0.58778631896 | C = 0.80901806105 | S[l] = 0.8778631896 | C[l] = 0.0901806105 |
| N = 1.066676810781291E−6 | | | | | |
| l = 1 | t = 23 | S = 0.80901898011 | C = 0.58778723802 | S[l] = 0.0901898011 | C[l] = 0.8778723802 |
| N = 1.985737293201838E−6 | | | | | |
| l = 1 | t = 24 | S = 0.95105661381 | C = 0.30901709189 | S[l] = 0.5105661381 | C[l] = 0.0901709189 |
| N = 9.75247616165269E−8 | | | | | |
| l = 2 | t = 1 | S = 0.30901761635 | C = 0.95105713827 | S[l] = 0.901761635 | C[l] = 0.105713827 |
| N = 6.219760772260661E−7 | | | | | |
| l = 2 | t = 2 | S = 0.58778565554 | C = 0.80901739762 | S[l] = 0.778565554 | C[l] = 0.901739762 |
| N = 4.0325188069130123E−7 | | | | | |
| l = 2 | t = 3 | S = 0.80901707162 | C = 0.58778532954 | S[l] = 0.901707162 | C[l] = 0.778532954 |
| N = 7.725011874365183E−8 | | | | | |
| l = 2 | t = 4 | S = 0.95105828031 | C = 0.30901875839 | S[l] = 0.105828031 | C[l] = 0.901875839 |
| N = 1.7640215396074375E−6 | | | | | |
| l = 2 | t = 5 | S = 1.36194E−6 | C = 0.0 | S[l] = 0.0 | C[l] = 0.0 |
| N = 1.361944632341849E−6 | | | | | |
| l = 2 | t = 6 | S = 0.95105651846 | C = −0.3090169922 | S[l] = 0.105651846 | C[l] = −0.90169922 |
| N = 2.1650401211223967E−9 | | | | | |
| l = 2 | t = 7 | S = 0.80901830327 | C = −0.58778394339 | S[l] = 0.901830327 | C[l] = −0.778394339 |
| N = 1.3088964583690867E−6 | | | | | |
| l = 2 | t = 8 | S = 0.58778689576 | C = −0.8090153509 | S[l] = 0.778689576 | C[l] = −0.90153509 |
| N = 1.6434690026182703E−6 | | | | | |
| l = 2 | t = 9 | S = 0.3090185711 | C = −0.95105493956 | S[l] = 0.90185711 | C[l] = −0.105493956 |
| N = 1.5767259441040967E−6 | | | | | |
| l = 2 | t = 10 | S = 0.0 | C = −0.99999968002 | S[l] = 0.0 | C[l] = −0.999968002 |
| N = 3.1997268756345254E−7 | | | | | |
| l = 2 | t = 11 | S = −0.30901683431 | C = −0.95105635623 | S[l] = −0.901683431 | C[l] = −0.105635623 |
| N = 1.6005726383611728E−7 | | | | | |
| l = 2 | t = 12 | S = −0.58778413958 | C = −0.80901588166 | S[l] = −0.778413958 | C[l] = −0.901588166 |
| N = 1.1127111887388616E−6 | | | | | |
| l = 2 | t = 13 | S = −0.80901562035 | C = −0.58778387827 | S+1) = −0.901562035 | C[l] = −0.778387827 |
| N = 1.3740207942581466E−6 | | | | | |
| l = 2 | t = 14 | S = −0.95105497265 | C = −0.30901545073 | S[l] −0.105497265 | C[l] = −0.901545073 |
| N = 1.5436378080855724E−6 | | | | | |
| l = 2 | t = 15 | S = −0.9999999104 | C = 0.0 | S[l] = −0.99999104 | C[l] = 0.0 |
| N = 8.959233163761126E−8 | | | | | |
| l = 2 | t = 16 | S = −0.9510557816 | C = 0.30901772906 | S[l] = −0.10557816 | C[l] = 0.901772906 |
| N = 7.346940100581696E−7 | | | | | |
| l = 2 | t = 17 | S = −0.80901639068 | C = 0.58778585598 | S[l] = −0.901639068 | C[l] = 0.778585598 |
| N = 6.036916324803745E−7 | | | | | |
| l = 2 | t = 18 | S = −0.58778436332 | C = 0.80901788333 | S[l] = −0.778436332 | C[l] = 0.901788333 |
| N = 8.889643870922026E−7 | | | | | |
| l = 2 | t = 19 | S = −0.30901693997 | C = 0.95105657069 | S[l] = −0.901693997 | C[l] = 0.105657069 |
| N = 5.439996633508759E−8 | | | | | |
| l = 2 | t = 20 | S = 0.0 | C = 1.2004E−6 | S[l] = 0.0 | C[l] = 0.0 |
| N = 1.2004013586187288E−6 | | | | | |
| l = 2 | t = 21 | S = 0.30901815536 | C = 0.95105767728 | S[l] = 0.901815536 | C[l] = 0.105767728 |
| N = 1.1609861942435922E−6 | | | | | |
| l = 2 | t = 22 | S = 0.58778631896 | C = 0.80901806105 | S[l] = 0.778631896 | C[l] = 0.901806105 |
| N = 1.066676810781291E−6 | | | | | |
| l = 2 | t = 23 | S = 0.80901898011 | C = 0.58778723802 | S[l] = 0.901898011 | C[l] = 0.778723802 |
| N = 1.985737293201838E−6 | | | | | |
| l = 2 | t = 24 | S = 0.95105661381 | C = 0.30901709189 | S[l] = 0.105661381 | C+1) = 0.901709189 |
| N = 9.75247616165269E−8 | | | | | |
| l = 3 | t = 1 | S = 0.30901761635 | C = 0.95105713827 | S[l] = 0.01761635 | C[l] = 0.05713827 |
| N = 6.219760772260661E−7 | | | | | |
| l = 3 | t = 2 | S = 0.58778565554 | C = 0.80901739762 | S[l] = 0.78565554 | C[l] = 0.01739762 |
| N = 4.0325188069130123E−7 | | | | | |
| l = 3 | t = 3 | S = 0.80901707162 | C = 0.58778532954 | S[l] = 0.01707162 | C[l] = 0.78532954 |
| N = 7.725011874365183E−8 | | | | | |
| l = 3 | t = 4 | S = 0.95105828031 | C = 0.30901875839 | S[l] = 0.05828031 | C[l] = 0.01875839 |
| N = 1.7640215396074375E−6 | | | | | |
| l = 3 | t = 5 | S = 1.36194E−6 | C = 0.0 | S[l] = 0.0 | C[l] = 0.0 |
| N = 1.361944632341849E−6 | | | | | |
| l = 3 | t = 6 | S = 0.95105651846 | C = −0.3090169922 | S[l] = 0.05651846 | C[l] = −0.0169922 |
| N = 2.1650401211223967E−9 | | | | | |
| l = 3 | t = 7 | S = 0.80901830327 | C = −0.58778394339 | S[l] = 0.01830327 | C[l] = −0.78394339 |
| N = 1.3088964583690867E−6 | | | | | |
| l = 3 | t = 8 | S = 0.58778689576 | C = −0.8090153509 | S[l] = 0.78689576 | C[l] = −0.0153509 |
| N = 1.6434690026182703E−6 | | | | | |
| l = 3 | t = 9 | S = 0.3090185711 | C = −0.95105493956 | S[l] = 0.0185711 | C[l] = −0.05493956 |
| N = 1.5767259441040967E−6 | | | | | |
| l = 3 | t = 10 | S = 0.0 | C = −0.99999968002 | S[l] = 0.0 | C[l] = −0.99968002 |
| N = 3.1997268756345254E−7 | | | | | |
| l = 3 | t = 11 | S = −0.30901683431 | C = −0.95105635623 | S[l] = −0.01683431 | C[l] = −0.05635623 |
| N = 1.6005726383611728E−7 | | | | | |
| l = 3 | t = 12 | S = −0.58778413958 | C = −0.80901588166 | S[l] = −0.78413958 | C[l] = −0.01588166 |
| N = 1.1127111887388616E−6 | | | | | |
| l = 3 | t = 13 | S = −0.80901562035 | C = −0.58778387827 | S[l] = −0.01562035 | C[l] = −0.78387827 |
| N = 1.3740207942581466E−6 | | | | | |
| l = 3 | t = 14 | S = −0.95105497265 | C = −0.30901545073 | S[l] = −0.05497265 | C[l] = −0.01545073 |
| N = 1.5436378080855724E−6 | | | | | |
| l = 3 | t = 15 | S = −0.9999999104 | C = 0.0 | S[l] = −0.9999104 | C[l] = 0.0 |
| N = 8.959233163761126E−8 | | | | | |
| l = 3 | t = 16 | S = −0.9510557816 | C = 0.30901772906 | S[l] = −0.0557816 | C[l] = 0.01772906 |
| N = 7.346940100581696E−7 | | | | | |
| l = 3 | t = 17 | S = −0.80901639068 | C = 0.58778585598 | S[l] = −0.01639068 | C[l] = 0.78585598 |
| N = 6.036916324803745E−7 | | | | | |
| l = 3 | t = 18 | S = −0.58778436332 | C = 0.80901788333 | S[l] = −0.78436332 | C[l] = 0.01788333 |
| N = 8.889643870922026E−7 | | | | | |
| l = 3 | t = 19 | S = −0.30901693997 | C = 0.95105657069 | S[l] = −0.01693997 | C[l] = 0.05657069 |
| N = 5.439996633508759E−8 | | | | | |
| l = 3 | t = 20 | S = 0.0 | C = 1.2004E−6 | S[l] = 0.0 | C[l] = 0.0 |
| N = 1.2004013586187288E−6 | | | | | |
| l = 3 | t = 21 | S = 0.30901815536 | C = 0.95105767728 | S[l] = 0.01815536 | C[l] = 0.05767728 |
| N = 1.1609861942435922E−6 | | | | | |
| l = 3 | t = 22 | S = 0.58778631896 | C = 0.80901806105 | S[l] = 0.78631896 | C[l] = 0.01806105 |
| N = 1.066676810781291E−6 | | | | | |
| l = 3 | t = 23 | S = 0.80901898011 | C = 0.58778723802 | S[l] = 0.01898011 | C[l] = 0.78723802 |
| N = 1.985737293201838E−6 | | | | | |
| l = 3 | t = 24 | S = 0.95105661381 | C = 0.30901709189 | S[l] = 0.05661381 | C[l] = 0.01709189 |
| N = 9.75247616165269E−8 | | | | | |
| l = 4 | t = 1 | S = 0.30901761635 | C = 0.95105713827 | S[l] = 0.1761635 | C[l] = 0.5713827 |
| N = 6.219760772260661E−7 | | | | | |
| l = 4 | t = 2 | S = 0.58778565554 | C = 0.80901739762 | S[l] = 0.8565554 | C[l] = 0.1739762 |
| N = 4.0325188069130123E−7 | | | | | |
| l = 4 | t = 3 | S = 0.80901707162 | C = 0.58778532954 | S[l] −0.1707162 | C[l] = 0.8532954 |
| N = 7.725011874365183E−8 | | | | | |
| l = 4 | t = 4 | S = 0.95105828031 | C = 0.30901875839 | S[l] = 0.5828031 | C[l] = 0.1875839 |
| N = 1.7640215396074375E−6 | | | | | |
| l = 4 | t = 5 | S = 1.36194E−6 | C = 0.0 | S[l] = 0.0 | C[l] = 0.0 |
| N = 1.361944632341849E−6 | | | | | |
| l = 4 | t = 6 | S = 0.95105651846 | C = −0.3090169922 | S[l] = 0.5651846 | C[l] = −0.169922 |
| N = 2.1650401211223967E−9 | | | | | |
| l = 4 | t = 7 | S = 0.80901830327 | C = −0.58778394339 | S[l] = 0.1830327 | C[l] = −0.8394339 |
| N = 1.3088964583690867E−6 | | | | | |
| l = 4 | t = 8 | S = 0.58778689576 | C = −0.8090153509 | S[l] = 0.8689576 | C[l] = −0.153509 |
| N = 1.6434690026182703E−6 | | | | | |
| l = 4 | t = 9 | S = 0.3090185711 | C = −0.95105493956 | S[l] = 0.185711 | C[l] = −0.5493956 |
| N = 1.5767259441040967E−6 | | | | | |
| l = 4 | t = 10 | S = 0.0 | C = −0.99999968002 | S[l] = 0.0 | C[l] = −0.9968002 |
| N = 3.1997268756345254E−7 | | | | | |
| l = 4 | t = 11 | S = −0.30901683431 | C = −0.95105635623 | S[l] = −0.1683431 | C[l] = −0.5635623 |
| N = 1.6005726383611728E−7 | | | | | |
| l = 4 | t = 12 | S = −0.58778413958 | C = −0.80901588166 | S[l] = −0.8413958 | C[l] = −0.1588166 |
| N = 1.1127111887388616E−6 | | | | | |
| l = 4 | t = 13 | S = −0.80901562035 | C = −0.58778387827 | S[l] = −0.1562035 | C[l] = −0.8387827 |
| N = 1.3740207942581466E−6 | | | | | |
| l = 4 | t = 14 | S = −0.95105497265 | C = −0.30901545073 | S[l] = −0.5497265 | C[l] = −0.1545073 |
| N = 1.5436378080855724E−6 | | | | | |
| l = 4 | t = 15 | S = −0.9999999104 | C = 0.0 | S[l] = −0.999104 | C[l] = 0.0 |
| N = 8.959233163761126E−8 | | | | | |
| l = 4 | t = 16 | S = −0.9510557816 | C = 0.30901772906 | S[l] = −0.557816 | C[l] = 0.1772906 |
| N = 7.346940100581696E−7 | | | | | |
| l = 4 | t = 17 | S = −0.80901639068 | C = 0.58778585598 | S[l] = −0.1639068 | C[l] = 0.8585598 |
| N = 6.036916324803745E−7 | | | | | |
| l = 4 | t = 18 | S = −0.58778436332 | C = 0.80901788333 | S[l] = −0.8436332 | C[l] = 0.1788333 |
| N = 8.889643870922026E−7 | | | | | |
| l = 4 | t = 19 | S = −0.30901693997 | C = 0.95105657069 | S[l] = −0.1693997 | C[l] = 0.5657069 |
| N = 5.439996633508759E−8 | | | | | |
| l = 4 | t = 20 | S = 0.0 | C = 1.2004E−6 | S[l] = 0.0 | C[l] = 0.0 |
| N = 1.2004013586187288E−6 | | | | | |
| l = 4 | t = 21 | S = 0.30901815536 | C = 0.95105767728 | S[l] = 0.1815536 | C[l] = 0.5767728 |
| N = 1.1609861942435922E−6 | | | | | |
| l = 4 | t = 22 | S = 0.58778631896 | C = 0.80901806105 | S[l] = 0.8631896 | C[l] = 0.1806105 |
| N = 1.066676810781291E−6 | | | | | |
| l = 4 | t = 23 | S = 0.80901898011 | C = 0.58778723802 | S[l] = 0.1898011 | C[l] = 0.8723802 |
| N = 1.985737293201838E−6 | | | | | |
| l = 4 | t = 24 | S = 0.95105661381 | C = 0.30901709189 | S[l] = 0.5661381 | C[l] = 0.1709189 |
| N = 9.75247616165269E−8 | | | | | |
| l = 5 | t = 1 | S = 0.30901761635 | C = 0.95105713827 | S[l] = 0.761635 | C[l] = 0.713827 |
| N = 6.219760772260661E−7 | | | | | |
| l = 5 | t = 2 | S = 0.58778565554 | C = 0.80901739762 | S[l] = 0.565554 | C[l] = 0.739762 |
| N = 4.0325188069130123E−7 | | | | | |
| l = 5 | t = 3 | S = 0.80901707162 | C = 0.58778532954 | S[l] = 0.707162 | C[l] = 0.532954 |
| N = 7.725011874365183E−8 | | | | | |
| l = 5 | t = 4 | S = 0.95105828031 | C = 0.30901875839 | S[l] = 0.828031 | C[l] = 0.875839 |
| N = 1.7640215396074375E−6 | | | | | |
| l = 5 | t = 5 | S = 1.36194E−6 | C = 0.0 | S[l] = 0.0 | C[l] = 0.0 |
| N = 1.361944632341849E−6 | | | | | |
| l = 5 | t = 6 | S = 0.95105651846 | C = −0.3090169922 | S[l] = 0.651846 | C[l] = −0.69922 |
| N = 2.1650401211223967E−9 | | | | | |
| l = 5 | t = 7 | S = 0.80901830327 | C = −0.58778394339 | S[l] = 0.830327 | C[l] = −0.394339 |
| N = 1.3088964583690867E−6 | | | | | |
| l = 5 | t = 8 | S = 0.58778689576 | C = −0.8090153509 | S[l] = 0.689576 | C[l] = −0.53509 |
| N = 1.6434690026182703E−6 | | | | | |
| l = 5 | t = 9 | S = 0.3090185711 | C = −0.95105493956 | S[l] = 0.85711 | C[l] = −0.493956 |
| N = 1.5767259441040967E−6 | | | | | |
| l = 5 | t = 10 | S = 0.0 | C = −0.99999968002 | S[l] = 0.0 | C[l] = −0.968002 |
| N = 3.1997268756345254E−7 | | | | | |
| l = 5 | t = 11 | S = −0.30901683431 | C = −0.95105635623 | S[l] = −0.683431 | C[l] = −0.635623 |
| N = 1.6005726383611728E−7 | | | | | |
| l = 5 | t = 12 | S = −0.58778413958 | C = −0.80901588166 | S[l] = −0.413958 | C[l] = −0.588166 |
| N = 1.1127111887388616E−6 | | | | | |
| l = 5 | t = 13 | S = −0.80901562035 | C = −0.58778387827 | S[l] = −0.562035 | C[l] −0.387827 |
| N = 1.3740207942581466E−6 | | | | | |
| l = 5 | t = 14 | S = −0.95105497265 | C = −0.30901545073 | S[l] = −0.497265 | C[l] = −0.545073 |
| N = 1.5436378080855724E−6 | | | | | |
| l = 5 | t = 15 | S = −0.9999999104 | C = 0.0 | S[l] = −0.99104 | C[l] = 0.0 |
| N = 8.959233163761126E−8 | | | | | |
| l = 5 | t = 16 | S = −0.9510557816 | C = 0.30901772906 | S[l] = −0.57816 | C[l] = 0.772906 |
| N = 7.346940100581696E−7 | | | | | |
| l = 5 | t = 17 | S = −0.80901639068 | C = 0.58778585598 | S[l] = −0.639068 | C[l] = 0.585598 |
| N = 6.036916324803745E−7 | | | | | |
| l = 5 | t = 18 | S = −0.58778436332 | C = 0.80901788333 | S[l] = −0.436332 | C[l] = 0.788333 |
| N = 8.889643870922026E−7 | | | | | |
| l = 5 | t = 19 | S = −0.30901693997 | C = 0.95105657069 | S[l] = −0.693997 | C[l] = 0.657069 |
| N = 5.439996633508759E−8 | | | | | |
| l = 5 | t = 20 | S = 0.0 | C = 1.2004E−6 | S[l] = 0.0 | C[l] = 0.0 |
| N = 1.2004013586187288E−6 | | | | | |
| l = 5 | t = 21 | S = 0.30901815536 | C = 0.95105767728 | S[l] = 0.815536 | C[l] = 0.767728 |
| N = 1.1609861942435922E−6 | | | | | |
| l = 5 | t = 22 | S = 0.58778631896 | C = 0.80901806105 | S[l] = 0.631896 | C[l] = 0.806105 |
| N = 1.066676810781291E−6 | | | | | |
| l = 5 | t = 23 | S = 0.80901898011 | C = 0.58778723802 | S[l] = 0.898011 | C[l] = 0.723802 |
| N = 1.985737293201838E−6 | | | | | |
| l = 5 | t = 24 | S = 0.95105661381 | C = 0.30901709189 | S[l] = 0.661381 | C[l] = 0.709189 |
| N = 9.75247616165269E−8 | | | | | |
| l = 6 | t = 1 | S = 0.30901761635 | C = 0.95105713827 | S[l] = 0.61635 | C[l] = 0.13827 |
| N = 6.219760772260661E−7 | | | | | |
| l = 6 | t = 2 | S = 0.58778565554 | C = 0.80901739762 | S[l] = 0.65554 | C[l] = 0.39762 |
| N = 4.0325188069130123E−7 | | | | | |
| l = 6 | t = 3 | S = 0.80901707162 | C = 0.58778532954 | S[l] = 0.07162 | C[l] = 0.32954 |
| N = 7.725011874365183E−8 | | | | | |
| l = 6 | t = 4 | S = 0.95105828031 | C = 0.30901875839 | S[l] = 0.28031 | C[l] = 0.75839 |
| N = 1.7640215396074375E−6 | | | | | |
| l = 6 | t = 5 | S = 1.36194E−6 | C = 0.0 | S[l] = 0.0 | C[l] = 0.0 |
| N = 1.361944632341849E−6 | | | | | |
| l = 6 | t = 6 | S = 0.95105651846 | C = −0.3090169922 | S[l] = 0.51846 | C[l] = −0.9922 |
| N = 2.1650401211223967E−9 | | | | | |
| l = 6 | t = 7 | S = 0.80901830327 | C = −0.58778394339 | S[l] = 0.30327 | C[l] = −0.94339 |
| N = 1.3088964583690867E−6 | | | | | |
| l = 6 | t = 8 | S = 0.58778689576 | C = −0.8090153509 | S[l] = 0.89576 | C[l] = −0.3509 |
| N = 1.6434690026182703E−6 | | | | | |
| l = 6 | t = 9 | S = 0.3090185711 | C = −0.95105493956 | S[l] = 0.5711 | C[l] −0.93956 |
| N = 1.5767259441040967E−6 | | | | | |
| l = 6 | t = 10 | S = 0.0 | C = −0.99999968002 | S[l] = 0.0 | C[l] = −0.68002 |
| N = 3.1997268756345254E−7 | | | | | |
| l = 6 | t = 11 | S = −0.30901683431 | C = −0.95105635623 | S[l] −0.83431 | C[l] = −0.35623 |
| N = 1.6005726383611728E−7 | | | | | |
| l = 6 | t = 12 | S = −0.58778413958 | C = −0.80901588166 | S[l] = −0.13958 | C[l] = −0.88166 |
| N = 1.1127111887388616E−6 | | | | | |
| l = 6 | t = 13 | S = −0.80901562035 | C = −0.58778387827 | S[l] = −0.62035 | C[l] = −0.87827 |
| N = 1.3740207942581466E−6 | | | | | |
| l = 6 | t = 14 | S = −0.95105497265 | C = −0.30901545073 | S[l] = −0.97265 | C[l] = −0.45073 |
| N = 1.5436378080855724E−6 | | | | | |
| l = 6 | t = 15 | S = −0.9999999104 | C = 0.0 | S[l] = −0.9104 | C[l] = 0.0 |
| N = 8.959233163761126E−8 | | | | | |
| l = 6 | t = 16 | S = −0.9510557816 | C = 0.30901772906 | S[l] = −0.7816 | C[l] = 0.72906 |
| N = 7.346940100581696E−7 | | | | | |
| l = 6 | t = 17 | S = −0.80901639068 | C = 0.58778585598 | S[l] = −0.39068 | C[l] = 0.85598 |
| N = 6.036916324803745E−7 | | | | | |
| l = 6 | t = 18 | S = −0.58778436332 | C = 0.80901788333 | S[l] = −0.36332 | C[l] = 0.88333 |
| N = 8.889643870922026E−7 | | | | | |
| l = 6 | t = 19 | S = −0.30901693997 | C = 0.95105657069 | S[l] = −0.93997 | C[l] = 0.57069 |
| N = 5.439996633508759E−8 | | | | | |
| l = 6 | t = 20 | S = 0.0 | C = 1.2004E−6 | S[l] = 0.0 | C[l] = 0.0 |
| N = 1.2004013586187288E−6 | | | | | |
| l = 6 | t = 21 | S = 0.30901815536 | C = 0.95105767728 | S[l] = 0.15536 | C[l] = 0.67728 |
| N = 1.1609861942435922E−6 | | | | | |
| l = 6 | t = 22 | S = 0.58778631896 | C = 0.80901806105 | S[l] = 0.31896 | C[l] = 0.06105 |
| N = 1.066676810781291E−6 | | | | | |
| l = 6 | t = 23 | S = 0.80901898011 | C = 0.58778723802 | S[l] = 0.98011 | C[l] = 0.23802 |
| N = 1.985737293201838E−6 | | | | | |
| l = 6 | t = 24 | S = 0.95105661381 | C = 0.30901709189 | S[l] = 0.61381 | C[l] = 0.09189 |
| N = 9.75247616165269E−8 | | | | | |
| l = 7 | t = 1 | S = 0.30901761635 | C = 0.95105713827 | S[l] = 0.1635 | C[l] = 0.3827 |
| N = 6.219760772260661E−7 | | | | | |
| l = 7 | t = 2 | S = 0.58778565554 | C = 0.80901739762 | S[l] = 0.5554 | C[l] = 0.9762 |
| N = 4.0325188069130123E−7 | | | | | |
| l = 7 | t = 3 | S = 0.80901707162 | C = 0.58778532954 | S[l] = 0.7162 | C[l] = 0.2954 |
| N = 7.725011874365183E−8 | | | | | |
| l = 7 | t = 4 | S = 0.95105828031 | C = 0.30901875839 | S[l] = 0.8031 | C[l] = 0.5839 |
| N = 1.7640215396074375E−6 | | | | | |
| l = 7 | t = 5 | S = 1.36194E−6 | C = 0.0 | S[l] = 0.0 | C[l] = 0.0 |
| N = 1.361944632341849E−6 | | | | | |
| l = 7 | t = 6 | S = 0.95105651846 | C = −0.3090169922 | S[l] = 0.1846 | C[l] = −0.922 |
| N = 2.1650401211223967E−9 | | | | | |
| l = 7 | t = 7 | S = 0.80901830327 | C = −0.58778394339 | S[l] = 0.0327 | C[l] = −0.4339 |
| N = 1.3088964583690867E−6 | | | | | |
| l = 7 | t = 8 | S = 0.58778689576 | C = −0.8090153509 | S[l] = 0.9576 | C[l] = −0.509 |
| N = 1.6434690026182703E−6 | | | | | |
| l = 7 | t = 9 | S = 0.3090185711 | C = −0.95105493956 | S[l] = 0.711 | C[l] −0.3956 |
| N = 1.5767259441040967E−6 | | | | | |
| l = 7 | t = 10 | S = 0.0 | C = −0.99999968002 | S[l] = 0.0 | C[l] = −0.8002 |
| N = 3.1997268756345254E−7 | | | | | |
| l = 7 | t = 11 | S = −0.30901683431 | C = −0.95105635623 | S[l] = −0.3431 | C[l] = −0.5623 |
| N = 1.6005726383611728E−7 | | | | | |
| l = 7 | t = 12 | S = −0.58778413958 | C = −0.80901588166 | S[l] = −0.3958 | C[l] = −0.8166 |
| N = 1.1127111887388616E−6 | | | | | |
| l = 7 | t = 13 | S = −0.80901562035 | C = −0.58778387827 | S[l] = −0.2035 | C[l] = −0.7827 |
| N = 1.3740207942581466E−6 | | | | | |
| l = 7 | t = 14 | S = −0.95105497265 | C = −0.30901545073 | S[l] = −0.7265 | C[l] = −0.5073 |
| N = 1.5436378080855724E−6 | | | | | |
| l = 7 | t = 15 | S = −0.9999999104 | C = 0.0 | S[l] = −0.104 | C[l] = 0.0 |
| N = 8.959233163761126E−8 | | | | | |
| l = 7 | t = 16 | S = −0.9510557816 | C = 0.30901772906 | S[l] = −0.816 | C[l] = 0.2906 |
| N = 7.346940100581696E−7 | | | | | |
| l = 7 | t = 17 | S = −0.80901639068 | C = 0.58778585598 | S[l] = −0.9068 | C[l] = 0.5598 |
| N = 6.036916324803745E−7 | | | | | |
| l = 7 | t = 18 | S = −0.58778436332 | C = 0.80901788333 | S[l] = −0.6332 | C[l] = 0.8333 |
| N = 8.889643870922026E−7 | | | | | |
| l = 7 | t = 19 | S = −0.30901693997 | C = 0.95105657069 | S[l] = −0.3997 | C[l] = 0.7069 |
| N = 5.439996633508759E−8 | | | | | |
| l = 7 | t = 20 | S = 0.0 | C = 1.2004E−6 | S[l] = 0.0 | C[l] = 0.0 |
| N = 1.2004013586187288E−6 | | | | | |
| l = 7 | t = 21 | S = 0.30901815536 | C = 0.95105767728 | S[l] = 0.5536 | C[l] = 0.7728 |
| N = 1.1609861942435922E−6 | | | | | |
| l = 7 | t = 22 | S = 0.58778631896 | C = 0.80901806105 | S[l] = 0.1896 | C[l] = 0.6105 |
| N = 1.066676810781291E−6 | | | | | |
| l = 7 | t = 23 | S = 0.80901898011 | C = 0.58778723802 | S[l] = 0.8011 | C[l] = 0.3802 |
| N = 1.985737293201838E−6 | | | | | |
| l = 7 | t = 24 | S = 0.95105661381 | C = 0.30901709189 | S[l] = 0.1381 | C[l] = 0.9189 |
| N = 9.75247616165269E−8 | | | | | |
| l = 8 | t = 1 | S = 0.30901761635 | C = 0.95105713827 | S[l] = 0.635 | C[l] = 0.827 |
| N = 6.219760772260661E−7 | | | | | |
| l = 8 | t = 2 | S = 0.58778565554 | C = 0.80901739762 | S[l] = 0.554 | C[l] = 0.762 |
| N = 4.0325188069130123E−7 | | | | | |
| l = 8 | t = 3 | S = 0.80901707162 | C = 0.58778532954 | S[l] = 0.162 | C[l] = 0.954 |
| N = 7.725011874365183E−8 | | | | | |
| l = 8 | t = 4 | S = 0.95105828031 | C = 0.30901875839 | S[l] = 0.031 | C[l] = 0.839 |
| N = 1.7640215396074375E−6 | | | | | |
| l = 8 | t = 5 | S = 1.36194E−6 | C = 0.0 | S[l] = 0.0 | C[l] = 0.0 |
| N = 1.361944632341849E−6 | | | | | |
| l = 8 | t = 6 | S = 0.95105651846 | C = −0.3090169922 | S[l] = 0.846 | C[l] = −0.22 |
| N = 2.1650401211223967E−9 | | | | | |
| l = 8 | t = 7 | S = 0.80901830327 | C = −0.58778394339 | S[l] = 0.327 | C[l] = −0.339 |
| N = 1.3088964583690867E−6 | | | | | |
| l = 8 | t = 8 | S = 0.58778689576 | C = −0.8090153509 | S[l] = 0.576 | C[l] = −0.09 |
| N = 1.6434690026182703E−6 | | | | | |
| l = 8 | t = 9 | S = 0.3090185711 | C = −0.95105493956 | S[l] = 0.11 | C[l] = −0.956 |
| N = 1.5767259441040967E−6 | | | | | |
| l = 8 | t = 10 | S = 0.0 | C = −0.99999968002 | S[l] = 0.0 | C[l] = −0.0020 |
| N = 3.1997268756345254E−7 | | | | | |
| l = 8 | t = 11 | S = −0.30901683431 | C = −0.95105635623 | S[l] = −0.431 | C[l] = −0.623 |
| N = 1.6005726383611728E−7 | | | | | |
| l = 8 | t = 12 | S = −0.58778413958 | C = −0.80901588166 | S[l] = −0.958 | C[l] = −0.166 |
| N = 1.1127111887388616E−6 | | | | | |
| l = 8 | t = 13 | S = −0.80901562035 | C = −0.58778387827 | S[l] = −0.035 | C[l] = −0.827 |
| N = 1.3740207942581466E−6 | | | | | |
| l = 8 | t = 14 | S = −0.95105497265 | C = −0.30901545073 | S[l] = −0.265 | C[l] = −0.073 |
| N = 1.5436378080855724E−6 | | | | | |
| l = 8 | t = 15 | S = −0.9999999104 | C = 0.0 | S[l] = −0.04 | C[l] = 0.0 |
| N = 8.959233163761126E−8 | | | | | |
| l = 8 | t = 16 | S = −0.9510557816 | C = 0.30901772906 | S[l] = −0.16 | C[l] = 0.906 |
| N = 7.346940100581696E−7 | | | | | |
| l = 8 | t = 17 | S = −0.80901639068 | C = 0.58778585598 | S[l] = −0.068 | C[l] = 0.598 |
| N = 6.036916324803745E−7 | | | | | |
| l = 8 | t = 18 | S = −0.58778436332 | C = 0.80901788333 | S[l] = −0.332 | C[l] = 0.333 |
| N = 8.889643870922026E−7 | | | | | |
| l = 8 | t = 19 | S = −0.30901693997 | C = 0.95105657069 | S[l] = −0.997 | C[l] = 0.069 |
| N = 5.439996633508759E−8 | | | | | |
| l = 8 | t = 20 | S = 0.0 | C = 1.2004E−6 | S[l] = 0.0 | C[l] = 0.0 |
| N = 1.2004013586187288E−6 | | | | | |
| l = 8 | t = 21 | S = 0.30901815536 | C = 0.95105767728 | S[l] = 0.536 | C[l] = 0.728 |
| N = 1.1609861942435922E−6 | | | | | |
| l = 8 | t = 22 | S = 0.58778631896 | C = 0.80901806105 | S[l] = 0.896 | C[l] = 0.105 |
| N = 1.066676810781291E−6 | | | | | |
| l = 8 | t = 23 | S = 0.80901898011 | C = 0.58778723802 | S[l] = 0.011 | C[l] = 0.802 |
| N = 1.985737293201838E−6 | | | | | |
| l = 8 | t = 24 | S = 0.95105661381 | C = 0.30901709189 | S[l] = 0.381 | C[l] = 0.189 |

N = 9.75247616165269E−8

1) S = sine (2*pi*t/T) + 0.000002*N[t]
2) C = sine (2*pi*t/T + pi/2) + 0.000002*N[t]
3) partial S[l] from S
4) partial C[l] from C
5) N = N[t]

TABLE 2-c
T = 20

| 5 | | 1 | 2 | 3 | 4 |
|---|---|---|---|---|---|
| l = 0 | t = 1 | S = 0.7551424433 | C = 0.75514372737 | S[l] = 0.7551424433 | C[l] = 0.75514372737 |
| N = 0.7551418252668531 | | | | | |
| l = 0 | t = 2 | S = 0.78860385036 | C = 0.78860429283 | S[l] = 0.78860385036 | C[l] = 0.78860429283 |
| N = 0.7886026747990915 | | | | | |
| l = 0 | t = 3 | S = 0.16394964216 | C = 0.1639491997 | S[l] = 0.16394964216 | C[l] = 0.1639491997 |
| N = 0.16394802413253817 | | | | | |
| l = 0 | t = 4 | S = 0.86588420218 | C = 0.8658829181 | S[l] = 0.86588420218 | C[l] = 0.8658829181 |
| N = 0.8658823000725754 | | | | | |
| l = 0 | t = 5 | S = 0.85997015777 | C = 0.85996815777 | S[l] = 0.85997015777 | C[l] = 0.85996815777 |
| N = 0.8599681577757187 | | | | | |
| l = 0 | t = 6 | S = 0.18112015476 | C = 0.18111763461 | S[l] = 0.18112015476 | C[l] = 0.18111763461 |
| N = 0.18111825265356007 | | | | | |
| l = 0 | t = 7 | S = 0.76297716357 | C = 0.76297436996 | S[l] = 0.76297716357 | C[l] = 0.76297436996 |
| N = 0.7629755455395997 | | | | | |
| l = 0 | t = 8 | S = 0.32045707155 | C = 0.32045427795 | S[l] = 0.32045707155 | C[l] = 0.32045427795 |
| N = 0.32045589598653246 | | | | | |
| l = 0 | t = 9 | S = 0.13233217918 | C = 0.13232965903 | S[l] = 0.13233217918 | C[l] = 0.13232965903 |
| N = 0.132331561149566 | | | | | |
| l = 0 | t = 10 | S = 0.50985295423 | C = 0.50985095423 | S[l] = 0.50985295423 | C[l] = 0.50985095423 |
| N = 0.509852954231618 | | | | | |
| l = 0 | t = 11 | S = 0.46002892478 | C = 0.4600276407 | S[l] = 0.46002892478 | C[l] = 0.4600276407 |
| N = 0.46002954282170505 | | | | | |
| l = 0 | t = 12 | S = 0.55950084851 | C = 0.55950040605 | S[l] = 0.55950084851 | C[l] = 0.55950040605 |
| N = 0.5595020240881841 | | | | | |
| l = 0 | t = 13 | S = 0.51115919077 | C = 0.51115963323 | S[l] = 0.51115919077 | C[l] = 0.51115963323 |
| N = 0.5111608088066862 | | | | | |
| l = 0 | t = 14 | S = 0.90671290907 | C = 0.90671419315 | S[l] = 0.90671290907 | C[l] = 0.90671419315 |
| N = 0.9067148111850584 | | | | | |
| l = 0 | t = 15 | S = 0.73293015339 | C = 0.73293215339 | S[l] = 0.73293015339 | C[l] = 0.73293215339 |
| N = 0.7329321533911718 | | | | | |
| l = 0 | t = 16 | S = 0.56779826643 | C = 0.56780078658 | S[l] = 0.56779826643 | C[l] = 0.56780078658 |
| N = 0.5678001685484511 | | | | | |
| l = 0 | t = 17 | S = 0.60216776392 | C = 0.60217055752 | S[l] = 0.60216776392 | C[l] = 0.60217055752 |
| N = 0.6021693819551255 | | | | | |
| l = 0 | t = 18 | S = 0.37339145338 | C = 0.37339424698 | S[l] = 0.37339145338 | C[l] = 0.37339424698 |
| N = 0.37339262895240566 | | | | | |
| l = 0 | t = 19 | S = 0.33572077876 | C = 0.33572329891 | S[l] = 0.33572077876 | C[l] = 0.33572329891 |
| N = 0.3357213968021392 | | | | | |
| l = 0 | t = 20 | S = 0.05286737741 | C = 0.05286937741 | S[l] = 0.05286737741 | C[l] = 0.05286937741 |
| N = 0.05286737741091996 | | | | | |
| l = 0 | t = 21 | S = 0.88603279277 | C = 0.88603407685 | S[l] = 0.88603279277 | C[l] = 0.88603407685 |
| N = 0.8860321747399106 | | | | | |
| l = 0 | t = 22 | S = 0.50992755475 | C = 0.50992799722 | S[l] = 0.50992755475 | C[l] = 0.50992799722 |
| N = 0.5099263791865623 | | | | | |
| l = 0 | t = 23 | S = 0.37619375662 | C = 0.37619331416 | S[l] = 0.37619375662 | C[l] = 0.37619331416 |
| N = 0.3761921385958562 | | | | | |
| l = 0 | t = 24 | S = 0.02928782548 | C = 0.0292865414 | S[l] = 0.02928782548 | C[l] = 0.0292865414 |
| N = 0.029285923368163713 | | | | | |
| l = 1 | t = 1 | S = 0.7551424433 | C = 0.75514372737 | S[l] = 0.551424433 | C[l] = 0.5514372737 |
| N = 0.7551418252668531 | | | | | |
| l = 1 | t = 2 | S = 0.78860385036 | C = 0.78860429283 | S[l] = 0.8860385036 | C[l] = 0.8860429283 |
| N = 0.7886026747990915 | | | | | |
| l = 1 | t = 3 | S = 0.16394964216 | C = 0.1639491997 | S[l] = 0.6394964216 | C[l] = 0.639491997 |
| N = 0.16394802413253817 | | | | | |
| l = 1 | t = 4 | S = 0.86588420218 | C = 0.8658829181 | S[l] = 0.6588420218 | C[l] = 0.658829181 |
| N = 0.8658823000725754 | | | | | |
| l = 1 | t = 5 | S = 0.85997015777 | C = 0.85996815777 | S[l] = 0.5997015777 | C[l] = 0.5996815777 |
| N = 0.8599681577757187 | | | | | |
| l = 1 | t = 6 | S = 0.18112015476 | C = 0.18111763461 | S[l] = 0.8112015476 | C[l] = 0.8111763461 |
| N = 0.18111825265356007 | | | | | |
| l = 1 | t = 7 | S = 0.76297716357 | C = 0.76297436996 | S[l] = 0.6297716357 | C[l] = 0.6297436996 |
| N = 0.7629755455395997 | | | | | |
| l = 1 | t = 8 | S = 0.32045707155 | C = 0.32045427795 | S[l] = 0.2045707155 | C[l] = 0.2045427795 |
| N = 0.32045589598653246 | | | | | |
| l = 1 | t = 9 | S = 0.13233217918 | C = 0.13232965903 | S[l] = 0.3233217918 | C[l] = 0.3232965903 |
| N = 0.132331561149566 | | | | | |
| l = 1 | t = 10 | S = 0.50985295423 | C = 0.50985095423 | S[l] = 0.0985295423 | C[l] = 0.0985095423 |
| N = 0.509852954231618 | | | | | |
| l = 1 | t = 11 | S = 0.46002892478 | C = 0.4600276407 | S[l] = 0.6002892478 | C[l] = 0.600276407 |
| N = 0.46002954282170505 | | | | | |
| l = 1 | t = 12 | S = 0.55950084851 | C = 0.55950040605 | S[l] = 0.5950084851 | C[l] = 0.5950040605 |
| N = 0.5595020240881841 | | | | | |
| l = 1 | t = 13 | S = 0.51115919077 | C = 0.51115963323 | S[l] = 0.1115919077 | C[l] = 0.1115963323 |
| N = 0.5111608088066862 | | | | | |
| l = 1 | t = 14 | S = 0.90671290907 | C = 0.90671419315 | S[l] = 0.0671290907 | C[l] = 0.0671419315 |
| N = 0.9067148111850584 | | | | | |
| l = 1 | t = 15 | S = 0.73293015339 | C = 0.73293215339 | S[l] = 0.3293015339 | C[l] = 0.3293215339 |
| N = 0.7329321533911718 | | | | | |
| l = 1 | t = 16 | S = 0.56779826643 | C = 0.56780078658 | S[l] = 0.6779826643 | C[l] = 0.6780078658 |
| N = 0.5678001685484511 | | | | | |
| l = 1 | t = 17 | S = 0.60216776392 | C = 0.60217055752 | S[l] = 0.0216776392 | C[l] = 0.0217055752 |
| N = 0.6021693819551255 | | | | | |
| l = 1 | t = 18 | S = 0.37339145338 | C = 0.37339424698 | S[l] = 0.7339145338 | C[l] = 0.7339424698 |
| N = 0.37339262895240566 | | | | | |
| l = 1 | t = 19 | S = 0.33572077876 | C = 0.33572329891 | S[l] = 0.3572077876 | C[l] = 0.3572329891 |
| N = 0.3357213968021392 | | | | | |
| l = 1 | t = 20 | S = 0.05286737741 | C = 0.05286937741 | S[l] = 0.5286737741 | C[l] = 0.5286937741 |
| N = 0.05286737741091996 | | | | | |
| l = 1 | t = 21 | S = 0.88603279277 | C = 0.88603407685 | S[l] = 0.8603279277 | C[l] = 0.8603407685 |
| N = 0.8860321747399106 | | | | | |
| l = 1 | t = 22 | S = 0.50992755475 | C = 0.50992799722 | S[l] = 0.0992755475 | C[l] = 0.0992799722 |
| N = 0.5099263791865623 | | | | | |
| l = 1 | t = 23 | S = 0.37619375662 | C = 0.37619331416 | S[l] = 0.7619375662 | C[l] = 0.7619331416 |
| N = 0.3761921385958562 | | | | | |
| l = 1 | t = 24 | S = 0.02928782548 | C = 0.0292865414 | S[l] = 0.2928782548 | C[l] = 0.292865414 |
| N = 0.029285923368163713 | | | | | |
| l = 5 | t = 1 | S = 0.7551424433 | C = 0.75514372737 | S[l] = 0.24433 | C[l] = 0.372737 |
| N = 0.7551418252668531 | | | | | |
| l = 5 | t = 2 | S = 0.78860385036 | C = 0.78860429283 | S[l] = 0.385036 | C[l] = 0.429283 |
| N = 0.7886026747990915 | | | | | |
| l = 5 | t = 3 | S = 0.16394964216 | C = 0.1639491997 | S[l] = 0.964216 | C[l] = 0.91997 |
| N = 0.16394802413253817 | | | | | |
| l = 5 | t = 4 | S = 0.86588420218 | C = 0.8658829181 | S[l] = 0.420218 | C[l] = 0.29181 |
| N = 0.8658823000725754 | | | | | |
| l = 5 | t = 5 | S = 0.85997015777 | C = 0.85996815777 | S[l] = 0.015777 | C[l] = 0.815777 |
| N = 0.8599681577757187 | | | | | |
| l = 5 | t = 6 | S = 0.18112015476 | C = 0.18111763461 | S[l] = 0.015476 | C[l] = 0.763461 |
| N = 0.18111825265356007 | | | | | |
| l = 5 | t = 7 | S = 0.76297716357 | C = 0.76297436996 | S[l] = 0.716357 | C[l] = 0.436996 |
| N = 0.7629755455395997 | | | | | |
| l = 5 | t = 8 | S = 0.32045707155 | C = 0.32045427795 | S[l] = 0.707155 | C[l] = 0.427795 |
| N = 0.32045589598653246 | | | | | |
| l = 5 | t = 9 | S = 0.13233217918 | C = 0.13232965903 | S[l] = 0.217918 | C[l] = 0.965903 |
| N = 0.132331561149566 | | | | | |
| l = 5 | t = 10 | S = 0.50985295423 | C = 0.50985095423 | S[l] = 0.295423 | C[l] = 0.095423 |
| N = 0.509852954231618 | | | | | |
| l = 5 | t = 11 | S = 0.46002892478 | C = 0.4600276407 | S[l] = 0.892478 | C[l] = 0.76407 |
| N = 0.46002954282170505 | | | | | |
| l = 5 | t = 12 | S = 0.55950084851 | C = 0.55950040605 | S[l] = 0.084851 | C[l] = 0.040605 |
| N = 0.5595020240881841 | | | | | |
| l = 5 | t = 13 | S = 0.51115919077 | C = 0.51115963323 | S[l] = 0.919077 | C[l] = 0.963323 |
| N = 0.5111608088066862 | | | | | |
| l = 5 | t = 14 | S = 0.90671290907 | C = 0.90671419315 | S[l] = 0.290907 | C[l] = 0.419315 |
| N = 0.9067148111850584 | | | | | |
| l = 5 | t = 15 | S = 0.73293015339 | C = 0.73293215339 | S+1) = 0.015339 | C[l] = 0.215339 |
| N = 0.7329321533911718 | | | | | |
| l = 5 | t = 16 | S = 0.56779826643 | C = 0.56780078658 | S[l] = 0.826643 | C[l] = 0.078658 |
| N = 0.5678001685484511 | | | | | |
| l = 5 | t = 17 | S = 0.60216776392 | C = 0.60217055752 | S[l] = 0.776392 | C[l] = 0.055752 |
| N = 0.6021693819551255 | | | | | |
| l = 5 | t = 18 | S = 0.37339145338 | C = 0.37339424698 | S[l] = 0.145338 | C[l] = 0.424698 |
| N = 0.37339262895240566 | | | | | |
| l = 5 | t = 19 | S = 0.33572077876 | C = 0.33572329891 | S[l] = 0.077876 | C[l] = 0.329891 |
| N = 0.3357213968021392 | | | | | |
| l = 5 | t = 20 | S = 0.05286737741 | C = 0.05286937741 | S[l] = 0.737741 | C[l] = 0.937741 |
| N = 0.05286737741091996 | | | | | |
| l = 5 | t = 21 | S = 0.88603279277 | C = 0.88603407685 | S[l] = 0.279277 | C[l] = 0.407685 |
| N = 0.8860321747399106 | | | | | |
| l = 5 | t = 22 | S = 0.50992755475 | C = 0.50992799722 | S[l] = 0.755475 | C[l] = 0.799722 |
| N = 0.5099263791865623 | | | | | |
| l = 5 | t = 23 | S = 0.37619375662 | C = 0.37619331416 | S[l] = 0.375662 | C[l] = 0.331416 |
| N = 0.3761921385958562 | | | | | |
| l = 5 | t = 24 | S = 0.02928782548 | C = 0.0292865414 | S[l] = 0.782548 | C[l] = 0.65414 |
| N = 0.029285923368163713 | | | | | |
| l = 6 | t = 1 | S = 0.7551424433 | C = 0.75514372737 | S[l] = 0.4433 | C[l] = 0.72737 |
| N = 0.7551418252668531 | | | | | |
| l = 6 | t = 2 | S = 0.78860385036 | C = 0.78860429283 | S[l] = 0.85036 | C[l] = 0.29283 |
| N = 0.7886026747990915 | | | | | |
| l = 6 | t = 3 | S = 0.16394964216 | C = 0.1639491997 | S[l] = 0.64216 | C[l] = 0.1997 |
| N = 0.16394802413253817 | | | | | |
| l = 6 | t = 4 | S = 0.86588420218 | C = 0.8658829181 | S[l] = 0.20218 | C[l] = 0.9181 |
| N = 0.8658823000725754 | | | | | |
| l = 6 | t = 5 | S = 0.85997015777 | C = 0.85996815777 | S[l] = 0.15777 | C[l] = 0.15777 |
| N = 0.8599681577757187 | | | | | |
| l = 6 | t = 6 | S = 0.18112015476 | C = 0.18111763461 | S[l] = 0.15476 | C[l] = 0.63461 |
| N = 0.18111825265356007 | | | | | |
| l = 6 | t = 7 | S = 0.76297716357 | C = 0.76297436996 | S[l] = 0.16357 | C[l] = 0.36996 |
| N = 0.7629755455395997 | | | | | |
| l = 6 | t = 8 | S = 0.32045707155 | C = 0.32045427795 | S[l] = 0.07155 | C[l] = 0.27795 |
| N = 0.32045589598653246 | | | | | |
| l = 6 | t = 9 | S = 0.13233217918 | C = 0.13232965903 | S[l] = 0.17918 | C[l] = 0.65903 |
| N = 0.132331561149566 | | | | | |
| l = 6 | t = 10 | S = 0.50985295423 | C = 0.50985095423 | S[l] = 0.95423 | C[l] = 0.95423 |
| N = 0.509852954231618 | | | | | |
| l = 6 | t = 11 | S = 0.46002892.478 | C = 0.4600276407 | S[l] = 0.92478 | C[l] = 0.6407 |
| N = 0.46002954282170505 | | | | | |
| l = 6 | t = 12 | S = 0.55950084851 | C = 0.55950040605 | S[l] = 0.84851 | C[l] = 0.40605 |
| N = 0.5595020240881841 | | | | | |
| l = 6 | t = 13 | S = 0.51115919077 | C = 0.51115963323 | S[l] = 0.19077 | C[l] = 0.63323 |
| N = 0.5111608088066862 | | | | | |
| l = 6 | t = 14 | S = 0.90671290907 | C = 0.90671419315 | S[l] = 0.90907 | C[l] = 0.19315 |
| N = 0.9067148111850584 | | | | | |
| l = 6 | t = 15 | S = 0.73293015339 | C = 0.73293215339 | S[l] = 0.15339 | C[l] = 0.15339 |
| N = 0.7329321533911718 | | | | | |
| l = 6 | t = 16 | S = 0.56779826643 | C = 0.56780078658 | S[l] = 0.26643 | C[l] = 0.78658 |
| N = 0.5678001685484511 | | | | | |
| l = 6 | t = 17 | S = 0.60216776392 | C = 0.60217055752 | S[l] = 0.76392 | C[l] = 0.55752 |
| N = 0.6021693819551255 | | | | | |
| l = 6 | t = 18 | S = 0.37339145338 | C = 0.37339424698 | S[l] = 0.45338 | C[l] = 0.24698 |
| N = 0.37339262895240566 | | | | | |
| l = 6 | t = 19 | S = 0.33572077876 | C = 0.33572329891 | S[l] = 0.77876 | C[l] = 0.29891 |
| N = 0.3357213968021392 | | | | | |
| l = 6 | t = 20 | S = 0.05286737741 | C = 0.05286937741 | S[l] = 0.37741 | C[l] = 0.37741 |
| N = 0.05286737741091996 | | | | | |
| l = 6 | t = 21 | S = 0.88603279277 | C = 0.88603407685 | S[l] = 0.79277 | C[l] = 0.07685 |
| N = 0.8860321747399106 | | | | | |
| l = 6 | t = 22 | S = 0.50992755475 | C = 0.50992799722 | S[l] = 0.55475 | C[l] = 0.99722 |
| N = 0.5099263791865623 | | | | | |
| l = 6 | t = 23 | S = 0.37619375662 | C = 0.37619331416 | S[l] = 0.75662 | C[l] = 0.31416 |
| N = 0.3761921385958562 | | | | | |
| l = 6 | t = 24 | S = 0.02928782548 | C = 0.0292865414 | S[l] = 0.82548 | C[l] = 0.5414 |
| N = 0.029285923368163713 | | | | | |
| l = 7 | t = 1 | S = 0.7551424433 | C = 0.75514372737 | S[l] = 0.433 | C[l] = 0.2737 |
| N = 0.7551418252668531 | | | | | |
| l = 7 | t = 2 | S = 0.78860385036 | C = 0.78860429283 | S[l] = 0.5036 | C[l] = 0.9283 |
| N = 0.7886026747990915 | | | | | |
| l = 7 | t = 3 | S = 0.16394964216 | C = 0.1639491997 | S[l] = 0.4216 | C[l] = 0.997 |
| N = 0.16394802413253817 | | | | | |
| l = 7 | t = 4 | S = 0.86588420218 | C = 0.8658829181 | S[l] = 0.0218 | C[l] = 0.181 |
| N = 0.8658823000725754 | | | | | |
| l = 7 | t = 5 | S = 0.85997015777 | C = 0.85996815777 | S[l] = 0.5777 | C[l] = 0.5777 |
| N = 0.8599681577757187 | | | | | |
| l = 7 | t = 6 | S = 0.18112015476 | C = 0.18111763461 | S[l] = 0.5476 | C[l] = 0.3461 |
| N = 0.18111825265356007 | | | | | |
| l = 7 | t = 7 | S = 0.76297716357 | C = 0.76297436996 | S[l] = 0.6357 | C[l] = 0.6996 |
| N = 0.7629755455395997 | | | | | |
| l = 7 | t = 8 | S = 0.32045707155 | C = 0.32045427795 | S[l] = 0.7155 | C[l] = 0.7795 |
| N = 0.32045589598653246 | | | | | |
| l = 7 | t = 9 | S = 0.13233217918 | C = 0.13232965903 | S[l] = 0.7918 | C[l] = 0.5903 |
| N = 0.132331561149566 | | | | | |
| l = 7 | t = 10 | S = 0.50985295423 | C = 0.50985095423 | S[l] = 0.5423 | C[l] = 0.5423 |
| N = 0.509852954231618 | | | | | |
| l = 7 | t = 11 | S = 0.46002892478 | C = 0.4600276407 | S[l] = 0.2478 | C[l] = 0.407 |
| N = 0.46002954282170505 | | | | | |
| l = 7 | t = 12 | S = 0.55950084851 | C = 0.55950040605 | S[l] = 0.4851 | C[l] = 0.0605 |
| N = 0.5595020240881841 | | | | | |
| l = 7 | t = 13 | S = 0.51115919077 | C = 0.51115963323 | S[l] = 0.9077 | C[l] = 0.3323 |
| N = 0.5111608088066862 | | | | | |
| l = 7 | t = 14 | S = 0.90671290907 | C = 0.90671419315 | S[l] = 0.0907 | C[l] = 0.9315 |
| N = 0.9067148111850584 | | | | | |
| l = 7 | t = 15 | S = 0.73293015339 | C = 0.73293215339 | S[l] = 0.5339 | C[l] = 0.5339 |
| N = 0.7329321533911718 | | | | | |
| l = 7 | t = 16 | S = 0.56779826643 | C = 0.56780078658 | S[l] = 0.6643 | C[l] = 0.8658 |
| N = 0.5678001685484511 | | | | | |
| l = 7 | t = 17 | S = 0.60216776392 | C = 0.60217055752 | S[l] = 0.6392 | C[l] = 0.5752 |
| N = 0.6021693819551255 | | | | | |
| l = 7 | t = 18 | S = 0.37339145338 | C = 0.37339424698 | S[l] = 0.5338 | C[l] = 0.4698 |
| N = 0.37339262895240566 | | | | | |
| l = 7 | t = 19 | S = 0.33572077876 | C = 0.33572329891 | S[l] = 0.7876 | C[l] = 0.9891 |
| N = 0.3357213968021392 | | | | | |
| l = 7 | t = 20 | S = 0.05286737741 | C = 0.05286937741 | S[l] = 0.7741 | C[l] = 0.7741 |
| N = 0.05286737741091996 | | | | | |
| l = 7 | t = 21 | S = 0.88603279277 | C = 0.88603407685 | S[l] = 0.9277 | C[l] = 0.7685 |
| N = 0.8860321747399106 | | | | | |
| l = 7 | t = 22 | S = 0.50992755475 | C = 0.50992799722 | S[l] = 0.5475 | C[l] = 0.9722 |
| N = 0.5099263791865623 | | | | | |
| l = 7 | t = 23 | S = 0.37619375662 | C = 0.37619331416 | S[l] = 0.5662 | C[l] = 0.1416 |
| N = 0.3761921385958562 | | | | | |
| l = 7 | t = 24 | S = 0.02928782548 | C = 0.0292865414 | S[l] = 0.2548 | C[l] = 0.414 |

N = 0.029285923368163713

1) S = N[t] + 0.000002*sine (2*pi*t/T)
2) C = N[t] + 0.000002* sine (2*pi*t/T + pi/2
3) partial S[l] from S
4) partial C[l] from C
5) N = noise N[t]

TABLE 3-a
T = 20

| | | 1 | 2 | 3 | 4 |
|---|---|---|---|---|---|
| l = 0 | t = 1 | S = 0.00309016994 | C = 0.00951056516 | S[l] = 0.00309016994 | C[l] = 0.00951056516 |
| l = 0 | t = 2 | S = 0.00587785252 | C = 0.00809016994 | S[l] = 0.00587785252 | C[l] = 0.00809016994 |
| l = 0 | t = 3 | S = 0.00809016994 | C = 0.00587785252 | S[l] = 0.00809016994 | C[l] = 0.00587785252 |
| l = 0 | t = 4 | S = 0.00951056516 | C = 0.00309016994 | S[l] = 0.00951056516 | C[l] = 0.00309016994 |
| l = 0 | t = 5 | S = 0.01 | C = 0.0 | S[l] = 0.01 | C[l] = 0.0 |
| l = 0 | t = 6 | S = 0.00951056516 | C = −0.00309016994 | S[l] = 0.00951056516 | C[l] = −0.00309016994 |
| l = 0 | t = 7 | S = 0.00809016994 | C = −0.00587785252 | S[l] = 0.00809016994 | C[l] = −0.00587785252 |
| l = 0 | t = 8 | S = 0.00587785252 | C = −0.00809016994 | S[l] = 0.00587785252 | C[l] = −0.00809016994 |
| l = 0 | t = 9 | S = 0.00309016994 | C = −0.00951056516 | S[l] = 0.00309016994 | C[l] = −0.00951056516 |
| l = 0 | t = 10 | S = 0.0 | C = −0.01 | S[l] = 0.0 | C[l] = −0.01 |
| l = 0 | t = 11 | S = −0.00309016994 | C = −0.00951056516 | S[l] = −0.00309016994 | C[l] = −0.00951056516 |
| l = 0 | t = 12 | S = −0.00587785252 | C = −0.00809016994 | S[l] = −0.00587785252 | C[l] = −0.00809016994 |
| l = 0 | t = 13 | S = −0.00809016994 | C = −0.00587785252 | S[l] = −0.00809016994 | C[l] = −0.00587785252 |
| l = 0 | t = 14 | S = −0.00951056516 | C = −0.00309016994 | S[l] = −0.00951056516 | C[l] = −0.00309016994 |
| l = 0 | t = 15 | S = −0.01 | C = −0.0 | S[l] = −0.01 | C[l] = −0.0 |
| l = 0 | t = 16 | S = −0.00951056516 | C = 0.00309016994 | S[l] = −0.00951056516 | C[l] = 0.00309016994 |
| l = 0 | t = 17 | S = −0.00809016994 | C = 0.00587785252 | S[l] = −0.00809016994 | C[l] = 0.00587785252 |
| l = 0 | t = 18 | S = −0.00587785252 | C = 0.00809016994 | S[l] = −0.00587785252 | C[l] = 0.00809016994 |
| l = 0 | t = 19 | S = −0.00309016994 | C = 0.00951056516 | S[l] = −0.00309016994 | C[l] = 0.00951056516 |
| l = 0 | t = 20 | S = −0.0 | C = 0.01 | S[l] = −0.0 | C[l] = 0.01 |
| l = 0 | t = 21 | S = 0.00309016994 | C = 0.00951056516 | S[l] = 0.00309016994 | C[l] = 0.00951056516 |
| l = 0 | t = 22 | S = 0.00587785252 | C = 0.00809016994 | S[l] = 0.00587785252 | C[l] = 0.00809016994 |
| l = 0 | t = 23 | S = 0.00809016994 | C = 0.00587785252 | S[l] = 0.00809016994 | C[l] = 0.00587785252 |
| l = 0 | t = 24 | S = 0.00951056516 | C = 0.00309016994 | S[l] = 0.00951056516 | C[l] = 0.00309016994 |
| l = 1 | t = 1 | S = 0.00309016994 | C = 0.00951056516 | S[l] = 0.0309016994 | C[l] = 0.0951056516 |
| l = 1 | t = 2 | S = 0.00587785252 | C = 0.00809016994 | S[l] = 0.0587785252 | C[l] = 0.0809016994 |
| l = 1 | t = 3 | S = 0.00809016994 | C = 0.00587785252 | S[l] = 0.0809016994 | C[l] = 0.0587785252 |
| l = 1 | t = 4 | S = 0.00951056516 | C = 0.00309016994 | S[l] = 0.0951056516 | C[l] = 0.0309016994 |
| l = 1 | t = 5 | S = 0.01 | C = 0.0 | S[l] = 0.1 | C[l] = 0.0 |
| l = 1 | t = 6 | S = 0.00951056516 | C = −0.00309016994 | S[l] = 0.0951056516 | C[l] = −0.0309016994 |
| l = 1 | t = 7 | S = 0.00809016994 | C = −0.00587785252 | S[l] = 0.0809016994 | C[l] = −0.0587785252 |
| l = 1 | t = 8 | S = 0.00587785252 | C = −0.00809016994 | S[l] = 0.0587785252 | C[l] = −0.0809016994 |
| l = 1 | t = 9 | S = 0.00309016994 | C = −0.00951056516 | S[l] = 0.0309016994 | C[l] = −0.0951056516 |
| l = 1 | t = 10 | S = 0.0 | C = −0.01 | S[l] = 0.0 | C[l] = −0.1 |
| l = 1 | t = 11 | S = −0.00309016994 | C = −0.00951056516 | S[l] = −0.0309016994 | C[l] = −0.0951056516 |
| l = 1 | t = 12 | S = −0.00587785252 | C = −0.00809016994 | S[l] = −0.0587785252 | C[l] = −0.0809016994 |
| l = 1 | t = 13 | S = −0.00809016994 | C = −0.00587785252 | S[l] = −0.0809016994 | C[l] = −0.0587785252 |
| l = 1 | t = 14 | S = −0.00951056516 | C = −0.00309016994 | S[l] = −0.0951056516 | C[l] = −0.0309016994 |
| l = 1 | t = 15 | S = −0.01 | C = −0.0 | S[l] = −0.1 | C[l] = −0.0 |
| l = 1 | t = 16 | S = −0.00951056516 | C = 0.00309016994 | S[l] = −0.0951056516 | C[l] = 0.0309016994 |
| l = 1 | t = 17 | S = −0.00809016994 | C = 0.00587785252 | S[l] = −0.0809016994 | C[l] = 0.0587785252 |
| l = 1 | t = 18 | S = −0.00587785252 | C = 0.00809016994 | S[l] = −0.0587785252 | C[l] = 0.0809016994 |
| l = 1 | t = 19 | S = −0.00309016994 | C = 0.00951056516 | S[l] = −0.0309016994 | C[l] = 0.0951056516 |
| l = 1 | t = 20 | S = −0.0 | C = 0.01 | S[l] = −0.0 | C[l] = 0.1 |
| l = 1 | t = 21 | S = 0.00309016994 | C = 0.00951056516 | S[l] = 0.0309016994 | C[l] = 0.0951056516 |
| l = 1 | t = 22 | S = 0.00587785252 | C = 0.00809016994 | S[l] = 0.0587785252 | C[l] = 0.0809016994 |
| l = 1 | t = 23 | S = 0.00809016994 | C = 0.00587785252 | S[l] = 0.0809016994 | C[l] = 0.0587785252 |
| l = 1 | t = 24 | S = 0.00951056516 | C = 0.00309016994 | S[l] = 0.0951056516 | C[l] = 0.0309016994 |
| l = 2 | t = 1 | S = 0.00309016994 | C = 0.00951056516 | S[l] = 0.309016994 | C[l] = 0.951056516 |
| l = 2 | t = 2 | S = 0.00587785252 | C = 0.00809016994 | S[l] = 0.587785252 | C[l] = 0.809016994 |
| l = 2 | t = 3 | S = 0.00809016994 | C = 0.00587785252 | S[l] = 0.809016994 | C[l] = 0.587785252 |
| l = 2 | t = 4 | S = 0.00951056516 | C = 0.00309016994 | S[l] = 0.951056516 | C[l] = 0.309016994 |
| l = 2 | t = 5 | S = 0.01 | C = 0.0 | S[l] = 0.0 | C[l] = 0.0 |
| l = 2 | t = 6 | S = 0.00951056516 | C = −0.00309016994 | S[l] = 0.951056516 | C[l] = −0.309016994 |
| l = 2 | t = 7 | S = 0.00809016994 | C = −0.00587785252 | S[l] = 0.809016994 | C[l] = −0.587785252 |
| l = 2 | t = 8 | S = 0.00587785252 | C = −0.00809016994 | S[l] = 0.587785252 | C[l] = −0.809016994 |
| l = 2 | t = 9 | S = 0.00309016994 | C = −0.00951056516 | S[l] = 0.309016994 | C[l] = −0.951056516 |
| l = 2 | t = 10 | S = 0.0 | C = −0.01 | S[l] = 0.0 | C[l] = −0.0 |
| l = 2 | t = 11 | S = −0.00309016994 | C = −0.00951056516 | S[l] = −0.309016994 | C[l] = −0.951056516 |
| l = 2 | t = 12 | S = −0.00587785252 | C = −0.00809016994 | S[l] = −0.587785252 | C[l] = −0.809016994 |
| l = 2 | t = 13 | S = −0.00809016994 | C = −0.00587785252 | S[l] = −0.809016994 | C[l] = −0.587785252 |
| l = 2 | t = 14 | S = −0.00951056516 | C = −0.00309016994 | S[l] = −0.951056516 | C[l] = −0.309016994 |
| l = 2 | t = 15 | S = −0.01 | C = −0.0 | S[l] = −0.0 | C[l] = −0.0 |
| l = 2 | t = 16 | S = −0.00951056516 | C = 0.00309016994 | S[l] = −0.951056516 | C[l] = 0.309016994 |
| l = 2 | t = 17 | S = −0.00809016994 | C = 0.00587785252 | S[l] = −0.809016994 | C[l] = 0.587785252 |
| l = 2 | t = 18 | S = −0.00587785252 | C = 0.00809016994 | S[l] = −0.587785252 | C[l] = 0.809016994 |
| l = 2 | t = 19 | S = −0.00309016994 | C = 0.00951056516 | S[l] = −0.309016994 | C[l] = 0.951056516 |
| l = 2 | t = 20 | S = −0.0 | C = 0.01 | S[l] = −0.0 | C[l] = 0.0 |
| l = 2 | t = 21 | S = 0.00309016994 | C = 0.00951056516 | S[l] = 0.309016994 | C[l] = 0.951056516 |
| l = 2 | t = 22 | S = 0.00587785252 | C = 0.00809016994 | S[l] = 0.587785252 | C[l] = 0.809016994 |
| l = 2 | t = 23 | S = 0.00809016994 | C = 0.00587785252 | S[l] = 0.809016994 | C[l] = 0.587785252 |
| l = 2 | t = 24 | S = 0.00951056516 | C = 0.00309016994 | S[l] = 0.951056516 | C[l] = 0.309016994 |
| l = 3 | t = 1 | S = 0.00309016994 | C = 0.00951056516 | S[l] = 0.09016994 | C[l] = 0.51056516 |
| l = 3 | t = 2 | S = 0.00587785252 | C = 0.00809016994 | S[l] = 0.87785252 | C[l] = 0.09016994 |
| l = 3 | t = 3 | S = 0.00809016994 | C = 0.00587785252 | S[l] = 0.09016994 | C[l] = 0.87785252 |
| l = 3 | t = 4 | S = 0.00951056516 | C = 0.00309016994 | S[l] = 0.51056516 | C[l] = 0.09016994 |
| l = 3 | t = 5 | S = 0.01 | C = 0.0 | S[l] = 0.0 | C[l] = 0.0 |
| l = 3 | t = 6 | S = 0.00951056516 | C = −0.00309016994 | S[l] = 0.51056516 | C[l] = −0.09016994 |
| l = 3 | t = 7 | S = 0.00809016994 | C = −0.00587785252 | S[l] = 0.09016994 | C[l] = −0.87785252 |
| l = 3 | t = 8 | S = 0.00587785252 | C = −0.00809016994 | S[l] = 0.87785252 | C[l] = −0.09016994 |
| l = 3 | t = 9 | S = 0.00309016994 | C = −0.00951056516 | S[l] = 0.09016994 | C[l] = −0.51056516 |
| l = 3 | t = 10 | S = 0.0 | C = −0.01 | S[l] = 0.0 | C[l] = −0.0 |
| l = 3 | t = 11 | S = −0.00309016994 | C = −0.00951056516 | S[l] = −0.09016994 | C[l] = −0.51056516 |
| l = 3 | t = 12 | S = −0.00587785252 | C = −0.00809016994 | S[l] = −0.87785252 | C[l] = −0.09016994 |
| l = 3 | t = 13 | S = −0.00809016994 | C = −0.00587785252 | S[l] = −0.09016994 | C[l] = −0.87785252 |
| l = 3 | t = 14 | S = −0.00951056516 | C = −0.00309016994 | S[l] = −0.51056516 | C[l] = −0.09016994 |
| l = 3 | t = 15 | S = −0.01 | C = −0.0 | S[l] = −0.0 | C[l] = −0.0 |
| l = 3 | t = 16 | S = −0.00951056516 | C = 0.00309016994 | S[l] = −0.51056516 | C[l] = 0.09016994 |
| l = 3 | t = 17 | S = −0.00809016994 | C = 0.00587785252 | S[l] = −0.09016994 | C[l] = 0.87785252 |
| l = 3 | t = 18 | S = −0.00587785252 | C = 0.00809016994 | S[l] = −0.87785252 | C[l] = 0.09016994 |
| l = 3 | t = 19 | S = −0.00309016994 | C = 0.00951056516 | S[l] = −0.09016994 | C[l] = 0.51056516 |
| l = 3 | t = 20 | S = −0.0 | C = 0.01 | S[l] = −0.0 | C[l] = 0.0 |
| l = 3 | t = 21 | S = 0.00309016994 | C = 0.00951056516 | S[l] = 0.09016994 | C[l] = 0.51056516 |
| l = 3 | t = 22 | S = 0.00587785252 | C = 0.00809016994 | S[l] = 0.87785252 | C[l] = 0.09016994 |
| l = 3 | t = 23 | S = 0.00809016994 | C = 0.00587785252 | S[l] = 0.09016994 | C[l] = 0.87785252 |
| l = 3 | t = 24 | S = 0.00951056516 | C = 0.00309016994 | S[l] = 0.51056516 | C[l] = 0.09016994 |
| l = 4 | t = 1 | S = 0.00309016994 | C = 0.00951056516 | S[l] = 0.9016994 | C[l] = 0.1056516 |
| l = 4 | t = 2 | S = 0.00587785252 | C = 0.00809016994 | S[l] = 0.7785252 | C[l] = 0.9016994 |
| l = 4 | t = 3 | S = 0.00809016994 | C = 0.00587785252 | S[l] = 0.9016994 | C[l] = 0.7785252 |
| l = 4 | t = 4 | S = 0.00951056516 | C = 0.00309016994 | S[l] = 0.1056516 | C[l] = 0.9016994 |
| l = 4 | t = 5 | S = 0.01 | C = 0.0 | S[l] = 0.0 | C[l] = 0.0 |
| l = 4 | t = 6 | S = 0.00951056516 | C = −0.00309016994 | S[l] = 0.1056516 | C[l] = −0.9016994 |
| l = 4 | t = 7 | S = 0.00809016994 | C = −0.00587785252 | S[l] = 0.9016994 | C[l] = −0.7785252 |
| l = 4 | t = 8 | S = 0.00587785252 | C = −0.00809016994 | S[l] = 0.7785252 | C[l] = −0.9016994 |
| l = 4 | t = 9 | S = 0.00309016994 | C = −0.00951056516 | S[l] = 0.9016994 | C[l] = −0.1056516 |
| l = 4 | t = 10 | S = 0.0 | C = −0.01 | S[l] = 0.0 | C[l] = −0.0 |
| l = 4 | t = 11 | S = −0.00309016994 | C = −0.00951056516 | S[l] = −0.9016994 | C[l] = −0.1056516 |
| l = 4 | t = 12 | S = −0.00587785252 | C = −0.00809016994 | S[l] = −0.7785252 | C[l] = −0.9016994 |
| l = 4 | t = 13 | S = −0.00809016994 | C = −0.00587785252 | S[l] = −0.9016994 | C[l] = −0.7785252 |
| l = 4 | t = 14 | S = −0.00951056516 | C = −0.00309016994 | S[l] = −0.1056516 | C[l] = −0.9016994 |
| l = 4 | t = 15 | S = −0.01 | C = −0.0 | S[l] = −0.0 | C[l] = −0.0 |
| l = 4 | t = 16 | S = −0.00951056516 | C = 0.00309016994 | S[l] = −0.1056516 | C[l] = 0.9016994 |
| l = 4 | t = 17 | S = −0.00809016994 | C = 0.00587785252 | S[l] = −0.9016994 | C[l] = 0.7785252 |
| l = 4 | t = 18 | S = −0.00587785252 | C = 0.00809016994 | S[l] = −0.7785252 | C[l] = 0.9016994 |
| l = 4 | t = 19 | S = −0.00309016994 | C = 0.00951056516 | S[l] = −0.9016994 | C[l] = 0.1056516 |
| l = 4 | t = 20 | S = −0.0 | C = 0.01 | S[l] = −0.0 | C[l] = 0.0 |
| l = 4 | t = 21 | S = 0.00309016994 | C = 0.00951056516 | S[l] = 0.9016994 | C[l] = 0.1056516 |
| l = 4 | t = 22 | S = 0.00587785252 | C = 0.00809016994 | S[l] = 0.7785252 | C[l] = 0.9016994 |
| l = 4 | t = 23 | S = 0.00809016994 | C = 0.00587785252 | S[l] = 0.9016994 | C[l] = 0.7785252 |
| l = 4 | t = 24 | S = 0.00951056516 | C = 0.00309016994 | S[l] = 0.1056516 | C[l] = 0.9016994 |
| l = 5 | t = 1 | S = 0.00309016994 | C = 0.00951056516 | S[l] = 0.016994 | C[l] = 0.056516 |
| l = 5 | t = 2 | S = 0.00587785252 | C = 0.00809016994 | S[l] = 0.785252 | C[l] = 0.016994 |
| l = 5 | t = 3 | S = 0.00809016994 | C = 0.00587785252 | S[l] = 0.016994 | C[l] = 0.785252 |
| l = 5 | t = 4 | S = 0.00951056516 | C = 0.00309016994 | S[l] = 0.056516 | C[l] = 0.016994 |
| l = 5 | t = 5 | S = 0.01 | C = 0.0 | S[l] = 0.0 | C[l] = 0.0 |
| l = 5 | t = 6 | S = 0.00951056516 | C = −0.00309016994 | S[l] = 0.056516 | C[l] = −0.016994 |
| l = 5 | t = 7 | S = 0.00809016994 | C = −0.00587785252 | S[l] = 0.016994 | C[l] = −0.785252 |
| l = 5 | t = 8 | S = 0.00587785252 | C = −0.00809016994 | S[l] = 0.785252 | C[l] = −0.016994 |
| l = 5 | t = 9 | S = 0.00309016994 | C = −0.00951056516 | S[l] = 0.016994 | C[l] = −0.056516 |
| l = 5 | t = 10 | S = 0.0 | C = −0.01 | S[l] = 0.0 | C[l] = −0.0 |
| l = 5 | t = 11 | S = −0.00309016994 | C = −0.00951056516 | S[l] = −0.016994 | C[l] = −0.056516 |
| l = 5 | t = 12 | S = −0.00587785252 | C = −0.00809016994 | S[l] = −0.785252 | C[l] = −0.016994 |
| l = 5 | t = 13 | S = −0.00809016994 | C = −0.00587785252 | S[l] = −0.016994 | C[l] = −0.785252 |
| l = 5 | t = 14 | S = −0.00951056516 | C = −0.00309016994 | S[l] = −0.056516 | C[l] = −0.016994 |
| l = 5 | t = 15 | S = −0.01 | C = −0.0 | S[l] = −0.0 | C[l] = −0.0 |
| l = 5 | t = 16 | S = −0.00951056516 | C = 0.00309016994 | S[l] = −0.056516 | C[l] = 0.016994 |
| l = 5 | t = 17 | S = −0.00809016994 | C = 0.00587785252 | S[l] = −0.016994 | C[l] = 0.785252 |
| l = 5 | t = 18 | S = −0.00587785252 | C = 0.00809016994 | S[l] = −0.785252 | C[l] = 0.016994 |
| l = 5 | t = 19 | S = −0.00309016994 | C = 0.00951056516 | S[l] = −0.016994 | C[l] = 0.056516 |
| l = 5 | t = 20 | S = −0.0 | C = 0.01 | S[l] = −0.0 | C[l] = 0.0 |
| l = 5 | t = 21 | S = 0.00309016994 | C = 0.00951056516 | S[l] = 0.016994 | C[l] = 0.056516 |
| l = 5 | t = 22 | S = 0.00587785252 | C = 0.00809016994 | S[l] = 0.785252 | C[l] = 0.016994 |
| l = 5 | t = 23 | S = 0.00809016994 | C = 0.00587785252 | S[l] = 0.016994 | C[l] = 0.785252 |
| l = 5 | t = 24 | S = 0.00951056516 | C = 0.00309016994 | S[l] = 0.056516 | C[l] = 0.016994 |
| l = 6 | t = 1 | S = 0.00309016994 | C = 0.00951056516 | S[l] = 0.16994 | C[l] = 0.56516 |
| l = 6 | t = 2 | S = 0.00587785252 | C = 0.00809016994 | S[l] = 0.85252 | C[l] = 0.16994 |
| l = 6 | t = 3 | S = 0.00809016994 | C = 0.00587885252 | S[l] = 0.16994 | C[l] = 0.85252 |
| l = 6 | t = 4 | S = 0.00951056516 | C = 0.00309016994 | S[l] = 0.56516 | C[l] = 0.16994 |
| l = 6 | t = 5 | S = 0.01 | C = 0.0 | S[l] = 0.0 | C[l] = 0.0 |
| l = 6 | t = 6 | S = 0.00951056516 | C = −0.00309016994 | S[l] = 0.56516 | C[l] = −0.16994 |
| l = 6 | t = 7 | S = 0.00809016994 | C = −0.00587785252 | S[l] = 0.16994 | C[l] = −0.85252 |
| l = 6 | t = 8 | S = 0.00587785252 | C = −0.00809016994 | S[l] = 0.85252 | C[l] = −0.16994 |
| l = 6 | t = 9 | S = 0.00309016994 | C = −0.00951056516 | S[l] = 0.16994 | C[l] = −0.56516 |
| l = 6 | t = 10 | S = 0.0 | C = −0.01 | S[l] = 0.0 | C[l] = −0.0 |
| l = 6 | t = 11 | S = −0.00309016994 | C = −0.00951056516 | S[l] = −0.16994 | C[l] = −0.56516 |
| l = 6 | t = 12 | S = −0.00587785252 | C = −0.00809016994 | S[l] = −0.85252 | C[l] = −0.16994 |
| l = 6 | t = 13 | S = −0.00809016994 | C = −0.00587785252 | S[l] = −0.16994 | C[l] = −0.85252 |
| l = 6 | t = 14 | S = −0.00951056516 | C = −0.00309016994 | S[l] = −0.56516 | C[l] = −0.16994 |
| l = 6 | t = 15 | S = −0.01 | C = −0.0 | S[l] = −0.0 | C[l] = −0.0 |
| l = 6 | t = 16 | S = −0.00951056516 | C = 0.00309016994 | S[l] = −0.56516 | C[l] = 0.16994 |
| l = 6 | t = 17 | S = −0.00809016994 | C = 0.00587785252 | S[l] = −0.16994 | C[l] = 0.85252 |
| l = 6 | t = 18 | S = −0.00587785252 | C = 0.00809016994 | S[l] = −0.85252 | C[l] = 0.16994 |
| l = 6 | t = 19 | S = −0.00309016994 | C = 0.00951056516 | S[l] = −0.16994 | C[l] = 0.56516 |
| l = 6 | t = 20 | S = −0.0 | C = 0.01 | S[l] = −0.0 | C[l] = 0.0 |
| l = 6 | t = 21 | S = 0.00309016994 | C = 0.00951056516 | S[l] = 0.16994 | C[l] = 0.56516 |
| l = 6 | t = 22 | S = 0.00587785252 | C = 0.00809016994 | S[l] = 0.85252 | C[l] = 0.16994 |
| l = 6 | t = 23 | S = 0.00809016994 | C = 0.00587785252 | S[l] = 0.16994 | C[l] = 0.85252 |
| l = 6 | t = 24 | S = 0.00951056516 | C = 0.00309016994 | S[l] = 0.56516 | C[l] = 0.16994 |
| l = 7 | t = 1 | S = 0.00309016994 | C = 0.00951056516 | S[l] = 0.6994 | C[l] = 0.6516 |
| l = 7 | t = 2 | S = 0.00587785252 | C = 0.00809016994 | S[l] = 0.5252 | C[l] = 0.6994 |
| l = 7 | t = 3 | S = 0.00809016994 | C = 0.00587785252 | S[l] = 0.6994 | C[l] = 0.5252 |
| l = 7 | t = 4 | S = 0.00951056516 | C = 0.00309016994 | S[l] = 0.6516 | C[l] = 0.6994 |
| l = 7 | t = 5 | S = 0.01 | C = 0.0 | S[l] = 0.0 | C[l] = 0.0 |
| l = 7 | t = 6 | S = 0.00951056516 | C = −0.00309016994 | S[l] = 0.6516 | C[l] = −0.6994 |
| l = 7 | t = 7 | S = 0.00809016994 | C = −0.00587785252 | S[l] = 0.6994 | C[l] = −0.5252 |
| l = 7 | t = 8 | S = 0.00587785252 | C = −0.00809016994 | S[l] = 0.5252 | C[l] = −0.6994 |
| l = 7 | t = 9 | S = 0.00309016994 | C = −0.00951056516 | S[l] = 0.6994 | C[l] = −0.6516 |
| l = 7 | t = 10 | S = 0.0 | C = −0.01 | S[l] = 0.0 | C[l] = −0.0 |
| l = 7 | t = 11 | S = −0.00309016994 | C = −0.00951056516 | S[l] = −0.6994 | C[l] = −0.6516 |
| l = 7 | t = 12 | S = −0.00587785252 | C = −0.00809016994 | S[l] = −0.5252 | C[l] = −0.6994 |
| l = 7 | t = 13 | S = −0.00809016994 | C = −0.00587785252 | S[l] = −0.6994 | C[l] = −0.5252 |
| l = 7 | t = 14 | S = −0.00951056516 | C = −0.00309016994 | S[l] = −0.6516 | C[l] = −0.6994 |
| l = 7 | t = 15 | S = −0.01 | C = −0.0 | S[l] = −0.0 | C[l] = −0.0 |
| l = 7 | t = 16 | S = −0.00951056516 | C = 0.00309016994 | S[l] = −0.6516 | C[l] = 0.6994 |
| l = 7 | t = 17 | S = −0.00809016994 | C = 0.00587785252 | S[l] = −0.6994 | C[l] = 0.5252 |
| l = 7 | t = 18 | S = −0.00587785252 | C = 0.00809016994 | S[l] = −0.5252 | C[l] = 0.6994 |
| l = 7 | t = 19 | S = −0.00309016994 | C = 0.00951056516 | S[l] = −0.6994 | C[l] = 0.6516 |
| l = 7 | t = 20 | S = −0.0 | C = 0.01 | S[l] = −0.0 | C[l] = 0.0 |
| l = 7 | t = 21 | S = 0.00309016994 | C = 0.00951056516 | S[l] = 0.6994 | C[l] = 0.6516 |
| l = 7 | t = 22 | S = 0.00587785252 | C = 0.00809016994 | S[l] = 0.5252 | C[l] = 0.6994 |
| l = 7 | t = 23 | S = 0.00809016994 | C = 0.00587785252 | S[l] = 0.6994 | C[l] = 0.5252 |
| l = 7 | t = 24 | S = 0.00951056516 | C = 0.00309016994 | S[l] = 0.6516 | C[l] = 0.6994 |
| l = 8 | t = 1 | S = 0.00309016994 | C = 0.00951056516 | S[l] = 0.994 | C[l] = 0.516 |
| l = 8 | t = 2 | S = 0.00587785252 | C = 0.00809016994 | S[l] = 0.252 | C[l] = 0.994 |
| l = 8 | t = 3 | S = 0.00809016994 | C = 0.00587785252 | S[l] = 0.994 | C[l] = 0.252 |
| l = 8 | t = 4 | S = 0.00951056516 | C = 0.00309016994 | S[l] = 0.516 | C[l] = 0.994 |
| l = 8 | t = 5 | S = 0.01 | C = 0.0 | S[l] = 0.0 | C[l] = 0.0 |
| l = 8 | t = 6 | S = 0.00951056516 | C = −0.00309016994 | S[l] = 0.516 | C[l] = −0.994 |
| l = 8 | t = 7 | S = 0.00809016994 | C = −0.00587785252 | S[l] = 0.994 | C[l] = −0.252 |
| l = 8 | t = 8 | S = 0.00587785252 | C = −0.00809016994 | S[l] = 0.252 | C[l] = −0.994 |
| l = 8 | t = 9 | S = 0.00309016994 | C = −0.00951056516 | S[l] = 0.994 | C[l] = −0.516 |
| l = 8 | t = 10 | S = 0.0 | C = −0.01 | S[l] = 0.0 | C[l] = −0.0 |
| l = 8 | t = 11 | S = −0.00309016994 | C = −0.00951056516 | S[l] = −0.994 | C[l] = −0.516 |
| l = 8 | t = 12 | S = −0.00587785252 | C = −0.00809016994 | S[l] = −0.252 | C[l] = −0.994 |
| l = 8 | t = 13 | S = −0.00809016994 | C = −0.00587785252 | S[l] = −0.994 | C[l] = −0.252 |
| l = 8 | t = 14 | S = −0.00951056516 | C = −0.00309016994 | S[l] = −0.516 | C[l] = −0.994 |
| l = 8 | t = 15 | S = −0.01 | C = −0.0 | S[l] = −0.0 | C[l] = −0.0 |
| l = 8 | t = 16 | S = −0.00951056516 | C = 0.00309016994 | S[l] = −0.516 | C[l] = 0.994 |
| l = 8 | t = 17 | S = −0.00809016994 | C = 0.00587785252 | S[l] = −0.994 | C[l] = 0.252 |
| l = 8 | t = 18 | S = −0.00587785252 | C = 0.00809016994 | S[l] = −0.252 | C[l] = 0.994 |
| l = 8 | t = 19 | S = −0.00309016994 | C = 0.00951056516 | S[l] = −0.994 | C[l] = 0.516 |
| l = 8 | t = 20 | S = −0.0 | C = 0.01 | S[l] = −0.0 | C[l] = 0.0 |
| l = 8 | t = 21 | S = 0.00309016994 | C = 0.00951056516 | S[l] = 0.994 | C[l] = 0.516 |
| l = 8 | t = 22 | S = 0.00587785252 | C = 0.00809016994 | S[l] = 0.252 | C[l] = 0.994 |
| l = 8 | t = 23 | S = 0.00809016994 | C = 0.00587785252 | S[l] = 0.994 | C[l] = 0.252 |
| l = 8 | t = 24 | S = 0.00951056516 | C = 0.00309016994 | S[l] = 0.516 | C[l] = 0.994 |
| l = 9 | t = 1 | S = 0.00309016994 | C = 0.00951056516 | S[l] = 0.94 | C[l] = 0.16 |
| l = 9 | t = 2 | S = 0.00587785252 | C = 0.00809016994 | S[l] = 0.52 | C[l] = 0.94 |
| l = 9 | t = 3 | S = 0.00809016994 | C = 0.00587785252 | S[l] = 0.94 | C[l] = 0.52 |
| l = 9 | t = 4 | S = 0.00951056516 | C = 0.00309016994 | S[l] = 0.16 | C[l] = 0.94 |
| l = 9 | t = 5 | S = 0.01 | C = 0.0 | S[l] = 0.0 | C[l] = 0.0 |
| l = 9 | t = 6 | S = 0.00951056516 | C = −0.00309016994 | S[l] = 0.16 | C[l] = −0.94 |
| l = 9 | t = 7 | S = 0.00809016994 | C = −0.00587785252 | S[l] = 0.94 | C[l] = −0.52 |
| l = 9 | t = 8 | S = 0.00587785252 | C = −0.00809016994 | S[l] = 0.52 | C[l] = −0.94 |
| l = 9 | t = 9 | S = 0.00309016994 | C = −0.00951056516 | S[l] = 0.94 | C[l] = −0.16 |
| l = 9 | t = 10 | S = 0.0 | C = −0.01 | S[l] = 0.0 | C[l] = −0.0 |
| l = 9 | t = 11 | S = −0.00309016994 | C = −0.00951056516 | S[l] = −0.94 | C[l] = −0.16 |
| l = 9 | t = 12 | S = −0.00587785252 | C = −0.00809016994 | S[l] = −0.52 | C[l] = −0.94 |
| l = 9 | t = 13 | S = −0.00809016994 | C = −0.00587785252 | S[l] = −0.94 | C[l] = −0.52 |
| l = 9 | t = 14 | S = −0.00951056516 | C = −0.00309016994 | S[l] = −0.16 | C[l] = −0.94 |
| l = 9 | t = 15 | S = −0.01 | C = −0.0 | S[l] = −0.0 | C[l] = −0.0 |
| l = 9 | t = 16 | S = −0.00951056516 | C = 0.00309016994 | S[l] = −0.16 | C[l] = 0.94 |
| l = 9 | t = 17 | S = −0.00809016994 | C = 0.00587785252 | S[l] = −0.94 | C[l] = 0.52 |
| l = 9 | t = 18 | S = −0.00587785252 | C = 0.00809016994 | S[l] = −0.52 | C[l] = 0.94 |
| l = 9 | t = 19 | S = −0.00309016994 | C = 0.00951056516 | S[l] = −0.94 | C[l] = 0.16 |
| l = 9 | t = 20 | S = −0.0 | C = 0.01 | S[l] = −0.0 | C[l] = 0.0 |
| l = 9 | t = 21 | S = 0.00309016994 | C = 0.00951056516 | S[l] = 0.94 | C[l] = 0.16 |
| l = 9 | t = 22 | S = 0.00587785252 | C = 0.00809016994 | S[l] = 0.52 | C[l] = 0.94 |
| l = 9 | t = 23 | S = 0.00809016994 | C = 0.00587785252 | S[l] = 0.94 | C[l] = 0.52 |
| l = 9 | t = 24 | S = 0.00951056516 | C = 0.00309016994 | S[l] = 0.16 | C[l] = 0.94 |
| l = 10 | t = 1 | S = 0.00309016994 | C = 0.00951056516 | S[l] = 0.4 | C[l] = 0.6 |
| l = 10 | t = 2 | S = 0.00587785252 | C = 0.00809016994 | S[l] = 0.2 | C[l] = 0.4 |
| l = 10 | t = 3 | S = 0.00809016994 | C = 0.00587785252 | S[l] = 0.4 | C[l] = 0.2 |
| l = 10 | t = 4 | S = 0.00951056516 | C = 0.00309016994 | S[l] = 0.6 | C[l] = 0.4 |
| l = 10 | t = 5 | S = 0.01 | C = 0.0 | S[l] = 0.0 | C[l] = 0.0 |
| l = 10 | t = 6 | S = 0.00951056516 | C = −0.00309016994 | S[l] = 0.6 | C[l] = −0.4 |
| l = 10 | t = 7 | S = 0.00809016994 | C = −0.00587785252 | S[l] = 0.4 | C[l] = −0.2 |
| l = 10 | t = 8 | S = 0.00587785252 | C = −0.00809016994 | S[l] = 0.2 | C[l] = −0.4 |
| l = 10 | t = 9 | S = 0.00309016994 | C = −0.00951056516 | S[l] = 0.4 | C[l] = −0.6 |
| l = 10 | t = 10 | S = 0.0 | C = −0.01 | S[l] = 0.0 | C[l] = −0.0 |
| l = 10 | t = 11 | S = −0.00309016994 | C = −0.00951056516 | S[l] = −0.4 | C[l] = −0.6 |
| l = 10 | t = 12 | S = −0.00587785252 | C = −0.00809016994 | S[l] = −0.2 | C[l] = −0.4 |
| l = 10 | t = 13 | S = −0.00809016994 | C = −0.00587785252 | S[l] = −0.4 | C[l] = −0.2 |
| l = 10 | t = 14 | S = −0.00951056516 | C = −0.00309016994 | S[l] = −0.6 | C[l] = −0.4 |
| l = 10 | t = 15 | S = −0.01 | C = −0.0 | S[l] = −0.0 | C[l] = −0.0 |
| l = 10 | t = 16 | S = −0.00951056516 | C = 0.00309016994 | S[l] = −0.6 | C[l] = 0.4 |
| l = 10 | t = 17 | S = −0.00809016994 | C = 0.00587785252 | S[l] = −0.4 | C[l] = 0.2 |
| l = 10 | t = 18 | S = −0.00587785252 | C = 0.00809016994 | S[l] = −0.2 | C[l] = 0.4 |
| l = 10 | t = 19 | S = −0.00309016994 | C = 0.00951056516 | S[l] = −0.4 | C[l] = 0.6 |
| l = 10 | t = 20 | S = −0.0 | C = 0.01 | S[l] = −0.0 | C[l] = 0.0 |
| l = 10 | t = 21 | S = 0.00309016994 | C = 0.00951056516 | S[l] = 0.4 | C[l] = 0.6 |
| l = 10 | t = 22 | S = 0.00587785252 | C = 0.00809016994 | S[l] = 0.2 | C[l] = 0.4 |
| l = 10 | t = 23 | S = 0.00809016994 | C = 0.00587785252 | S[l] = 0.4 | C[l] = 0.2 |
| l = 10 | t = 24 | S = 0.00951056516 | C = 0.00309016994 | S[l] = 0.6 | C[l] = 0.4 |
| l = 11 | t = 1 | S = 0.00309016994 | C = 0.00951056516 | S[l] = 0.0 | C[l] = 0.0 |
| l = 11 | t = 2 | S = 0.00587785252 | C = 0.00809016994 | S[l] = 0.0 | C[l] = 0.0 |
| l = 11 | t = 3 | S = 0.00809016994 | C = 0.00587785252 | S[l] = 0.0 | C[l] = 0.0 |
| l = 11 | t = 4 | S = 0.00951056516 | C = 0.00309016994 | S[l] = 0.0 | C[l] = 0.0 |
| l = 11 | t = 5 | S = 0.01 | C = 0.0 | S[l] = 0.0 | C[l] = 0.0 |
| l = 11 | t = 6 | S = 0.00951056516 | C = −0.00309016994 | S[l] = 0.0 | C[l] = −0.0 |
| l = 11 | t = 7 | S = 0.00809016994 | C = −0.00587785252 | S[l] = 0.0 | C[l] = −0.0 |
| l = 11 | t = 8 | S = 0.00587785252 | C = −0.00809016994 | S[l] = 0.0 | C[l] = −0.0 |
| l = 11 | t = 9 | S = 0.00309016994 | C = −0.00951056516 | S[l] = 0.0 | C[l] = −0.0 |
| l = 11 | t = 10 | S = 0.0 | C = −0.01 | S[l] = 0.0 | C[l] = −0.0 |
| l = 11 | t = 11 | S = −0.00309016994 | C = −0.00951056516 | S[l] = −0.0 | C[l] = −0.0 |
| l = 11 | t = 12 | S = −0.00587785252 | C = −0.00809016994 | S[l] = −0.0 | C[l] = −0.0 |
| l = 11 | t = 13 | S = −0.00809016994 | C = −0.00587785252 | S[l] = −0.0 | C[l] = −0.0 |
| l = 11 | t = 14 | S = −0.00951056516 | C = −0.00309016994 | S[l] = −0.0 | C[l] = −0.0 |
| l = 11 | t = 15 | S = −0.01 | C = −0.0 | S[l] = −0.0 | C[l] = −0.0 |
| l = 11 | t = 16 | S = −0.00951056516 | C = 0.00309016994 | S[l] = −0.0 | C[l] = 0.0 |
| l = 11 | t = 17 | S = −0.00809016994 | C = 0.00587785252 | S[l] = −0.0 | C[l] = 0.0 |
| l = 11 | t = 18 | S = −0.00587785252 | C = 0.00809016994 | S[l] = −0.0 | C[l] = 0.0 |
| l = 11 | t = 19 | S = −0.00309016994 | C = 0.00951056516 | S[l] = −0.0 | C[l] = 0.0 |
| l = 11 | t = 20 | S = −0.0 | C = 0.01 | S[l] = −0.0 | C[l] = 0.0 |
| l = 11 | t = 21 | S = 0.00309016994 | C = 0.00951056516 | S[l] = 0.0 | C[l] = 0.0 |
| l = 11 | t = 22 | S = 0.00587785252 | C = 0.00809016994 | S[l] = 0.0 | C[l] = 0.0 |
| l = 11 | t = 23 | S = 0.00809016994 | C = 0.00587785252 | S[l] = 0.0 | C[l] = 0.0 |
| l = 11 | t = 24 | S = 0.00951056516 | C = 0.00309016994 | S[l] = 0.0 | C[l] = 0.0 |

1) S = 0.001*sine(2*pi*t/T)
2) C = 0.001*sine(2*pi*t/T + pi/2)
3) partial S[l] from S
4) partial C[l] from C

TABLE 3-b
T = 20

| | | 1 | 2 | 3 | 4 |
|---|---|---|---|---|---|
| l = 0 | t = 1 | S = 0.0 | C = 0.0 | S[l] = 0.0 | C[l] = 0.0 |
| l = 0 | t = 2 | S = 0.0 | C = 0.0 | S[l] = 0.0 | C[l] = 0.0 |
| l = 0 | t = 3 | S = 0.0 | C = 0.0 | S[l] = 0.0 | C[l] = 0.0 |
| l = 0 | t = 4 | S = 0.0 | C = 0.0 | S[l] = 0.0 | C[l] = 0.0 |
| l = 0 | t = 5 | S = 0.0010 | C = 0.0 | S[l] = 0.0010 | C[l] = 0.0 |
| l = 0 | t = 6 | S = 0.0 | C = −0.0 | S[l] = 0.0 | C[l] = −0.0 |
| l = 0 | t = 7 | S = 0.0 | C = −0.0 | S[l] = 0.0 | C[l] = −0.0 |
| l = 0 | t = 8 | S = 0.0 | C = −0.0 | S[l] = 0.0 | C[l] = −0.0 |
| l = 0 | t = 9 | S = 0.0 | C = −0.0 | S[l] = 0.0 | C[l] = −0.0 |
| l = 0 | t = 10 | S = 0.0 | C = −0.0010 | S[l] = 0.0 | C[l] = −0.0010 |
| l = 0 | t = 11 | S = −0.0 | C = −0.0 | S[l] = −0.0 | C[l] = −0.0 |
| l = 0 | t = 12 | S = −0.0 | C = −0.0 | S[l] = −0.0 | C[l] = −0.0 |
| l = 0 | t = 13 | S = −0.0 | C = −0.0 | S[l] = −0.0 | C[l] = −0.0 |
| l = 0 | t = 14 | S = −0.0 | C = −0.0 | S[l] = −0.0 | C[l] = −0.0 |
| l = 0 | t = 15 | S = −0.0010 | C = −0.0 | S[l] = −0.0010 | C[l] = −0.0 |
| l = 0 | t = 16 | S = −0.0 | C = 0.0 | S[l] = −0.0 | C[l] = 0.0 |
| l = 0 | t = 17 | S = −0.0 | C = 0.0 | S[l] = −0.0 | C[l] = 0.0 |
| l = 0 | t = 18 | S = −0.0 | C = 0.0 | S[l] = −0.0 | C[l] = 0.0 |
| l = 0 | t = 19 | S = −0.0 | C = 0.0 | S[l] = −0.0 | C[l] = 0.0 |
| l = 0 | t = 20 | S = −0.0 | C = 0.0010 | S[l] = −0.0 | C[l] = 0.0010 |
| l = 0 | t = 21 | S = 0.0 | C = 0.0 | S[l] = 0.0 | C[l] = 0.0 |
| l = 0 | t = 22 | S = 0.0 | C = 0.0 | S[l] = 0.0 | C[l] = 0.0 |
| l = 0 | t = 23 | S = 0.0 | C = 0.0 | S[l] = 0.0 | C[l] = 0.0 |
| l = 0 | t = 24 | S = 0.0 | C = 0.0 | S[l] = 0.0 | C[l] = 0.0 |
| l = 1 | t = 1 | S = 0.0 | C = 0.0 | S[l] = 0.0 | C[l] = 0.0 |
| l = 1 | t = 2 | S = 0.0 | C = 0.0 | S[l] = 0.0 | C[l] = 0.0 |
| l = 1 | t = 3 | S = 0.0 | C = 0.0 | S[l] = 0.0 | C[l] = 0.0 |
| l = 1 | t = 4 | S = 0.0 | C = 0.0 | S[l] = 0.0 | C[l] = 0.0 |
| l = 1 | t = 5 | S = 0.0010 | C = 0.0 | S[l] = 0.01 | C[l] = 0.0 |
| l = 1 | t = 6 | S = 0.0 | C = −0.0 | S[l] = 0.0 | C[l] = −0.0 |
| l = 1 | t = 7 | S = 0.0 | C = −0.0 | S[l] = 0.0 | C[l] = −0.0 |
| l = 1 | t = 8 | S = 0.0 | C = −0.0 | S[l] = 0.0 | C[l] = −0.0 |
| l = 1 | t = 9 | S = 0.0 | C = −0.0 | S[l] = 0.0 | C[l] = −0.0 |
| l = 1 | t = 10 | S = 0.0 | C = −0.0010 | S[l] = 0.0 | C[l] = −0.01 |
| l = 1 | t = 11 | S = −0.0 | C = −0.0 | S[l] = −0.0 | C[l] = −0.0 |
| l = 1 | t = 12 | S = −0.0 | C = −0.0 | S[l] = −0.0 | C[l] = −0.0 |
| l = 1 | t = 13 | S = −0.0 | C = −0.0 | S[l] = −0.0 | C[l] = −0.0 |
| l = 1 | t = 14 | S = −0.0 | C = −0.0 | S[l] = −0.0 | C[l] = −0.0 |
| l = 1 | t = 15 | S = −0.0010 | C = −0.0 | S[l] = −0.01 | C[l] = −0.0 |
| l = 1 | t = 16 | S = −0.0 | C = 0.0 | S[l] = −0.0 | C[l] = 0.0 |
| l = 1 | t = 17 | S = −0.0 | C = 0.0 | S[l] = −0.0 | C[l] = 0.0 |
| l = 1 | t = 18 | S = −0.0 | C = 0.0 | S[l] = −0.0 | C[l] = 0.0 |
| l = 1 | t = 19 | S = −0.0 | C = 0.0 | S[l] = −0.0 | C[l] = 0.0 |
| l = 1 | t = 20 | S = −0.0 | C = 0.0010 | S[l] = −0.0 | C[l] = 0.01 |
| l = 1 | t = 21 | S = 0.0 | C = 0.0 | S[l] = 0.0 | C[l] = 0.0 |
| l = 1 | t = 22 | S = 0.0 | C = 0.0 | S[l] = 0.0 | C[l] = 0.0 |
| l = 1 | t = 23 | S = 0.0 | C = 0.0 | S[l] = 0.0 | C[l] = 0.0 |
| l = 1 | t = 24 | S = 0.0 | C = 0.0 | S[l] = 0.0 | C[l] = 0.0 |

1) S = 0.0001*sine(2*pi*t/T)
2) C = 0.0001*sine(2*pi*t/T + pi/2)
3) partial S[l] from S
4) partial C[l] from C

TABLE 3-c
T = 20

| 5 | | 1 | 2 | 3 | 4 |
|---|---|---|---|---|---|
| l = 0 | t = 1 | S = 0.45928316602 | C = 0.45992520554 | S[l] = 0.45928316602 | C[l] = 0.45992520554 |

N = 0.45897414902622

| | | | | | |
|---|---|---|---|---|---|
| l = 0 | t = 2 | S = 0.28703976073 | C = 0.28726099247 | S[l] = 0.28703976073 | C[l] = 0.28726099247 |

N = 0.28645197548487333

| | | | | | |
|---|---|---|---|---|---|
| l = 0 | t = 3 | S = 0.62769101541 | C = 0.62746978366 | S[l] = 0.62769101541 | C[l] = 0.62746978366 |

N = 0.6268819984168608

| | | | | | |
|---|---|---|---|---|---|
| l = 0 | t = 4 | S = 0.6733042843 | C = 0.67266224478 | S[l] = 0.6733042843 | C[l] = 0.67266224478 |

N = 0.6723532277873395

| | | | | | |
|---|---|---|---|---|---|
| l = 0 | t = 5 | S = 0.95105103276 | C = 0.95005103276 | S[l] = 0.95105103276 | C[l] = 0.95005103276 |

N = 0.9500510327604397

| | | | | | |
|---|---|---|---|---|---|
| l = 0 | t = 6 | S = 0.92679980259 | C = 0.92553972908 | S[l] = 0.92679980259 | C[l] = 0.92553972908 |

N = 0.9258487460764414

| | | | | | |
|---|---|---|---|---|---|
| l = 0 | t = 7 | S = 0.75781869395 | C = 0.75642189171 | S[l] = 0.75781869395 | C[l] = 0.75642189171 |

N = 0.7570096769635962

| | | | | | |
|---|---|---|---|---|---|
| l = 0 | t = 8 | S = 0.20106762645 | C = 0.1996708242 | S[l] = 0.20106762645 | C[l] = 0.1996708242 |

N = 0.20047984120251394

| | | | | | |
|---|---|---|---|---|---|
| l = 0 | t = 9 | S = 0.49106379395 | C = 0.48980372044 | S[l] = 0.49106379395 | C[l] = 0.48980372044 |

N = 0.49075477696111336

| | | | | | |
|---|---|---|---|---|---|
| l = 0 | t = 10 | S = 0.46380054841 | C = 0.46280054841 | S[l] = 0.46380054841 | C[l] = 0.46280054841 |

N = 0.4638005484135552

| | | | | | |
|---|---|---|---|---|---|
| l = 0 | t = 11 | S = 0.97759656905 | C = 0.97695452953 | S[l] = 0.97759656905 | C[l] = 0.97695452953 |

N = 0.9779055860484721

| | | | | | |
|---|---|---|---|---|---|
| l = 0 | t = 12 | S = 0.41525180668 | C = 0.41503057494 | S[l] = 0.41525180668 | C[l] = 0.41503057494 |

N = 0.4158395919389991

| | | | | | |
|---|---|---|---|---|---|
| l = 0 | t = 13 | S = 0.54929934288 | C = 0.54952057462 | S[l] = 0.54929934288 | C[l] = 0.54952057462 |

N = 0.5501083598816547

| | | | | | |
|---|---|---|---|---|---|
| l = 0 | t = 14 | S = 0.12334512157 | C = 0.12398716109 | S[l] = 0.12334512157 | C[l] = 0.12398716109 |

N = 0.12429617809331905

| | | | | | |
|---|---|---|---|---|---|
| l = 0 | t = 15 | S = 0.478366715 | C = 0.479366715 | S[l] = 0.478366715 | C[l] = 0.479366715 |

N = 0.4793667150070021

| | | | | | |
|---|---|---|---|---|---|
| l = 0 | t = 16 | S = 0.23920327192 | C = 0.24046334543 | S[l] = 0.23920327192 | C[l] = 0.24046334543 |

N = 0.24015432843969664

| | | | | | |
|---|---|---|---|---|---|
| l = 0 | t = 17 | S = 0.94672719767 | C = 0.94812399992 | S[l] = 0.94672719767 | C[l] = 0.94812399992 |

N = 0.9475362146714496

| | | | | | |
|---|---|---|---|---|---|
| l = 0 | t = 18 | S = 0.2298603993 | C = 0.23125720155 | S[l] = 0.2298603993 | C[l] = 0.23125720155 |

N = 0.23044818455584026

| | | | | | |
|---|---|---|---|---|---|
| l = 0 | t = 19 | S = 0.94186869783 | C = 0.94312877134 | S[l] = 0.94186869783 | C[l] = 0.94312877134 |

N = 0.9421777148334594

| | | | | | |
|---|---|---|---|---|---|
| l = 0 | t = 20 | S = 0.32527545171 | C = 0.32627545171 | S[l] = 0.32527545171 | C[l] = 0.32627545171 |

N = 0.3252754517173355

| | | | | | |
|---|---|---|---|---|---|
| l = 0 | t = 21 | S = 0.34275131973 | C = 0.34339335926 | S[l] = 0.34275131973 | C[l] = 0.34339335926 |

N = 0.342442302745268

| | | | | | |
|---|---|---|---|---|---|
| l = 0 | t = 22 | S = 0.36837077146 | C = 0.3685920032 | S[l] = 0.36837077146 | C[l] = 0.3685920032 |

N = 0.36778298621256345

| | | | | | |
|---|---|---|---|---|---|
| l = 0 | t = 23 | S = 0.64473047025 | C = 0.64450923851 | S[l] = 0.64473047025 | C[l] = 0.64450923851 |

N = 0.6439214532647584

| | | | | | |
|---|---|---|---|---|---|
| l = 0 | t = 24 | S = 0.47675815628 | C = 0.47611611676 | S[l] = 0.47675815628 | C[l] = 0.47611611676 |

N = 0.47580709976592817

| | | | | | |
|---|---|---|---|---|---|
| l = 3 | t = 1 | S = 0.45928316602 | C = 0.45992520554 | S[l] = 0.28316602 | C[l] = 0.92520554 |

N = 0.45897414902622

| | | | | | |
|---|---|---|---|---|---|
| l = 3 | t = 2 | S = 0.28703976073 | C = 0.28726099247 | S[l] = 0.03976073 | C[l] = 0.26099247 |

N = 0.28645197548487333

| | | | | | |
|---|---|---|---|---|---|
| l = 3 | t = 3 | S = 0.62769101541 | C = 0.62746978366 | S[l] = 0.69101541 | C[l] = 0.46978366 |

N = 0.6268819984168608

| | | | | | |
|---|---|---|---|---|---|
| l = 3 | t = 4 | S = 0.6733042843 | C = 0.67266224478 | S[l] = 0.3042843 | C[l] = 0.66224478 |

N = 0.6723532277873395

| | | | | | |
|---|---|---|---|---|---|
| l = 3 | t = 5 | S = 0.95105103276 | C = 0.95005103276 | S[l] = 0.05103276 | C[l] = 0.05103276 |

N = 0.9500510327604397

| | | | | | |
|---|---|---|---|---|---|
| l = 3 | t = 6 | S = 0.92679980259 | C = 0.92553972908 | S[l] = 0.79980259 | C[l] = 0.53972908 |

N = 0.9258487460764414

| | | | | | |
|---|---|---|---|---|---|
| l = 3 | t = 7 | S = 0.75781869395 | C = 0.75642189171 | S[l] = 0.81869395 | C[l] = 0.42189171 |

N = 0.7570096769635962

| | | | | | |
|---|---|---|---|---|---|
| l = 3 | t = 8 | S = 0.20106762645 | C = 0.1996708242 | S[l] = 0.06762645 | C[l] = 0.6708242 |

N = 0.20047984120251394

| | | | | | |
|---|---|---|---|---|---|
| l = 3 | t = 9 | S = 0.49106379395 | C = 0.48980372044 | S[l] = 0.06379395 | C[l] = 0.80372044 |

N = 0.49075477696111336

| | | | | | |
|---|---|---|---|---|---|
| l = 3 | t = 10 | S = 0.46380054841 | C = 0.46280054841 | S[l] = 0.80054841 | C[l] = 0.80054841 |

N = 0.4638005484135552

| | | | | | |
|---|---|---|---|---|---|
| l = 3 | t = 11 | S = 0.97759656905 | C = 0.97695452953 | S[l] = 0.59656905 | C[l] = 0.95452953 |

N = 0.9779055860484721

| | | | | | |
|---|---|---|---|---|---|
| l = 3 | t = 12 | S = 0.41525180668 | C = 0.41503057494 | S[l] = 0.25180668 | C[l] = 0.03057494 |

N = 0.4158395919389991

| | | | | | |
|---|---|---|---|---|---|
| l = 3 | t = 13 | S = 0.54929934288 | C = 0.54952057462 | S[l] = 0.29934288 | C[l] = 0.52057462 |

N = 0.5501083598816547

| | | | | | |
|---|---|---|---|---|---|
| l = 3 | t = 14 | S = 0.12334512157 | C = 0.12398716109 | S[l] = 0.34512157 | C[l] = 0.98716109 |

N = 0.12429617809331905

| | | | | | |
|---|---|---|---|---|---|
| l = 3 | t = 15 | S = 0.478366715 | C = 0.479366715 | S[l] = 0.366715 | C[l] = 0.366715 |

N = 0.4793667150070021

| | | | | | |
|---|---|---|---|---|---|
| l = 3 | t = 16 | S = 0.23920327192 | C = 0.24046334543 | S[l] = 0.20327192 | C[l] = 0.46334543 |

N = 0.24015432843969664

| | | | | | |
|---|---|---|---|---|---|
| l = 3 | t = 17 | S = 0.94672719767 | C = 0.94812399992 | S[l] = 0.72719767 | C[l] = 0.12399992 |

N = 0.9475362146714496

| | | | | | |
|---|---|---|---|---|---|
| l = 3 | t = 18 | S = 0.2298603993 | C = 0.23125720155 | S[l] = 0.8603993 | C[l] = 0.25720155 |

N = 0.23044818455584026

| | | | | | |
|---|---|---|---|---|---|
| l = 3 | t = 19 | S = 0.94186869783 | C = 0.94312877134 | S[l] = 0.86869783 | C[l] = 0.12877134 |

N = 0.9421777148334594

| | | | | | |
|---|---|---|---|---|---|
| l = 3 | t = 20 | S = 0.32527545171 | C = 0.32627545171 | S[l] = 0.27545171 | C[l] = 0.27545171 |

N = 0.3252754517173355

| | | | | | |
|---|---|---|---|---|---|
| l = 3 | t = 21 | S = 0.34275131973 | C = 0.34339335926 | S[l] = 0.75131973 | C[l] = 0.39335926 |

N = 0.342442302745268

| | | | | | |
|---|---|---|---|---|---|
| l = 3 | t = 22 | S = 0.36837077146 | C = 0.3685920032 | S[l] = 0.37077146 | C[l] = 0.5920032 |

N = 0.36778298621256345

| | | | | | |
|---|---|---|---|---|---|
| l = 3 | t = 23 | S = 0.64473047025 | C = 0.64450923851 | S[l] = 0.73047025 | C[l] = 0.50923851 |

N = 0.6439214532647584

| | | | | | |
|---|---|---|---|---|---|
| l = 3 | t = 24 | S = 0.47675815628 | C = 0.47611611676 | S[l] = 0.75815628 | C[l] = 0.11611676 |

N = 0.47580709976592817

| | | | | | |
|---|---|---|---|---|---|
| l = 4 | t = 1 | S = 0.45928316602 | C = 0.45992520554 | S[l] = 0.8316602 | C[l] = 0.2520554 |

N = 0.45897414902622

| | | | | | |
|---|---|---|---|---|---|
| l = 4 | t = 2 | S = 0.28703976073 | C = 0.28726099247 | S[l] = 0.3976073 | C[l] = 0.6099247 |

N = 0.28645197548487333

| | | | | | |
|---|---|---|---|---|---|
| l = 4 | t = 3 | S = 0.62769101541 | C = 0.62746978366 | S[l] = 0.9101541 | C[l] = 0.6978366 |

N = 0.6268819984168608

| | | | | | |
|---|---|---|---|---|---|
| l = 4 | t = 4 | S = 0.6733042843 | C = 0.67266224478 | S[l] = 0.042843 | C[l] = 0.6224478 |

N = 0.6723532277873395

| | | | | | |
|---|---|---|---|---|---|
| l = 4 | t = 5 | S = 0.95105103276 | C = 0.95005103276 | S[l] = 0.5103276 | C[l] = 0.5103276 |

N = 0.9500510327604397

| | | | | | |
|---|---|---|---|---|---|
| l = 4 | t = 6 | S = 0.92679980259 | C = 0.92553972908 | S[l] = 0.9980259 | C[l] = 0.3972908 |

N = 0.9258487460764414

| | | | | | |
|---|---|---|---|---|---|
| l = 4 | t = 7 | S = 0.75781869395 | C = 0.75642189171 | S[l] = 0.1869395 | C[l] = 0.2189171 |

N = 0.7570096769635962

| | | | | | |
|---|---|---|---|---|---|
| l = 4 | t = 8 | S = 0.20106762645 | C = 0.1996708242 | S[l] = 0.6762645 | C[l] = 0.708242 |

N = 0.20047984120251394

| | | | | | |
|---|---|---|---|---|---|
| l = 4 | t = 9 | S = 0.49106379395 | C = 0.48980372044 | S[l] = 0.6379395 | C[l] = 0.0372044 |

N = 0.49075477696111336

| | | | | | |
|---|---|---|---|---|---|
| l = 4 | t = 10 | S = 0.46380054841 | C = 0.46280054841 | S[l] = 0.0054841 | C[l] = 0.0054841 |

N = 0.4638005484135552

| | | | | | |
|---|---|---|---|---|---|
| l = 4 | t = 11 | S = 0.97759656905 | C = 0.97695452953 | S[l] = 0.9656905 | C[l] = 0.5452953 |

N = 0.9779055860484721

| | | | | | |
|---|---|---|---|---|---|
| l = 4 | t = 12 | S = 0.41525180668 | C = 0.41503057494 | S[l] = 0.5180668 | C[l] = 0.3057494 |

N = 0.4158395919389991

| | | | | | |
|---|---|---|---|---|---|
| l = 4 | t = 13 | S = 0.54929934288 | C = 0.54952057462 | S[l] = 0.9934288 | C[l] = 0.2057462 |

N = 0.5501083598816547

| | | | | | |
|---|---|---|---|---|---|
| l = 4 | t = 14 | S = 0.12334512157 | C = 0.12398716109 | S[l] = 0.4512157 | C[l] = 0.8716109 |

N = 0.12429617809331905

| | | | | | |
|---|---|---|---|---|---|
| l = 4 | t = 15 | S = 0.478366715 | C = 0.479366715 | S[l] = 0.66715 | C[l] = 0.66715 |

N = 0.4793667150070021

| | | | | | |
|---|---|---|---|---|---|
| l = 4 | t = 16 | S = 0.23920327192 | C = 0.24046334543 | S[l] = 0.0327192 | C[l] = 0.6334543 |

N = 0.24015432843969664

| | | | | | |
|---|---|---|---|---|---|
| l = 4 | t = 17 | S = 0.94672719767 | C = 0.94812399992 | S[l] = 0.2719767 | C[l] = 0.2399992 |

N = 0.9475362146714496

| | | | | | |
|---|---|---|---|---|---|
| l = 4 | t = 18 | S = 0.2298603993 | C = 0.23125720155 | S[l] = 0.603993 | C[l] = 0.5720155 |

N = 0.23044818455584026

| | | | | | |
|---|---|---|---|---|---|
| l = 4 | t = 19 | S = 0.94186869783 | C = 0.94312877134 | S[l] = 0.6869783 | C[l] = 0.2877134 |

N = 0.9421777148334594

| | | | | | |
|---|---|---|---|---|---|
| l = 4 | t = 20 | S = 0.32527545171 | C = 0.32627545171 | S[l] = 0.7545171 | C[l] = 0.7545171 |

N = 0.3252754517173355

| | | | | | |
|---|---|---|---|---|---|
| l = 4 | t = 21 | S = 0.34275131973 | C = 0.34339335926 | S[l] = 0.5131973 | C[l] = 0.9335926 |

N = 0.342442302745268

| | | | | | |
|---|---|---|---|---|---|
| l = 4 | t = 22 | S = 0.36837077146 | C = 0.3685920032 | S[l] = 0.7077146 | C[l] = 0.920032 |

N = 0.36778298621256345

| | | | | | |
|---|---|---|---|---|---|
| l = 4 | t = 23 | S = 0.64473047025 | C = 0.64450923851 | S[l] = 0.3047025 | C[l] = 0.0923851 |

N = 0.6439214532647584

| | | | | | |
|---|---|---|---|---|---|
| l = 4 | t = 24 | S = 0.47675815628 | C = 0.47611611676 | S[l] = 0.5815628 | C[l] = 0.1611676 |

N = 0.47580709976592817
1) S = N[t] + 0.0001*sine(2*pi*t/T)
2) C = N[t] + 0.0001*sine(2*pi*t/T + pi/2)
3) partial S]l] from S
4) partial C[l] from C
5) N = noise N[t]

TABLE 3-d
T = 20

| 5 | | 1 | 2 | 3 | 4 |
|---|---|---|---|---|---|
| l = 0 | t = 1 | S = 0.74364150596 | C = 0.743642148 | S[l] = 0.74364150596 | C[l] = 0.743642148 |

N = 0.7436411969461322

| | | | | | |
|---|---|---|---|---|---|
| l = 0 | t = 2 | S = 0.61710921518 | C = 0.61710943641 | S[l] = 0.61710921518 | C[l] = 0.61710943641 |

N = 0.6171086273955917

| | | | | | |
|---|---|---|---|---|---|
| l = 0 | t = 3 | S = 0.94946037541 | C = 0.94946015418 | S[l] = 0.94946037541 | C[l] = 0.94946015418 |

N = 0.949459566399603

| | | | | | |
|---|---|---|---|---|---|
| l = 0 | t = 4 | S = 0.63441139063 | C = 0.63441074859 | S[l] = 0.63441139063 | C[l] = 0.63441074859 |

N = 0.634410439577296

| | | | | | |
|---|---|---|---|---|---|
| l = 0 | t = 5 | S = 0.91356596113 | C = 0.91356496113 | S[l] = 0.91356596113 | C[l] = 0.91356496113 |

N = 0.9135649611359267

| | | | | | |
|---|---|---|---|---|---|
| l = 0 | t = 6 | S = 0.42686328297 | C = 0.4268620229 | S[l] = 0.42686328297 | C[l] = 0.4268620229 |

N = 0.4268623319234597

| | | | | | |
|---|---|---|---|---|---|
| l = 0 | t = 7 | S = 0.30175801577 | C = 0.30175661897 | S[l] = 0.30175801577 | C[l] = 0.30175661897 |

N = 0.3017572067561809

| | | | | | |
|---|---|---|---|---|---|
| l = 0 | t = 8 | S = 0.33045201406 | C = 0.33045061726 | S[l] = 0.33045201406 | C[l] = 0.33045061726 |

N = 0.33045142628136837

| | | | | | |
|---|---|---|---|---|---|
| l = 0 | t = 9 | S = 0.76466706739 | C = 0.76466580731 | S[l] = 0.76466706739 | C[l] = 0.76466580731 |

N = 0.7646667583752824

| | | | | | |
|---|---|---|---|---|---|
| l = 0 | t = 10 | S = 0.24828075636 | C = 0.24827975636 | S[l] = 0.24828075636 | C[l] = 0.24827975636 |

N = 0.24828075636603164

| | | | | | |
|---|---|---|---|---|---|
| l = 0 | t = 11 | S = 0.07517743208 | C = 0.07517679004 | S[l] = 0.07517743208 | C[l] = 0.07517679004 |

N = 0.07517774110432451

| | | | | | |
|---|---|---|---|---|---|
| l = 0 | t = 12 | S = 0.43580247382 | C = 0.43580225259 | S[l] = 0.43580247382 | C[l] = 0.43580225259 |

N = 0.4358030616077615

| | | | | | |
|---|---|---|---|---|---|
| l = 0 | t = 13 | S = 0.8133264111 | C = 0.81332663233 | S[l] = 0.8133264111 | C[l] = 0.81332663233 |

N = 0.8133272201191313

| | | | | | |
|---|---|---|---|---|---|
| l = 0 | t = 14 | S = 0.65384280161 | C = 0.65384344365 | S[l] = 0.65384280161 | C[l] = 0.65384344365 |

N = 0.6538437526732097

| | | | | | |
|---|---|---|---|---|---|
| l = 0 | t = 15 | S = 0.30339375366 | C = 0.30339475366 | S[l] = 0.30339375366 | C[l] = 0.30339475366 |

N = 0.3033947536653492

| | | | | | |
|---|---|---|---|---|---|
| l = 0 | t = 16 | S = 0.2523815839 | C = 0.25238284397 | S[l] = 0.2523815839 | C[l] = 0.25238284397 |

N = 0.25238253495844165

| | | | | | |
|---|---|---|---|---|---|
| l = 0 | t = 17 | S = 0.61675539299 | C = 0.61675678979 | S[l] = 0.61675539299 | C[l] = 0.61675678979 |

N = 0.6167562020098308

| | | | | | |
|---|---|---|---|---|---|
| l = 0 | t = 18 | S = 0.86000510876 | C = 0.86000650556 | S[l] = 0.86000510876 | C[l] = 0.86000650556 |

N = 0.8600056965511272

| | | | | | |
|---|---|---|---|---|---|
| l = 0 | t = 19 | S = 0.78028185103 | C = 0.7802831111 | S[l] = 0.78028185103 | C[l] = 0.7802831111 |

N = 0.7802821600496817

| | | | | | |
|---|---|---|---|---|---|
| l = 0 | t = 20 | S = 0.69348274478 | C = 0.69348374478 | S[l] = 0.69348274478 | C[l] = 0.69348374478 |

N = 0.6934827447826224

| | | | | | |
|---|---|---|---|---|---|
| l = 0 | t = 21 | S = 0.21052801493 | C = 0.21052865697 | S[l] = 0.21052801493 | C[l] = 0.21052865697 |

N = 0.21052770591891246

| | | | | | |
|---|---|---|---|---|---|
| l = 0 | t = 22 | S = 0.94504163844 | C = 0.94504185968 | S[l] = 0.94504163844 | C[l] = 0.94504185968 |

N = 0.9450410506639705

| | | | | | |
|---|---|---|---|---|---|
| l = 0 | t = 23 | S = 0.30622700748 | C = 0.30622678625 | S[l] = 0.30622700748 | C[l] = 0.30622678625 |

N = 0.3062261984657363

| | | | | | |
|---|---|---|---|---|---|
| l = 0 | t = 24 | S = 0.89320949618 | C = 0.89320885414 | S[l] = 0.89320949618 | C[l] = 0.89320885414 |

N = 0.8932085451288954

| | | | | | |
|---|---|---|---|---|---|
| l = 6 | t = 1 | S = 0.74364150596 | C = 0.743642148 | S[l] = 0.50596 | C[l] = 0.148 |

N = 0.7436411969461322

| | | | | | |
|---|---|---|---|---|---|
| l = 6 | t = 2 | S = 0.61710921518 | C = 0.61710943641 | S[l] = 0.21518 | C[l] = 0.43641 |

N = 0.6171086273955917

| | | | | | |
|---|---|---|---|---|---|
| l = 6 | t = 3 | S = 0.94946037541 | C = 0.94946015418 | S[l] = 0.37541 | C[l] = 0.15418 |

N = 0.949459566399603

| | | | | | |
|---|---|---|---|---|---|
| l = 6 | t = 4 | S = 0.63441139063 | C = 0.63441074859 | S[l] = 0.39063 | C[l] = 0.74859 |

N = 0.634410439577296

| | | | | | |
|---|---|---|---|---|---|
| l = 6 | t = 5 | S = 0.91356596113 | C = 0.91356496113 | S[l] = 0.96113 | C[l] = 0.96113 |

N = 0.9135649611359267

| | | | | | |
|---|---|---|---|---|---|
| l = 6 | t = 6 | S = 0.42686328297 | C = 0.4268620229 | S[l] = 0.28297 | C[l] = 0.0229 |

N = 0.4268623319234597

| | | | | | |
|---|---|---|---|---|---|
| l = 6 | t = 7 | S = 0.30175801577 | C = 0.30175661897 | S[l] = 0.01577 | C[l] = 0.61897 |

N = 0.3017572067561809

| | | | | | |
|---|---|---|---|---|---|
| l = 6 | t = 8 | S = 0.33045201406 | C = 0.33045061726 | S[l] = 0.01406 | C[l] = 0.61726 |

N = 0.33045142628136837

| | | | | | |
|---|---|---|---|---|---|
| l = 6 | t = 9 | S = 0.76466706739 | C = 0.76466580731 | S[l] = 0.06739 | C[l] = 0.80731 |

N = 0.7646667583752824

| | | | | | |
|---|---|---|---|---|---|
| l = 6 | t = 10 | S = 0.24828075636 | C = 0.24827975636 | S[l] = 0.75636 | C[l] = 0.75636 |

N = 0.24828075636603164

| | | | | | |
|---|---|---|---|---|---|
| l = 6 | t = 11 | S = 0.07517743208 | C = 0.07517679004 | S[l] = 0.43208 | C[l] = 0.79004 |

N = 0.07517774110432451

| | | | | | |
|---|---|---|---|---|---|
| l = 6 | t = 12 | S = 0.43580247382 | C = 0.43580225259 | S[l] = 0.47382 | C[l] = 0.25259 |

N = 0.4358030616077615

| | | | | | |
|---|---|---|---|---|---|
| l = 6 | t = 13 | S = 0.8133264111 | C = 0.81332663233 | S[l] = 0.4111 | C[l] = 0.63233 |

N = 0.8133272201191313

| | | | | | |
|---|---|---|---|---|---|
| l = 6 | t = 14 | S = 0.65384280161 | C = 0.65384344365 | S[l] = 0.80161 | C[l] = 0.44365 |

N = 0.6538437526732097

| | | | | | |
|---|---|---|---|---|---|
| l = 6 | t = 15 | S = 0.30339375366 | C = 0.30339475366 | S[l] = 0.75366 | C[l] = 0.75366 |

N = 0.3033947536653492

| | | | | | |
|---|---|---|---|---|---|
| l = 6 | t = 16 | S = 0.2523815839 | C = 0.25238284397 | S[l] = 0.5839 | C[l] = 0.84397 |

N = 0.25238253495844165

| | | | | | |
|---|---|---|---|---|---|
| l = 6 | t = 17 | S = 0.61675539299 | C = 0.61675678979 | S[l] = 0.39299 | C[l] = 0.78979 |

N = 0.6167562020098308

| | | | | | |
|---|---|---|---|---|---|
| l = 6 | t = 18 | S = 0.86000510876 | C = 0.86000650556 | S[l] = 0.10876 | C[l] = 0.50556 |

N = 0.8600056965511272

| | | | | | |
|---|---|---|---|---|---|
| l = 6 | t = 19 | S = 0.78028185103 | C = 0.7802831111 | S[l] = 0.85103 | C[l] = 0.1111 |

N = 0.7802821600496817

| | | | | | |
|---|---|---|---|---|---|
| l = 6 | t = 20 | S = 0.69348274478 | C = 0.69348374478 | S[l] = 0.74478 | C[l] = 0.74478 |

N = 0.6934827447826224

| | | | | | |
|---|---|---|---|---|---|
| l = 6 | t = 21 | S = 0.21052801493 | C = 0.21052865697 | S[l] = 0.01493 | C[l] = 0.65697 |

N = 0.21052770591891246

| | | | | | |
|---|---|---|---|---|---|
| l = 6 | t = 22 | S = 0.94504163844 | C = 0.94504185968 | S[l] = 0.63844 | C[l] = 0.85968 |

N = 0.9450410506639705

| | | | | | |
|---|---|---|---|---|---|
| l = 6 | t = 23 | S = 0.30622700748 | C = 0.30622678625 | S[l] = 0.00748 | C[l] = 0.78625 |

N = 0.3062261984657363

| | | | | | |
|---|---|---|---|---|---|
| l = 6 | t = 24 | S = 0.89320949618 | C = 0.89320885414 | S[l] = 0.49618 | C[l] = 0.85414 |

N = 0.8932085451288954

| | | | | | |
|---|---|---|---|---|---|
| l = 7 | t = 1 | S = 0.74364150596 | C = 0.743642148 | S[l] = 0.0596 | C[l] = 0.48 |

N = 0.7436411969461322

| | | | | | |
|---|---|---|---|---|---|
| l = 7 | t = 2 | S = 0.61710921518 | C = 0.61710943641 | S[l] = 0.1518 | C[l] = 0.3641 |

N = 0.6171086273955917

| | | | | | |
|---|---|---|---|---|---|
| l = 7 | t = 3 | S = 0.94946037541 | C = 0.94946015418 | S[l] = 0.7541 | C[l] = 0.5418 |

N = 0.949459566399603

| | | | | | |
|---|---|---|---|---|---|
| l = 7 | t = 4 | S = 0.63441139063 | C = 0.63441074859 | S[l] = 0.9063 | C[l] = 0.4859 |

N = 0.634410439577296

| | | | | | |
|---|---|---|---|---|---|
| l = 7 | t = 5 | S = 0.91356596113 | C = 0.91356496113 | S[l] = 0.6113 | C[l] = 0.6113 |

N = 0.9135649611359267

| | | | | | |
|---|---|---|---|---|---|
| l = 7 | t = 6 | S = 0.42686328297 | C = 0.4268620229 | S[l] = 0.8297 | C[l] = 0.229 |

N = 0.4268623319234597

| | | | | | |
|---|---|---|---|---|---|
| l = 7 | t = 7 | S = 0.30175801577 | C = 0.30175661897 | S[l] = 0.1577 | C[l] = 0.1897 |

N = 0.3017572067561809

| | | | | | |
|---|---|---|---|---|---|
| l = 7 | t = 8 | S = 0.33045201406 | C = 0.33045061726 | S[l] = 0.1406 | C[l] = 0.1726 |

N = 0.33045142628136837

| | | | | | |
|---|---|---|---|---|---|
| l = 7 | t = 9 | S = 0.76466706739 | C = 0.76466580731 | S[l] = 0.6739 | C[l] = 0.0731 |

N = 0.7646667583752824

| | | | | | |
|---|---|---|---|---|---|
| l = 7 | t = 10 | S = 0.24828075636 | C = 0.24827975636 | S[l] = 0.5636 | C[l] = 0.5636 |

N = 0.24828075636603164

| | | | | | |
|---|---|---|---|---|---|
| l = 7 | t = 11 | S = 0.07517743208 | C = 0.07517679004 | S[l] = 0.3208 | C[l] = 0.9004 |

N = 0.07517774110432451

| | | | | | |
|---|---|---|---|---|---|
| l = 7 | t = 12 | S = 0.43580247382 | C = 0.43580225259 | S[l] = 0.7382 | C[l] = 0.5259 |

N = 0.4358030616077615

| | | | | | |
|---|---|---|---|---|---|
| l = 7 | t = 13 | S = 0.8133264111 | C = 0.81332663233 | S[l] = 0.111 | C[l] = 0.3233 |

N = 0.8133272201191313

| | | | | | |
|---|---|---|---|---|---|
| l = 7 | t = 14 | S = 0.65384280161 | C = 0.65384344365 | S[l] = 0.0161 | C[l] = 0.4365 |

N = 0.6538437526732097

| | | | | | |
|---|---|---|---|---|---|
| l = 7 | t = 15 | S = 0.30339375366 | C = 0.30339475366 | S[l] = 0.5366 | C[l] = 0.5366 |

N = 0.3033947536653492

| | | | | | |
|---|---|---|---|---|---|
| l = 7 | t = 16 | S = 0.2523815839 | C = 0.25238284397 | S[l] = 0.839 | C[l] = 0.4397 |

N = 0.25238253495844165

| | | | | | |
|---|---|---|---|---|---|
| l = 7 | t = 17 | S = 0.61675539299 | C = 0.61675678979 | S[l] = 0.9299 | C[l] = 0.8979 |

N = 0.6167562020098308

| | | | | | |
|---|---|---|---|---|---|
| l = 7 | t = 18 | S = 0.86000510876 | C = 0.86000650556 | S[l] = 0.0876 | C[l] = 0.0556 |

N = 0.8600056965511272

| | | | | | |
|---|---|---|---|---|---|
| l = 7 | t = 19 | S = 0.78028185103 | C = 0.7802831111 | S[l] = 0.5103 | C[l] = 0.111 |

N = 0.7802821600496817

| | | | | | |
|---|---|---|---|---|---|
| l = 7 | t = 20 | S = 0.69348274478 | C = 0.69348374478 | S[l] = 0.4478 | C[l] = 0.4478 |

N = 0.6934827447826224

| | | | | | |
|---|---|---|---|---|---|
| l = 7 | t = 21 | S = 0.21052801493 | C = 0.21052865697 | S[l] = 0.1493 | C[l] = 0.5697 |

N = 0.21052770591891246

| | | | | | |
|---|---|---|---|---|---|
| l = 7 | t = 22 | S = 0.94504163844 | C = 0.94504185968 | S[l] = 0.3844 | C[l] = 0.5968 |

N = 0.9450410506639705

| | | | | | |
|---|---|---|---|---|---|
| l = 7 | t = 23 | S = 0.30622700748 | C = 0.30622678625 | S[l] = 0.0748 | C[l] = 0.8625 |

N = 0.3062261984657363

| | | | | | |
|---|---|---|---|---|---|
| l = 7 | t = 24 | S = 0.89320949618 | C = 0.89320885414 | S[l] = 0.9618 | C[l] = 0.5414 |

N = 0.8932085451288954
1) S = N[t] + 0.0000001*sine(2*pi*t/T)
2) C = N[t] + 0.0000001*sine(2*pi*t/T + pi/2)
3) partial S[l] from S
4) partial C[l] from C
5) noise N = N[t]

TABLE 4a
Getting patterns by decimals. T = 20.0 t = 1-24
Step 1

| | 1 | 2 | 3 |
|---|---|---|---|
| t = 0 | signal-0 = 0.0 | noise-0 = 0.057763357996661435 | mix-0 = 0.057763357996661435 |
| t = 1 | signal-0 = 0.3090169943749474 | noise-0 = 0.9367966486572717 | mix-0 = 1.245813643032219 |
| t = 2 | signal-0 = 0.5877852522924731 | noise-0 = 0.9626588832143346 | mix-0 = 1.5504441355068077 |
| t = 3 | signal-0 = 0.8090169943749475 | noise-0 = 0.6613758187446075 | mix-0 = 1.470392813119555 |
| t = 4 | signal-0 = 0.9510565162951535 | noise-0 = 0.5995641931156973 | mix-0 = 1.5506207094108508 |
| t = 5 | signal-0 = 1.0 | noise-0 = 0.9033855407919242 | mix-0 = 1.9033855407919242 |
| t = 6 | signal-0 = 0.9510565162951536 | noise-0 = 0.12717124117685774 | mix-0 = 1.0782277574720114 |
| t = 7 | signal-0 = 0.8090169943749475 | noise-0 = 0.3553702632888037 | mix-0 = 1.1643872576637513 |
| t = 8 | signal-0 = 0.5877852522924732 | noise-0 = 0.5424037710652598 | mix-0 = 1.1301890233577332 |
| t = 9 | signal-0 = 0.3090169943749475 | noise-0 = 0.10023535003086603 | mix-0 = 0.40925234440581354 |
| t = 10 | signal-0 = 1.2246063538223773E−16 | noise-0 = 0.13625284109429014 | mix-0 = 0.13625284109429026 |
| t = 11 | signal-0 = −0.3090169943749469 | noise-0 = 0.7393534631870632 | mix-0 = 0.4303364688121163 |
| t = 12 | signal-0 = −0.587785252292473 | noise-0 = 0.14555202675875267 | mix-0 = −0.44223322553372035 |
| t = 13 | signal-0 = −0.8090169943749473 | noise-0 = 0.41817840653514415 | mix-0 = −0.3908385878398032 |
| t = 14 | signal-0 = −0.9510565162951535 | noise-0 = 0.7303642203416668 | mix-0 = −0.22069229595348672 |
| t = 15 | signal-0 = −1.0 | noise-0 = 0.8260159298716245 | mix-0 = −0.17398407012837547 |
| t = 16 | signal-0 = −0.9510565162951536 | noise-0 = 0.04897523139256843 | mix-0 = −0.9020812849025852 |
| t = 17 | signal-0 = −0.8090169943749476 | noise-0 = 0.03617157954454486 | mix-0 = −0.7728454148304027 |
| t = 18 | signal-0 = −0.5877852522924734 | noise-0 = 0.4061515916902434 | mix-0 = −0.18163366060222996 |
| t = 19 | signal-0 = −0.3090169943749476 | noise-0 = 0.8142500009777289 | mix-0 = 0.5052330066027813 |
| t = 20 | signal-0 = −2.4492127076447545E−16 | noise-0 = 0.9936439338364275 | mix-0 = 0.9936439338364272 |
| t = 21 | signal-0 = 0.3090169943749472 | noise-0 = 0.9795523385128857 | mix-0 = 1.288569332887833 |
| t = 22 | signal-0 = 0.5877852522924721 | noise-0 = 0.6063465604568415 | mix-0 = 1.1941318127493137 |
| t = 23 | signal-0 = 0.8090169943749472 | noise-0 = 0.10906684968966818 | mix-0 = 0.9180838440646154 |
| t = 24 | signal-0 = 0.9510565162951535 | noise-0 = 0.33762971962992416 | mix-0 = 1.2886862359250777 |
| t = 25 | signal-0 = 1.0 | noise-0 = 0.4553533807515542 | mix-0 = 1.4553533807515542 |
| t = 26 | signal-0 = 0.9510565162951536 | noise-0 = 0.7708383160522495 | mix-0 = 1.7218948323474033 |
| t = 27 | signal-0 = 0.8090169943749477 | noise-0 = 0.3666951034409982 | mix-0 = 1.1757120978159459 |
| t = 28 | signal-0 = 0.5877852522924734 | noise-0 = 0.681619888354332 | mix-0 = 1.2694051406468052 |

1: Initial learning signal sine(2*pi*t/T)
2: Initial learning noise
3: Initial learning mixture “signal + noise”
Comment: Detecting the signal in a mixture with noise is provied by additional streams of data (this mixture) gotten by partial numbers at 1 levels of decimals (look at table 4b and table 4c)

TABLE 4b
Getting patterns by decimals. T = 20.0 t = 0-24
Step 2

| | | 1 | 2 | 3 | 4 |
|---|---|---|---|---|---|
| l = 1 | t = 0 | signal-l = 0.0 | noise-l = 0.57763357996 | mix-0 = 0.057763357996661435 | mix-l = 0.57763357996 |
| l = 1 | t = 1 | signal-l = 0.09016994374 | noise-l = 0.36796648657 | mix-0 = 1.245813643032219 | mix-l = 0.45813643032 |
| l = 1 | t = 2 | signal-l = 0.87785252292 | noise-l = 0.62658883214 | mix-0 = 1.5504441355068077 | mix-l = 0.50444135506 |
| l = 1 | t = 3 | signal-l = 0.09016994374 | noise-l = 0.61375818744 | mix-0 = 1.470392813119555 | mix-l = 0.70392813119 |
| l = 1 | t = 4 | signal-l = 0.51056516295 | noise-l = 0.99564193115 | mix-0 = 1.5506207094108508 | mix-l = 0.5062070941 |
| l = 1 | t = 5 | signal-l = 0.0 | noise-l = 0.03385540791 | mix-0 = 1.9033855407919242 | mix-l = 0.03385540791 |
| l = 1 | t = 6 | signal-l = 0.51056516295 | noise-l = 0.27171241176 | mix-0 = 1.0782277574720114 | mix-l = 0.78227757472 |
| l = 1 | t = 7 | signal-l = 0.09016994374 | noise-l = 0.55370263288 | mix-0 = 1.1643872576637513 | mix-l = 0.64387257663 |
| l = 1 | t = 8 | signal-l = 0.87785252292 | noise-l = 0.42403771065 | mix-0 = 1.1301890233577332 | mix-l = 0.30189023357 |
| l = 1 | t = 9 | signal-l = 0.09016994374 | noise-l = 0.0023535003 | mix-0 = 0.40925234440581354 | mix-l = 0.09252344405 |
| l = 1 | t = 10 | signal-l = 0.0 | noise-l = 0.36252841094 | mix-0 = 0.13625284109429026 | mix-l = 0.36252841094 |
| l = 1 | t = 11 | signal-l = −0.09016994374 | noise-l = 0.39353463187 | mix-0 = 0.4303364688121163 | mix-l = 0.30336468812 |
| l = 1 | t = 12 | signal-l = −0.87785252292 | noise-l = 0.45552026758 | mix-0 = −0.44223322553372035 | mix-l = −0.42233225533 |
| l = 1 | t = 13 | signal-l = −0.09016994374 | noise-l = 0.18178406535 | mix-0 = −0.3908385878398032 | mix-l = −0.90838587839 |
| l = 1 | t = 14 | signal-l = −0.51056516295 | noise-l = 0.30364220341 | mix-0 = −0.22069229595348672 | mix-l = −0.20692295953 |
| l = 1 | t = 15 | signal-l = −0.0 | noise-l = 0.26015929871 | mix-0 = −0.17398407012837547 | mix-l = −0.73984070128 |
| l = 1 | t = 16 | signal-l = −0.51056516295 | noise-l = 0.48975231392 | mix-0 = −0.9020812849025852 | mix-l = −0.02081284902 |
| l = 1 | t = 17 | signal-l = −0.09016994374 | noise-l = 0.36171579544 | mix-0 = −0.7728454148304027 | mix-l = −0.7284541483 |
| l = 1 | t = 18 | signal-l = −0.87785252292 | noise-l = 0.0615159169 | mix-0 = −0.18163366060222996 | mix-l = −0.81633660602 |
| l = 1 | t = 19 | signal-l = −0.09016994374 | noise-l = 0.14250000977 | mix-0 = 0.5052330066027813 | mix-l = 0.05233006602 |
| l = 1 | t = 20 | signal-l = −0.0 | noise-l = 0.93643933836 | mix-0 = 0.9936439338364272 | mix-l = 0.93643933836 |
| l = 1 | t = 21 | signal-l = 0.09016994374 | noise-l = 0.79552338512 | mix-0 = 1.288569332887833 | mix-l = 0.88569332887 |
| l = 1 | t = 22 | signal-l = 0.87785252292 | noise-l = 0.06346560456 | mix-0 = 1.1941318127493137 | mix-l = 0.94131812749 |
| l = 1 | t = 23 | signal-l = 0.09016994374 | noise-l = 0.09066849689 | mix-0 = 0.9180838440646154 | mix-l = 0.18083844064 |
| l = 1 | t = 24 | signal-l = 0.51056516295 | noise-l = 0.37629719629 | mix-0 = 1.2886862359250777 | mix-l = 0.88686235925 |
| l = 1 | t = 25 | signal-l = 0.0 | noise-l = 0.55353380751 | mix-0 = 1.4553533807515542 | mix-l = 0.55353380751 |
| l = 1 | t = 26 | signal-l = 0.51056516295 | noise-l = 0.70838316052 | mix-0 = 1.7218948323474033 | mix-l = 0.21894832347 |
| l = 1 | t = 27 | signal-l = 0.09016994374 | noise-l = 0.6669510344 | mix-0 = 1.1757120978159459 | mix-l = 0.75712097815 |
| l = 1 | t = 28 | signal-l = 0.87785252292 | noise-l = 0.81619888354 | mix-0 = 1.2694051406468052 | mix-l = 0.69405140646 |
| l = 2 | t = 0 | signal-l = 0.0 | noise-l = 0.77633579966 | mix-0 = 0.057763357996661435 | mix-l = 0.77633579966 |
| l = 2 | t = 1 | signal-l = 0.90169943749 | noise-l = 0.67966486572 | mix-0 = 1.245813643032219 | mix-l = 0.58136430322 |
| l = 2 | t = 2 | signal-l = 0.77852522924 | noise-l = 0.26588832143 | mix-0 = 1.5504441355068077 | mix-l = 0.04441355068 |
| l = 2 | t = 3 | signal-l = 0.90169943749 | noise-l = 0.13758187446 | mix-0 = 1.470392813119555 | mix-l = 0.03928131195 |
| l = 2 | t = 4 | signal-l = 0.10565162951 | noise-l = 0.95641931156 | mix-0 = 1.5506207094108508 | mix-l = 0.06207094108 |
| l = 2 | t = 5 | signal-l = 0.0 | noise-l = 0.33855407919 | mix-0 = 1.9033855407919242 | mix-l = 0.33855407919 |
| l = 2 | t = 6 | signal-l = 0.10565162951 | noise-l = 0.71712411768 | mix-0 = 1.0782277574720114 | mix-l = 0.8227757472 |
| l = 2 | t = 7 | signal-l = 0.90169943749 | noise-l = 0.53702632888 | mix-0 = 1.1643872576637513 | mix-l = 0.43872576637 |
| l = 2 | t = 8 | signal-l = 0.77852522924 | noise-l = 0.24037710652 | mix-0 = 1.1301890233577332 | mix-l = 0.01890233577 |
| l = 2 | t = 9 | signal-l = 0.90169943749 | noise-l = 0.02353500308 | mix-0 = 0.40925234440581354 | mix-l = 0.92523444058 |
| l = 2 | t = 10 | signal-l = 0.0 | noise-l = 0.62528410942 | mix-0 = 0.13625284109429026 | mix-l = 0.62528410942 |
| l = 2 | t = 11 | signal-l = −0.90169943749 | noise-l = 0.9353463187 | mix-0 = 0.4303364688121163 | mix-l = 0.03364688121 |
| l = 2 | t = 12 | signal-l = −0.77852522924 | noise-l = 0.55520267587 | mix-0 = −0.44223322553372035 | mix-l = −0.22332255337 |
| l = 2 | t = 13 | signal-l = −0.90169943749 | noise-l = 0.81784065351 | mix-0 = −0.3908385878398032 | mix-l = −0.08385878398 |
| l = 2 | t = 14 | signal-l = −0.10565162951 | noise-l = 0.03642203416 | mix-0 = −0.22069229595348672 | mix-l = −0.06922959534 |
| l = 2 | t = 15 | signal-l = −0.0 | noise-l = 0.60159298716 | mix-0 = −0.17398407012837547 | mix-l = −0.39840701283 |
| l = 2 | t = 16 | signal-l = −0.10565162951 | noise-l = 0.89752313925 | mix-0 = −0.9020812849025852 | mix-l = −0.20812849025 |
| l = 2 | t = 17 | signal-l = −0.90169943749 | noise-l = 0.61715795445 | mix-0 = −0.7728454148304027 | mix-l = −0.28454148304 |
| l = 2 | t = 18 | signal-l = −0.77852522924 | noise-l = 0.61515916902 | mix-0 = −0.18163366060222996 | mix-l = −0.16336606022 |
| l = 2 | t = 19 | signal-l = −0.90169943749 | noise-l = 0.42500009777 | mix-0 = 0.5052330066027813 | mix-l = 0.52330066027 |
| l = 2 | t = 20 | signal-l = −0.0 | noise-l = 0.36439338364 | mix-0 = 0.9936439338364272 | mix-l = 0.36439338364 |
| l = 2 | t = 21 | signal-l = 0.90169943749 | noise-l = 0.95523385128 | mix-0 = 1.288569332887833 | mix-l = 0.85693328878 |
| l = 2 | t = 22 | signal-l = 0.77852522924 | noise-l = 0.63465604568 | mix-0 = 1.1941318127493137 | mix-l = 0.41318127493 |
| l = 2 | t = 23 | signal-l = 0.90169943749 | noise-l = 0.90668496896 | mix-0 = 0.9180838440646154 | mix-l = 0.80838440646 |
| l = 2 | t = 24 | signal-l = 0.10565162951 | noise-l = 0.76297196299 | mix-0 = 1.2886862359250777 | mix-l = 0.8686235925 |
| l = 2 | t = 25 | signal-l = 0.0 | noise-l = 0.53533807515 | mix-0 = 1.4553533807515542 | mix-l = 0.53533807515 |
| l = 2 | t = 26 | signal-l = 0.10565162951 | noise-l = 0.08383160522 | mix-0 = 1.7218948323474033 | mix-l = 0.18948323474 |
| l = 2 | t = 27 | signal-l = 0.90169943749 | noise-l = 0.66951034409 | mix-0 = 1.1757120978159459 | mix-l = 0.57120978159 |
| l = 2 | t = 28 | signal-l = 0.77852522924 | noise-l = 0.16198883543 | mix-0 = 1.2694051406468052 | mix-l = 0.94051406468 |
| l = 3 | t = 0 | signal-l = 0.0 | noise-l = 0.76335799666 | mix-0 = 0.057763357996661435 | mix-l = 0.76335799666 |
| l = 3 | t = 1 | signal-l = 0.01699437494 | noise-l = 0.79664865727 | mix-0 = 1.245813643032219 | mix-l = 0.81364303221 |
| l = 3 | t = 2 | signal-l = 0.78525229247 | noise-l = 0.65888321433 | mix-0 = 1.5504441355068077 | mix-l = 0.4441355068 |
| l = 3 | t = 3 | signal-l = 0.01699437494 | noise-l = 0.3758187446 | mix-0 = 1.470392813119555 | mix-l = 0.39281311955 |
| l = 3 | t = 4 | signal-l = 0.05651629515 | noise-l = 0.56419311569 | mix-0 = 1.5506207094108508 | mix-l = 0.62070941085 |
| l = 3 | t = 5 | signal-l = 0.0 | noise-l = 0.38554079192 | mix-0 = 1.9033855407919242 | mix-l = 0.38554079192 |
| l = 3 | t = 6 | signal-l = 0.05651629515 | noise-l = 0.17124117685 | mix-0 = 1.0782277574720114 | mix-l = 0.22775747201 |
| l = 3 | t = 7 | signal-l = 0.01699437494 | noise-l = 0.3702632888 | mix-0 = 1.1643872576637513 | mix-l = 0.38725766375 |
| l = 3 | t = 8 | signal-l = 0.78525229247 | noise-l = 0.40377106525 | mix-0 = 1.1301890233577332 | mix-l = 0.18902335773 |
| l = 3 | t = 9 | signal-l = 0.01699437494 | noise-l = 0.23535003086 | mix-0 = 0.40925234440581354 | mix-l = 0.25234440581 |
| l = 3 | t = 10 | signal-l = 0.0 | noise-l = 0.25284109429 | mix-0 = 0.13625284109429026 | mix-l = 0.25284109429 |
| l = 3 | t = 11 | signal-l = −0.01699437494 | noise-l = 0.35346318706 | mix-0 = 0.4303364688121163 | mix-l = 0.33646881211 |
| l = 3 | t = 12 | signal-l = −0.78525229247 | noise-l = 0.55202675875 | mix-0 = −0.44223322553372035 | mix-l = −0.23322553372 |
| l = 3 | t = 13 | signal-l = −0.01699437494 | noise-l = 0.17840653514 | mix-0 = −0.3908385878398032 | mix-l = −0.8385878398 |
| l = 3 | t = 14 | signal-l = −0.05651629515 | noise-l = 0.36422034166 | mix-0 = −0.22069229595348672 | mix-l = −0.69229595348 |
| l = 3 | t = 15 | signal-l = −0.0 | noise-l = 0.01592987162 | mix-0 = −0.17398407012837547 | mix-l = −0.98407012837 |
| l = 3 | t = 16 | signal-l = −0.05651629515 | noise-l = 0.97523139256 | mix-0 = −0.9020812849025852 | mix-l = −0.08128490258 |
| l = 3 | t = 17 | signal-l = −0.01699437494 | noise-l = 0.17157954454 | mix-0 = −0.7728454148304027 | mix-l = −0.8454148304 |
| l = 3 | t = 18 | signal-l = −0.78525229247 | noise-l = 0.15159169024 | mix-0 = −0.18163366060222996 | mix-l = −0.63366060222 |
| l = 3 | t = 19 | signal-l = −0.01699437494 | noise-l = 0.25000097772 | mix-0 = 0.5052330066027813 | mix-l = 0.23300660278 |
| l = 3 | t = 20 | signal-l = −0.0 | noise-l = 0.64393383642 | mix-0 = 0.9936439338364272 | mix-l = 0.64393383642 |
| l = 3 | t = 21 | signal-l = 0.01699437494 | noise-l = 0.55233851288 | mix-0 = 1.288569332887833 | mix-l = 0.56933288783 |
| l = 3 | t = 22 | signal-l = 0.78525229247 | noise-l = 0.34656045684 | mix-0 = 1.1941318127493137 | mix-l = 0.13181274931 |
| l = 3 | t = 23 | signal-l = 0.01699437494 | noise-l = 0.06684968966 | mix-0 = 0.9180838440646154 | mix-l = 0.08384406461 |
| l = 3 | t = 24 | signal-l = 0.05651629515 | noise-l = 0.62971962992 | mix-0 = 1.2886862359250777 | mix-l = 0.68623592507 |
| l = 3 | t = 25 | signal-l = 0.0 | noise-l = 0.35338075155 | mix-0 = 1.4553533807515542 | mix-l = 0.35338075155 |
| l = 3 | t = 26 | signal-l = 0.05651629515 | noise-l = 0.83831605224 | mix-0 = 1.7218948323474033 | mix-l = 0.8948323474 |
| l = 3 | t = 27 | signal-l = 0.01699437494 | noise-l = 0.69510344099 | mix-0 = 1.1757120978159459 | mix-l = 0.71209781594 |
| l = 3 | t = 28 | signal-l = 0.78525229247 | noise-l = 0.61988835433 | mix-0 = 1.2694051406468052 | mix-l = 0.4051406468 |
| l = 4 | t = 0 | signal-l = 0.0 | noise-l = 0.63357996661 | mix-0 = 0.057763357996661435 | mix-l = 0.63357996661 |
| l = 4 | t = 1 | signal-l = 0.16994374947 | noise-l = 0.96648657271 | mix-0 = 1.245813643032219 | mix-l = 0.13643032219 |
| l = 4 | t = 2 | signal-l = 0.85252292473 | noise-l = 0.58883214334 | mix-0 = 1.5504441355068077 | mix-l = 0.44135506807 |
| l = 4 | t = 3 | signal-l = 0.16994374947 | noise-l = 0.75818744607 | mix-0 = 1.470392813119555 | mix-l = 0.92813119555 |
| l = 4 | t = 4 | signal-l = 0.56516295153 | noise-l = 0.64193115697 | mix-0 = 1.5506207094108508 | mix-l = 0.2070941085 |
| l = 4 | t = 5 | signal-l = 0.0 | noise-l = 0.85540791924 | mix-0 = 1.9033855407919242 | mix-l = 0.85540791924 |
| l = 4 | t = 6 | signal-l = 0.56516295153 | noise-l = 0.71241176857 | mix-0 = 1.0782277574720114 | mix-l = 0.27757472011 |
| l = 4 | t = 7 | signal-l = 0.16994374947 | noise-l = 0.70263288803 | mix-0 = 1.1643872576637513 | mix-l = 0.87257663751 |
| l = 4 | t = 8 | signal-l = 0.85252292473 | noise-l = 0.03771065259 | mix-0 = 1.1301890233577332 | mix-l = 0.89023357733 |
| l = 4 | t = 9 | signal-l = 0.16994374947 | noise-l = 0.35350030866 | mix-0 = 0.40925234440581354 | mix-l = 0.52344405813 |
| l = 4 | t = 10 | signal-l = 0.0 | noise-l = 0.5284109429 | mix-0 = 0.13625284109429026 | mix-l = 0.5284109429 |
| l = 4 | t = 11 | signal-l = −0.16994374946 | noise-l = 0.53463187063 | mix-0 = 0.4303364688121163 | mix-l = 0.36468812116 |
| l = 4 | t = 12 | signal-l = −0.85252292473 | noise-l = 0.52026758752 | mix-0 = −0.44223322553372035 | mix-l = −0.3322553372 |
| l = 4 | t = 13 | signal-l = −0.16994374947 | noise-l = 0.78406535144 | mix-0 = −0.3908385878398032 | mix-l = −0.38587839803 |
| l = 4 | t = 14 | signal-l = −0.56516295153 | noise-l = 0.64220341666 | mix-0 = −0.22069229595348672 | mix-l = −0.92295953486 |
| l = 4 | t = 15 | signal-l = −0.0 | noise-l = 0.15929871624 | mix-0 = −0.17398407012837547 | mix-l = −0.84070128375 |
| l = 4 | t = 16 | signal-l = −0.56516295153 | noise-l = 0.75231392568 | mix-0 = −0.9020812849025852 | mix-l = −0.81284902585 |
| l = 4 | t = 17 | signal-l = −0.16994374947 | noise-l = 0.71579544544 | mix-0 = −0.7728454148304027 | mix-l = −0.45414830402 |
| l = 4 | t = 18 | signal-l = −0.85252292473 | noise-l = 0.51591690243 | mix-0 = −0.18163366060222996 | mix-l = −0.33660602229 |
| l = 4 | t = 19 | signal-l = −0.16994374947 | noise-l = 0.50000977728 | mix-0 = 0.5052330066027813 | mix-l = 0.33006602781 |
| l = 4 | t = 20 | signal-l = −0.0 | noise-l = 0.43933836427 | mix-0 = 0.9936439338364272 | mix-l = 0.43933836427 |
| l = 4 | t = 21 | signal-l = 0.16994374947 | noise-l = 0.52338512885 | mix-0 = 1.288569332887833 | mix-l = 0.69332887833 |
| l = 4 | t = 22 | signal-l = 0.85252292472 | noise-l = 0.46560456841 | mix-0 = 1.1941318127493137 | mix-l = 0.31812749313 |
| l = 4 | t = 23 | signal-l = 0.16994374947 | noise-l = 0.66849689668 | mix-0 = 0.9180838440646154 | mix-l = 0.83844064615 |
| l = 4 | t = 24 | signal-l = 0.56516295153 | noise-l = 0.29719629924 | mix-0 = 1.2886862359250777 | mix-l = 0.86235925077 |
| l = 4 | t = 25 | signal-l = 0.0 | noise-l = 0.53380751554 | mix-0 = 1.4553533807515542 | mix-l = 0.53380751554 |
| l = 4 | t = 26 | signal-l = 0.56516295153 | noise-l = 0.38316052249 | mix-0 = 1.7218948323474033 | mix-l = 0.94832347403 |
| l = 4 | t = 27 | signal-l = 0.16994374947 | noise-l = 0.95103440998 | mix-0 = 1.1757120978159459 | mix-l = 0.12097815945 |
| l = 4 | t = 28 | signal-l = 0.85252292473 | noise-l = 0.19888354332 | mix-0 = 1.2694051406468052 | mix-l = 0.05140646805 |
| l = 5 | t = 0 | signal-l = 0.0 | noise-l = 0.33579966614 | mix-0 = 0.057763357996661435 | mix-l = 0.33579966614 |
| l = 5 | t = 1 | signal-l = 0.69943749474 | noise-l = 0.66486572717 | mix-0 = 1.245813643032219 | mix-l = 0.3643032219 |
| l = 5 | t = 2 | signal-l = 0.52522924731 | noise-l = 0.88832143346 | mix-0 = 1.5504441355068077 | mix-l = 0.41355068077 |
| l = 5 | t = 3 | signal-l = 0.69943749475 | noise-l = 0.58187446075 | mix-0 = 1.470392813119555 | mix-l = 0.2813119555 |
| l = 5 | t = 4 | signal-l = 0.65162951535 | noise-l = 0.41931156973 | mix-0 = 1.5506207094108508 | mix-l = 0.07094108508 |
| l = 5 | t = 5 | signal-l = 0.0 | noise-l = 0.55407919242 | mix-0 = 1.9033855407919242 | mix-l = 0.55407919242 |
| l = 5 | t = 6 | signal-l = 0.65162951536 | noise-l = 0.12411768577 | mix-0 = 1.0782277574720114 | mix-l = 0.77574720114 |
| l = 5 | t = 7 | signal-l = 0.69943749475 | noise-l = 0.02632888037 | mix-0 = 1.1643872576637513 | mix-l = 0.72576637513 |
| l = 5 | t = 8 | signal-l = 0.52522924732 | noise-l = 0.37710652598 | mix-0 = 1.1301890233577332 | mix-l = 0.90233577332 |
| l = 5 | t = 9 | signal-l = 0.69943749475 | noise-l = 0.5350030866 | mix-0 = 0.40925234440581354 | mix-l = 0.23444058135 |
| l = 5 | t = 10 | signal-l = 0.0 | noise-l = 0.28410942901 | mix-0 = 0.13625284109429026 | mix-l = 0.28410942902 |
| l = 5 | t = 11 | signal-l = −0.69943749469 | noise-l = 0.34631870632 | mix-0 = 0.4303364688121163 | mix-l = 0.64688121163 |
| l = 5 | t = 12 | signal-l = −0.5252292473 | noise-l = 0.20267587526 | mix-0 = −0.44223322553372035 | mix-l = −0.32255337203 |
| l = 5 | t = 13 | signal-l = −0.69943749473 | noise-l = 0.84065351441 | mix-0 = −0.3908385878398032 | mix-l = −0.85878398032 |
| l = 5 | t = 14 | signal-l = −0.65162951535 | noise-l = 0.42203416668 | mix-0 = −0.22069229595348672 | mix-l = −0.22959534867 |
| l = 5 | t = 15 | signal-l = −0.0 | noise-l = 0.59298716245 | mix-0 = −0.17398407012837547 | mix-l = −0.40701283754 |
| l = 5 | t = 16 | signal-l = −0.65162951536 | noise-l = 0.52313925684 | mix-0 = −0.9020812849025852 | mix-l = −0.12849025852 |
| l = 5 | t = 17 | signal-l = −0.69943749476 | noise-l = 0.15795445448 | mix-0 = −0.7728454148304027 | mix-l = −0.54148304027 |
| l = 5 | t = 18 | signal-l = −0.52522924734 | noise-l = 0.15916902434 | mix-0 = −0.18163366060222996 | mix-l = −0.36606022299 |
| l = 5 | t = 19 | signal-l = −0.69943749476 | noise-l = 9.777289E-5 | mix-0 = 0.5052330066027813 | mix-l = 0.30066027813 |
| l = 5 | t = 20 | signal-l = −0.0 | noise-l = 0.39338364275 | mix-0 = 0.9936439338364272 | mix-l = 0.39338364272 |
| l = 5 | t = 21 | signal-l = 0.69943749472 | noise-l = 0.23385128857 | mix-0 = 1.288569332887833 | mix-l = 0.9332887833 |
| l = 5 | t = 22 | signal-l = 0.52522924721 | noise-l = 0.65604568415 | mix-0 = 1.1941318127493137 | mix-l = 0.18127493137 |
| l = 5 | t = 23 | signal-l = 0.69943749472 | noise-l = 0.68496896681 | mix-0 = 0.9180838440646154 | mix-l = 0.38440646154 |
| l = 5 | t = 24 | signal-l = 0.65162951535 | noise-l = 0.97196299241 | mix-0 = 1.2886862359250777 | mix-l = 0.62359250777 |
| l = 5 | t = 25 | signal-l = 0.0 | noise-l = 0.33807515542 | mix-0 = 1.4553533807515542 | mix-l = 0.33807515542 |
| l = 5 | t = 26 | signal-l = 0.65162951536 | noise-l = 0.83160522495 | mix-0 = 1.7218948323474033 | mix-l = 0.48323474033 |
| l = 5 | t = 27 | signal-l = 0.69943749477 | noise-l = 0.51034409982 | mix-0 = 1.1757120978159459 | mix-l = 0.20978159459 |
| l = 5 | t = 28 | signal-l = 0.52522924734 | noise-l = 0.9888354332 | mix-0 = 1.2694051406468052 | mix-l = 0.51406468052 |
| l = 6 | t = 0 | signal-l = 0.0 | noise-l = 0.35799666143 | mix-0 = 0.057763357996661435 | mix-l = 0.35799666143 |
| l = 6 | t = 1 | signal-l = 0.9943749474 | noise-l = 0.6486572717 | mix-0 = 1.245813643032219 | mix-l = 0.643032219 |
| l = 6 | t = 2 | signal-l = 0.2522924731 | noise-l = 0.8832143346 | mix-0 = 1.5504441355068077 | mix-l = 0.1355068077 |
| l = 6 | t = 3 | signal-l = 0.9943749475 | noise-l = 0.8187446075 | mix-0 = 1.470392813119555 | mix-l = 0.813119555 |
| l = 6 | t = 4 | signal-l = 0.5162951535 | noise-l = 0.1931156973 | mix-0 = 1.5506207094108508 | mix-l = 0.7094108508 |
| l = 6 | t = 5 | signal-l = 0.0 | noise-l = 0.5407919242 | mix-0 = 1.9033855407919242 | mix-l = 0.5407919242 |
| l = 6 | t = 6 | signal-l = 0.5162951536 | noise-l = 0.24117685774 | mix-0 = 1.0782277574720114 | mix-l = 0.7574720114 |
| l = 6 | t = 7 | signal-l = 0.9943749475 | noise-l = 0.2632888037 | mix-0 = 1.1643872576637513 | mix-l = 0.2576637513 |
| l = 6 | t = 8 | signal-l = 0.2522924732 | noise-l = 0.7710652598 | mix-0 = 1.1301890233577332 | mix-l = 0.0233577332 |
| l = 6 | t = 9 | signal-l = 0.9943749475 | noise-l = 0.35003086603 | mix-0 = 0.40925234440581354 | mix-l = 0.34440581354 |
| l = 6 | t = 10 | signal-l = 0.0 | noise-l = 0.84109429014 | mix-0 = 0.13625284109429026 | mix-l = 0.84109429026 |
| l = 6 | t = 11 | signal-l = −0.9943749469 | noise-l = 0.4631870632 | mix-0 = 0.4303364688121163 | mix-l = 0.4688121163 |
| l = 6 | t = 12 | signal-l = −0.252292473 | noise-l = 0.02675875267 | mix-0 = −0.44223322553372035 | mix-l = −0.22553372035 |
| l = 6 | t = 13 | signal-l = −0.9943749473 | noise-l = 0.40653514415 | mix-0 = −0.3908385878398032 | mix-l = −0.5878398032 |
| l = 6 | t = 14 | signal-l = −0.5162951535 | noise-l = 0.2203416668 | mix-0 = −0.22069229595348672 | mix-l = −0.29595348672 |
| l = 6 | t = 15 | signal-l = −0.0 | noise-l = 0.9298716245 | mix-0 = −0.17398407012837547 | mix-l = −0.07012837547 |
| l = 6 | t = 16 | signal-l = −0.5162951536 | noise-l = 0.23139256843 | mix-0 = −0.9020812849025852 | mix-l = −0.2849025852 |
| l = 6 | t = 17 | signal-l = −0.9943749476 | noise-l = 0.57954454486 | mix-0 = −0.7728454148304027 | mix-l = −0.4148304027 |
| l = 6 | t = 18 | signal-l = −0.2522924734 | noise-l = 0.5916902434 | mix-0 = −0.18163366060222996 | mix-l = −0.66060222996 |
| l = 6 | t = 19 | signal-l = −0.9943749476 | noise-l = 9.777289E-4 | mix-0 = 0.5052330066027813 | mix-l = 0.0066027813 |
| l = 6 | t = 20 | signal-l = −0.0 | noise-l = 0.9338364275 | mix-0 = 0.9936439338364272 | mix-l = 0.9338364272 |
| l = 6 | t = 21 | signal-l = 0.9943749472 | noise-l = 0.3385128857 | mix-0 = 1.288569332887833 | mix-l = 0.332887833 |
| l = 6 | t = 22 | signal-l = 0.2522924721 | noise-l = 0.5604568415 | mix-0 = 1.1941318127493137 | mix-l = 0.8127493137 |
| l = 6 | t = 23 | signal-l = 0.9943749472 | noise-l = 0.84968966818 | mix-0 = 0.9180838440646154 | mix-l = 0.8440646154 |
| l = 6 | t = 24 | signal-l = 0.5162951535 | noise-l = 0.71962992416 | mix-0 = 1.2886862359250777 | mix-l = 0.2359250777 |
| l = 6 | t = 25 | signal-l = 0.0 | noise-l = 0.3807515542 | mix-0 = 1.4553533807515542 | mix-l = 0.3807515542 |
| l = 6 | t = 26 | signal-l = 0.5162951536 | noise-l = 0.3160522495 | mix-0 = 1.7218948323474033 | mix-l = 0.8323474033 |
| l = 6 | t = 27 | signal-l = 0.9943749477 | noise-l = 0.1034409982 | mix-0 = 1.1757120978159459 | mix-l = 0.0978159459 |
| l = 6 | t = 28 | signal-l = 0.2522924734 | noise-l = 0.888354332 | mix-0 = 1.2694051406468052 | mix-l = 0.1406468052 |
| l = 7 | t = 0 | signal-l = 0.0 | noise-l = 0.57996661435 | mix-0 = 0.057763357996661435 | mix-l = 0.57996661435 |
| l = 7 | t = 1 | signal-l = 0.943749474 | noise-l = 0.486572717 | mix-0 = 1.245813643032219 | mix-l = 0.43032219 |
| l = 7 | t = 2 | signal-l = 0.522924731 | noise-l = 0.832143346 | mix-0 = 1.5504441355068077 | mix-l = 0.355068077 |
| l = 7 | t = 3 | signal-l = 0.943749475 | noise-l = 0.187446075 | mix-0 = 1.470392813119555 | mix-l = 0.13119555 |
| l = 7 | t = 4 | signal-l = 0.162951535 | noise-l = 0.931156973 | mix-0 = 1.5506207094108508 | mix-l = 0.094108508 |
| l = 7 | t = 5 | signal-l = 0.0 | noise-l = 0.407919242 | mix-0 = 1.9033855407919242 | mix-l = 0.407919242 |
| l = 7 | t = 6 | signal-l = 0.162951536 | noise-l = 0.4117685774 | mix-0 = 1.0782277574720114 | mix-l = 0.574720114 |
| l = 7 | t = 7 | signal-l = 0.943749475 | noise-l = 0.632888037 | mix-0 = 1.1643872576637513 | mix-l = 0.576637513 |
| l = 7 | t = 8 | signal-l = 0.522924732 | noise-l = 0.710652598 | mix-0 = 1.1301890233577332 | mix-l = 0.233577332 |
| l = 7 | t = 9 | signal-l = 0.943749475 | noise-l = 0.5003086603 | mix-0 = 0.40925234440581354 | mix-l = 0.4440581354 |
| l = 7 | t = 10 | signal-l = 0.0 | noise-l = 0.4109429014 | mix-0 = 0.13625284109429026 | mix-l = 0.4109429026 |
| l = 7 | t = 11 | signal-l = −0.943749469 | noise-l = 0.631870632 | mix-0 = 0.4303364688121163 | mix-l = 0.688121163 |
| l = 7 | t = 12 | signal-l = −0.52292473 | noise-l = 0.2675875267 | mix-0 = −0.44223322553372035 | mix-l = −0.2553372035 |
| l = 7 | t = 13 | signal-l = −0.943749473 | noise-l = 0.0653514415 | mix-0 = −0.3908385878398032 | mix-l = −0.878398032 |
| l = 7 | t = 14 | signal-l = −0.162951535 | noise-l = 0.203416668 | mix-0 = −0.22069229595348672 | mix-l = −0.9595348672 |
| l = 7 | t = 15 | signal-l = −0.0 | noise-l = 0.298716245 | mix-0 = −0.17398407012837547 | mix-l = −0.7012837547 |
| l = 7 | t = 16 | signal-l = −0.162951536 | noise-l = 0.3139256843 | mix-0 = −0.9020812849025852 | mix-l = −0.849025852 |
| l = 7 | t = 17 | signal-l = −0.943749476 | noise-l = 0.7954454486 | mix-0 = −0.7728454148304027 | mix-l = −0.148304027 |
| l = 7 | t = 18 | signal-l = −0.522924734 | noise-l = 0.916902434 | mix-0 = −0.18163366060222996 | mix-l = −0.6060222996 |
| l = 7 | t = 19 | signal-l = −0.943749476 | noise-l = 0.009777289 | mix-0 = 0.5052330066027813 | mix-l = 0.066027813 |
| l = 7 | t = 20 | signal-l = −0.0 | noise-l = 0.338364275 | mix-0 = 0.9936439338364272 | mix-l = 0.338364272 |
| l = 7 | t = 21 | signal-l = 0.943749472 | noise-l = 0.385128857 | mix-0 = 1.288569332887833 | mix-l = 0.32887833 |
| l = 7 | t = 22 | signal-l = 0.522924721 | noise-l = 0.604568415 | mix-0 = 1.1941318127493137 | mix-l = 0.127493137 |
| l = 7 | t = 23 | signal-l = 0.943749472 | noise-l = 0.4968966818 | mix-0 = 0.9180838440646154 | mix-l = 0.440646154 |
| l = 7 | t = 24 | signal-l = 0.162951535 | noise-l = 0.1962992416 | mix-0 = 1.2886862359250777 | mix-l = 0.359250777 |
| l = 7 | t = 25 | signal-l = 0.0 | noise-l = 0.807515542 | mix-0 = 1.4553533807515542 | mix-l = 0.807515542 |
| l = 7 | t = 26 | signal-l = 0.162951536 | noise-l = 0.160522495 | mix-0 = 1.7218948323474033 | mix-l = 0.323474033 |
| l = 7 | t = 27 | signal-l = 0.943749477 | noise-l = 0.034409982 | mix-0 = 1.1757120978159459 | mix-l = 0.978159459 |
| l = 7 | t = 28 | signal-l = 0.522924734 | noise-l = 0.88354332 | mix-0 = 1.2694051406468052 | mix-l = 0.406468052 |
| l = 8 | t = 0 | signal-l = 0.0 | noise-l = 0.7996661435 | mix-0 = 0.057763357996661435 | mix-l = 0.7996661435 |
| l = 8 | t = 1 | signal-l = 0.43749474 | noise-l = 0.86572717 | mix-0 = 1.245813643032219 | mix-l = 0.3032219 |
| l = 8 | t = 2 | signal-l = 0.22924731 | noise-l = 0.32143346 | mix-0 = 1.5504441355068077 | mix-l = 0.55068077 |
| l = 8 | t = 3 | signal-l = 0.43749475 | noise-l = 0.87446075 | mix-0 = 1.470392813119555 | mix-l = 0.3119555 |
| l = 8 | t = 4 | signal-l = 0.62951535 | noise-l = 0.31156973 | mix-0 = 1.5506207094108508 | mix-l = 0.94108508 |
| l = 8 | t = 5 | signal-l = 0.0 | noise-l = 0.07919242 | mix-0 = 1.9033855407919242 | mix-l = 0.07919242 |
| l = 8 | t = 6 | signal-l = 0.62951536 | noise-l = 0.117685774 | mix-0 = 1.0782277574720114 | mix-l = 0.74720114 |
| l = 8 | t = 7 | signal-l = 0.43749475 | noise-l = 0.32888037 | mix-0 = 1.1643872576637513 | mix-l = 0.76637513 |
| l = 8 | t = 8 | signal-l = 0.22924732 | noise-l = 0.10652598 | mix-0 = 1.1301890233577332 | mix-l = 0.33577332 |
| l = 8 | t = 9 | signal-l = 0.43749475 | noise-l = 0.003086603 | mix-0 = 0.40925234440581354 | mix-l = 0.440581354 |
| l = 8 | t = 10 | signal-l = 0.0 | noise-l = 0.109429014 | mix-0 = 0.13625284109429026 | mix-l = 0.109429026 |
| l = 8 | t = 11 | signal-l = −0.43749469 | noise-l = 0.31870632 | mix-0 = 0.4303364688121163 | mix-l = 0.88121163 |
| l = 8 | t = 12 | signal-l = −0.2292473 | noise-l = 0.675875267 | mix-0 = −0.44223322553372035 | mix-l = −0.553372035 |
| l = 8 | t = 13 | signal-l = −0.43749473 | noise-l = 0.653514415 | mix-0 = −0.3908385878398032 | mix-l = −0.78398032 |
| l = 8 | t = 14 | signal-l = −0.62951535 | noise-l = 0.03416668 | mix-0 = −0.22069229595348672 | mix-l = −0.595348672 |
| l = 8 | t = 15 | signal-l = −0.0 | noise-l = 0.98716245 | mix-0 = −0.17398407012837547 | mix-l = −0.012837547 |
| l = 8 | t = 16 | signal-l = −0.62951536 | noise-l = 0.139256843 | mix-0 = −0.9020812849025852 | mix-l = −0.49025852 |
| l = 8 | t = 17 | signal-l = −0.43749476 | noise-l = 0.954454486 | mix-0 = −0.7728454148304027 | mix-l = −0.48304027 |
| l = 8 | t = 18 | signal-l = −0.22924734 | noise-l = 0.16902434 | mix-0 = −0.18163366060222996 | mix-l = −0.060222996 |
| l = 8 | t = 19 | signal-l = −0.43749476 | noise-l = 0.09777289 | mix-0 = 0.5052330066027813 | mix-l = 0.66027813 |
| l = 8 | t = 20 | signal-l = −0.0 | noise-l = 0.38364275 | mix-0 = 0.9936439338364272 | mix-l = 0.38364272 |
| l = 8 | t = 21 | signal-l = 0.43749472 | noise-l = 0.85128857 | mix-0 = 1.288569332887833 | mix-l = 0.2887833 |
| l = 8 | t = 22 | signal-l = 0.22924721 | noise-l = 0.04568415 | mix-0 = 1.1941318127493137 | mix-l = 0.27493137 |
| l = 8 | t = 23 | signal-l = 0.43749472 | noise-l = 0.968966818 | mix-0 = 0.9180838440646154 | mix-l = 0.40646154 |
| l = 8 | t = 24 | signal-l = 0.62951535 | noise-l = 0.962992416 | mix-0 = 1.2886862359250777 | mix-l = 0.59250777 |
| l = 8 | t = 25 | signal-l = 0.0 | noise-l = 0.07515542 | mix-0 = 1.4553533807515542 | mix-l = 0.07515542 |
| l = 8 | t = 26 | signal-l = 0.62951536 | noise-l = 0.60522495 | mix-0 = 1.7218948323474033 | mix-l = 0.23474033 |
| l = 8 | t = 27 | signal-l = 0.43749477 | noise-l = 0.34409982 | mix-0 = 1.1757120978159459 | mix-l = 0.78159459 |
| l = 8 | t = 28 | signal-l = 0.22924734 | noise-l = 0.8354332 | mix-0 = 1.2694051406468052 | mix-l = 0.06468052 |
| l = 9 | t = 0 | signal-l = 0.0 | noise-l = 0.996661435 | mix-0 = 0.057763357996661435 | mix-l = 0.996661435 |
| l = 9 | t = 1 | signal-l = 0.3749474 | noise-l = 0.6572717 | mix-0 = 1.245813643032219 | mix-l = 0.032219 |
| l = 9 | t = 2 | signal-l = 0.2924731 | noise-l = 0.2143346 | mix-0 = 1.5504441355068077 | mix-l = 0.5068077 |
| l = 9 | t = 3 | signal-l = 0.3749475 | noise-l = 0.7446075 | mix-0 = 1.470392813119555 | mix-l = 0.119555 |
| l = 9 | t = 4 | signal-l = 0.2951535 | noise-l = 0.1156973 | mix-0 = 1.5506207094108508 | mix-l = 0.4108508 |
| l = 9 | t = 5 | signal-l = 0.0 | noise-l = 0.7919242 | mix-0 = 1.9033855407919242 | mix-l = 0.7919242 |
| l = 9 | t = 6 | signal-l = 0.2951536 | noise-l = 0.17685774 | mix-0 = 1.0782277574720114 | mix-l = 0.4720114 |
| l = 9 | t = 7 | signal-l = 0.3749475 | noise-l = 0.2888037 | mix-0 = 1.1643872576637513 | mix-l = 0.6637513 |
| l = 9 | t = 8 | signal-l = 0.2924732 | noise-l = 0.0652598 | mix-0 = 1.1301890233577332 | mix-l = 0.3577332 |
| l = 9 | t = 9 | signal-l = 0.3749475 | noise-l = 0.03086603 | mix-0 = 0.40925234440581354 | mix-l = 0.40581354 |
| l = 9 | t = 10 | signal-l = 0.0 | noise-l = 0.09429014 | mix-0 = 0.13625284109429026 | mix-l = 0.09429026 |
| l = 9 | t = 11 | signal-l = −0.3749469 | noise-l = 0.1870632 | mix-0 = 0.4303364688121163 | mix-l = 0.8121163 |
| l = 9 | t = 12 | signal-l = −0.292473 | noise-l = 0.75875267 | mix-0 = −0.44223322553372035 | mix-l = −0.53372035 |
| l = 9 | t = 13 | signal-l = −0.3749473 | noise-l = 0.53514415 | mix-0 = −0.3908385878398032 | mix-l = −0.8398032 |
| l = 9 | t = 14 | signal-l = −0.2951535 | noise-l = 0.3416668 | mix-0 = −0.22069229595348672 | mix-l = −0.95348672 |
| l = 9 | t = 15 | signal-l = −0.0 | noise-l = 0.8716245 | mix-0 = −0.17398407012837547 | mix-l = −0.12837547 |
| l = 9 | t = 16 | signal-l = −0.2951536 | noise-l = 0.39256843 | mix-0 = −0.9020812849025852 | mix-l = −0.9025852 |
| l = 9 | t = 17 | signal-l = −0.3749476 | noise-l = 0.54454486 | mix-0 = −0.7728454148304027 | mix-l = −0.8304027 |
| l = 9 | t = 18 | signal-l = −0.2924734 | noise-l = 0.6902434 | mix-0 = −0.18163366060222996 | mix-l = −0.60222996 |
| l = 9 | t = 19 | signal-l = −0.3749476 | noise-l = 0.9777289 | mix-0 = 0.5052330066027813 | mix-l = 0.6027813 |
| l = 9 | t = 20 | signal-l = −0.0 | noise-l = 0.8364275 | mix-0 = 0.9936439338364272 | mix-l = 0.8364272 |
| l = 9 | t = 21 | signal-l = 0.3749472 | noise-l = 0.5128857 | mix-0 = 1.288569332887833 | mix-l = 0.887833 |
| l = 9 | t = 22 | signal-l = 0.2924721 | noise-l = 0.4568415 | mix-0 = 1.1941318127493137 | mix-l = 0.7493137 |
| l = 9 | t = 23 | signal-l = 0.3749472 | noise-l = 0.68966818 | mix-0 = 0.9180838440646154 | mix-l = 0.0646154 |
| l = 9 | t = 24 | signal-l = 0.2951535 | noise-l = 0.62992416 | mix-0 = 1.2886862359250777 | mix-l = 0.9250777 |
| l = 9 | t = 25 | signal-l = 0.0 | noise-l = 0.7515542 | mix-0 = 1.4553533807515542 | mix-l = 0.7515542 |
| l = 9 | t = 26 | signal-l = 0.2951536 | noise-l = 0.0522495 | mix-0 = 1.7218948323474033 | mix-l = 0.3474033 |
| l = 9 | t = 27 | signal-l = 0.3749477 | noise-l = 0.4409982 | mix-0 = 1.1757120978159459 | mix-l = 0.8159459 |
| l = 9 | t = 28 | signal-l = 0.2924734 | noise-l = 0.354332 | mix-0 = 1.2694051406468052 | mix-l = 0.6468052 |
| l = 10 | t = 0 | signal-l = 0.0 | noise-l = 0.96661435 | mix-0 = 0.057763357996661435 | mix-l = 0.96661435 |
| l = 10 | t = 1 | signal-l = 0.749474 | noise-l = 0.572717 | mix-0 = 1.245813643032219 | mix-l = 0.32219 |
| l = 10 | t = 2 | signal-l = 0.924731 | noise-l = 0.143346 | mix-0 = 1.5504441355068077 | mix-l = 0.068077 |
| l = 10 | t = 3 | signal-l = 0.749475 | noise-l = 0.446075 | mix-0 = 1.470392813119555 | mix-l = 0.19555 |
| l = 10 | t = 4 | signal-l = 0.951535 | noise-l = 0.156973 | mix-0 = 1.5506207094108508 | mix-l = 0.108508 |
| l = 10 | t = 5 | signal-l = 0.0 | noise-l = 0.919242 | mix-0 = 1.9033855407919242 | mix-l = 0.919242 |
| l = 10 | t = 6 | signal-l = 0.951536 | noise-l = 0.7685774 | mix-0 = 1.0782277574720114 | mix-l = 0.720114 |
| l = 10 | t = 7 | signal-l = 0.749475 | noise-l = 0.888037 | mix-0 = 1.1643872576637513 | mix-l = 0.637513 |
| l = 10 | t = 8 | signal-l = 0.924732 | noise-l = 0.652598 | mix-0 = 1.1301890233577332 | mix-l = 0.577332 |
| l = 10 | t = 9 | signal-l = 0.749475 | noise-l = 0.3086603 | mix-0 = 0.40925234440581354 | mix-l = 0.0581354 |
| l = 10 | t = 10 | signal-l = 0.0 | noise-l = 0.9429014 | mix-0 = 0.13625284109429026 | mix-l = 0.9429026 |
| l = 10 | t = 11 | signal-l = −0.749469 | noise-l = 0.870632 | mix-0 = 0.4303364688121163 | mix-l = 0.121163 |
| l = 10 | t = 12 | signal-l = −0.92473 | noise-l = 0.5875267 | mix-0 = −0.44223322553372035 | mix-l = −0.3372035 |
| l = 10 | t = 13 | signal-l = −0.749473 | noise-l = 0.3514415 | mix-0 = −0.3908385878398032 | mix-l = −0.398032 |
| l = 10 | t = 14 | signal-l = −0.951535 | noise-l = 0.416668 | mix-0 = −0.22069229595348672 | mix-l = −0.5348672 |
| l = 10 | t = 15 | signal-l = −0.0 | noise-l = 0.716245 | mix-0 = −0.17398407012837547 | mix-l = −0.2837547 |
| l = 10 | t = 16 | signal-l = −0.951536 | noise-l = 0.9256843 | mix-0 = −0.9020812849025852 | mix-l = −0.025852 |
| l = 10 | t = 17 | signal-l = −0.749476 | noise-l = 0.4454486 | mix-0 = −0.7728454148304027 | mix-l = −0.304027 |
| l = 10 | t = 18 | signal-l = −0.924734 | noise-l = 0.902434 | mix-0 = −0.18163366060222996 | mix-l = −0.0222996 |
| l = 10 | t = 19 | signal-l = −0.749476 | noise-l = 0.777289 | mix-0 = 0.5052330066027813 | mix-l = 0.027813 |
| l = 10 | t = 20 | signal-l = −0.0 | noise-l = 0.364275 | mix-0 = 0.9936439338364272 | mix-l = 0.364272 |
| l = 10 | t = 21 | signal-l = 0.749472 | noise-l = 0.128857 | mix-0 = 1.288569332887833 | mix-l = 0.87833 |
| l = 10 | t = 22 | signal-l = 0.924721 | noise-l = 0.568415 | mix-0 = 1.1941318127493137 | mix-l = 0.493137 |
| l = 10 | t = 23 | signal-l = 0.749472 | noise-l = 0.8966818 | mix-0 = 0.9180838440646154 | mix-l = 0.646154 |
| l = 10 | t = 24 | signal-l = 0.951535 | noise-l = 0.2992416 | mix-0 = 1.2886862359250777 | mix-l = 0.250777 |
| l = 10 | t = 25 | signal-l = 0.0 | noise-l = 0.515542 | mix-0 = 1.4553533807515542 | mix-l = 0.515542 |
| l = 10 | t = 26 | signal-l = 0.951536 | noise-l = 0.522495 | mix-0 = 1.7218948323474033 | mix-l = 0.474033 |
| l = 10 | t = 27 | signal-l = 0.749477 | noise-l = 0.409982 | mix-0 = 1.1757120978159459 | mix-l = 0.159459 |
| l = 10 | t = 28 | signal-l = 0.924734 | noise-l = 0.54332 | mix-0 = 1.2694051406468052 | mix-l = 0.468052 |

1: signal-l sine (2*pi*t/T) (additional streams of initial signal (sine) shifted each from l = 1 to 10)
2: noise-l (additional streams of initial noise shifted each from l = 1 to 10)
3: mixture-0 (initial mixture)
4: mixture-l l (additional streams of the initial mixture shifted each from l = 1 to 10)

TABLE 4c
Getting patterns by decimals. T = 20.0 t = 0-24
Step 3

| | 1 | 2 | 3 |
|---|---|---|---|
| on l = 1 | signal sum = 9 | noise sum = 29 | mix sum = 15 |
| on l = 2 | signal sum = 11 | noise sum = 29 | mix sum = 16 |
| on l = 3 | signal sum = 10 | noise sum = 29 | mix sum = 14 |
| on l = 4 | signal sum = 9 | noise sum = 29 | mix sum = 13 |
| on l = 5 | signal sum = 11 | noise sum = 29 | mix sum = 11 |
| on l = 6 | signal sum = 10 | noise sum = 29 | mix sum = 13 |
| on l = 7 | signal sum = 11 | noise sum = 29 | mix sum = 11 |
| on l = 8 | signal sum = 10 | noise sum = 29 | mix sum = 15 |
| on l = 9 | signal sum = 11 | noise sum = 29 | mix sum = 14 |
| on l = 10 | signal sum = 11 | noise sum = 29 | mix sum = 13 |

1: Learning measure of a signal = sine(2*pi*t/T (by levels of orders)
2: Learning measure of noise (by levels of orders)
3: Real mearsure of initial mixture (by partial measures on different levels of decimals)
Number of levels = 10 Number of levels that detect a signal in mixed with noise = 10

I claim:

1. Method to detect a signal in a mixture with noise received by a sensor, amplified and digitized by an analog-digital transformation into the stream of normalized fractions comprises:
creating an artificial dimension of intensity represented with additional streams of data made each from similar parts of available fractions normalized like the initial ones comprising:
creating partial fractions of the first additional stream by shifting out to the left and deleting the top digits of the fractions taken from the initial stream
indexing the stream by the index 1
creating partial fractions of the second additional stream similarly, shifting out to the left and deleting at the new stream the top digits of the fraction taken from the first additional stream
indexing the stream by the index 2
repeating two previous steps creating each next additional stream similarly: shifting out to the left and deleting the top digits of a fraction taken from a previous stream and indexing all streams accordingly
stopping the procedure while the last significant digit of a fraction is reached
establishing a procedure of a separate measuring each additional streams comprises:
establishing a formula that need at least two arguments for computing
establishing a sampling procedure to feed the formula with data taken from a stream by screening
establishing a procedure to get an integrated measure for each stream
establishing a procedure to take a decision and to detect a signal basing on said integrated measure
providing a learning procedure comprises:
adjusting measuring to supposed kinds of signals and noise
establishing a threshold to get a decision by a value of a measure
making visible an invisible signal after detecting comprises:
switching on a current dot of a scanning circuit of a local TV if a signal is detected
establishing brightness of the dot in an inverse accordance with the index of the stream of data that appears the first one detecting the signal and to get the less brightness the weaker the signal

2. Method of claim 1 to compute the measure by the formula of an inverse tangent function which needs two (sine and cosine) arguments.

3. Method of claim 2 to feed the formula with current data as if they are values of sine and cosine functions sampled following rules to index said sine and cosine functions similar to trigonometric ones.

4. Method of claim 2 to feed the formula by data indexed arbitrary, for example, applying all possible combinations of data

5. Method of claim 2 to get an integrated and separate measure of each additional stream of date by adding together correspondent computed values.

6. Method of claim 5 to add all measures together and to make a decision in respect to all data together

7. Method of claim 1 to establish brightness of the dot in accordance with an index of a stream of data that appears the first to detect a signal and to get an inverse brightness of the signal with the more brightness the weaker the signal

8. Method of claim 1 to switch on a dot of the field of optics of a mono/binocular when a signal is detected.

9. Method of claim 1 to get a contour of the signal in a correspondent space comprises:
moving the sensor in different directions
coordinating a screening circuit of TV with this movement.

10. Method of claim 1 to get a contour of a signal on a hunan body scanned by devices like Pat and Cat Scans, MRI etc.

11-20. (canceled)
